(19) United States
(12) Patent Application Publication
(10) Pub. No.: US 2019/0034048 A1
(43) Pub. Date: Jan. 31, 2019

(54) UNIFYING USER-INTERFACE FOR MULTI-SOURCE MEDIA

(71) Applicant: Sirius XM Radio Inc., New York, NY (US)

(72) Inventors: Sean Gibbons, Jackson, NJ (US); Theodore Osborn Calvin, Austin, TX (US); Kenneth James Parsons, Bryn Mawr, PA (US); James Michael Geier, Montvale, NJ (US); Thomas Schalk, Plano, TX (US)

(21) Appl. No.: 16/067,452

(22) PCT Filed: Dec. 28, 2016
(86) PCT No.: PCT/US16/68946

§ 371 Date: Jun. 29, 2018

Related U.S. Application Data
(60) Provisional application No. 62/273,419, filed on Dec. 30, 2015.
(60) Provisional application No. 62/306,430, filed on Mar. 10, 2016.

(51) Int. Cl. G06F 3/0482; G06F 3/16; G06F 3/0488; G06F 3/0354; H04L 29/06; H04H 20/74

(52) U.S. Cl. CPC G06F 3/0482; G06F 3/167; H04H 20/74; G06F 3/03545; H04L 65/4076; G06F 3/04883

(57) ABSTRACT

A graphical user-interface for a multi-source media player that optimizes the presentation of content and navigational choices to a user, as well as the user's interactive experience, is described. Methods of enabling users to access, manage and listen to content, whether delivered over an IP, satellite, other communications channel, or some/all of such channels, are presented. The user-interface can include, for example, tile, icon and album art-based user-interface elements. The user-interface elements may be selected via touch screen, voice commands, trackball and remote touch activated panels, as well as haptic devices or rotary controllers, or various multi-modal combinations of inputs and control signals.

### CROSS-REFERENCE TO RELATED APPLICATIONS

This application claims the benefit of U.S. Provisional Patent Application No. 62/273,419, filed on Dec. 30, 2015, entitled “Novel User Interface Presentations and Interactions for Multiple Source In-Vehicle Radios” and U.S. Provisional Patent Application No. 62/306,430, filed on Mar. 10, 2016, entitled “Connected Vehicle and Speech Recognition-Based Systems and Methods for Vehicle Performance Feedback and Analytics.” The contents of each of these applications are incorporated by reference in their entirety.

### TECHNICAL FIELD

The present subject matter is directed to graphical user-interfaces, particularly to features of a graphical user-interface for use with a multi-source media player such as an in-vehicle head unit, that optimizes the presentation of content and navigational choices to a user, as well as the user's interactive experience.

### BACKGROUND

Rich and varied media use is now the norm in vehicles. For example, many audio contents are available from broadcast sources like AM/FM, and from various music streaming services over cellular and/or IP (Internet Protocol) data connections. Moreover, as of 2016, satellite radio subscribers can access over 175 channels of diverse premium content. This large selection, however, makes navigation difficult for users, especially new ones, to either learn all that a given media content delivery system has to offer or to easily and efficiently access the numerous channels of programming even once they have some familiarity. This is likely due to two reasons.

First, most in-vehicle user-interfaces (UI) are generally text-based, presenting names of channels for the user to choose from, similar to typical television electronic programming guides (EPGs). Additionally, channels are generally presented sequentially, where channels in the same category are grouped together in the same “run” or “band” of channels, but similarities that may cross category boundaries are not noted, presented, or used as the basis to change to a similar channel.

Secondly, groups of channels within a programming type, or, at a higher level of abstraction, a set of different categories (e.g., news, sports, music, talk, etc.) are also generally presented as text.

These conventional approaches are not conducive to selecting audio content while driving. Drivers want to be able to navigate through a complex multi-channel interface, having multiple features, quickly, without having to focus on reading too many words, so they can focus on the road. Additionally, if a driver or other user likes a particular channel or a genre, and they want to find more of it, it is much preferred if the system can alert them to any and all similar content. No driver wants to pull out a channel list and determine which channels go with which other channels. Drivers need to see that information conveniently, and in a way that is as evident and as immediate as possible, and with interactivity that allows for quick and efficient selection of content. Ultimately, a driver's interaction with an in-vehicle radio should require a minimal amount of attention demand, as well as a limited number of short eye glances toward the infotainment display.

Another drawback of convention in-vehicle UI is the complete segregation of different media sources. Contents are divided at the top level by the media source (e.g., AM, FM, Bluetooth, and Satellite). Consequently, users must first decide which media source to access. Once the media source is selected, content selections are limited to that selected media source.

### SUMMARY

The present subject matter provides a user-interface that unifies the presentation of contents from multiple sources. In some implementations, the user-interface is optimized for efficient navigation to media contents, which can come from one or more sources including satellite broadcast and IP streaming. In some implementations, the user-interface can be implemented in an in-vehicle multi-source infotainment head-unit. In exemplary implementations of the present subject matter, novel and efficient methods of enabling users to access, manage and listen to content, whether it's over an IP, satellite, other communications channel, or some/all of such channels, are presented.

User-interfaces according to exemplary implementations include tile, icon and album art-based presentation, as opposed to presentations including listings of text that a user must view or cycle through. Icons may be chosen via touch screen, voice commands, trackball and remote touch activated panels, as well as haptic devices or rotary controllers, or various multi-modal combinations of inputs and control signals.

Exemplary interfaces and interaction flows according to the present subject matter are believed by the inventors to be at least a step ahead of conventional approaches in that they are advanced, and adept at content discovery. This makes it very easy for drivers and other users to discover not only live content, but on demand content as well, covering all programs that a user may bring up, replay or otherwise interact with. The graphical user-interface may include one constituent portion or multiple constituent portions.

In exemplary implementations of the present subject matter, a user may interact with a user-interface directly, such as, for example, by using a stylus, such as a finger, on a touch screen, or indirectly, such as, for example, by using a rotary dial or a haptic controller, in whole or in part, to effect the various interactions described above as being accomplished via touch screens. Additionally, other controllers commonly used on laptops and desktops may also be used, such as, for example, 5-way controllers and jog wheels. In addition, a user may interact with an in-vehicle user-interface via voice commands instead of, or in addition to, touch screen tapping, gesturing and swiping.

To enhance the user experience using voice commands, the present subject matter provides a voice recognition system with enhanced voice recognition and silence detection features. In some implementations, the voice recognition system can be configured to receive one or more telematics data (“telematics” is also referred to in the art as connected vehicle). The voice recognition system can be configured to provide and/or restrict certain features of the media device based on the telematics data.

The present subject matter provides a device that includes a display, at least one processor, and a non-transitory computer-readable medium including instructions which, when executed by the at least one processor, cause the at least one processor to perform one or more features of the present subject matter.

The present subject matter also provides a method that includes presenting a user-interface on the display and enabling selection of one or more of the user-interface elements by a user. The user-interface can include a plurality of user-interface elements. At least some of the user-interface elements can be or include tiles, active buttons, icons, or images representing a media content that can be streamed to the device via a one-way broadcast and a two-way communication channel. In some embodiments, the selection of one or more of the user-interface elements can be performed by the user via at least one of an interactive touch screen, a rotary dial, a haptic controller, or voice commands.

In some embodiments, the user-interface elements are presented in a plurality of screens. In some embodiments, at least some of the user-interface elements are presented as a 1D array of user-interface elements or a 2D array of user-interface elements.

In some embodiments, upon selection by a user of one from a first set of presented user-interface elements, the device is configured to remove from view at least some of the user-interface elements which do not form part of the selected element. In some embodiments, the device can be configured to automatically display a second set of user-interface elements to the user upon selection of one from a first set of presented user-interface elements. In some embodiments, the first set can include tiles representing a set of content categories, and the second set can include shows, channels, or programs within one of the categories. In some embodiments, the first set can include active buttons for at least one of presents, recommended channels, custom mix, more from this channel, and a currently playing channel.

In some embodiments, the selection of the one or more user-interface elements can include detecting a particular stylus position from a plurality of detectable style positions of the device. Each stylus position can be associated with a constituent portion of the user-interface. In some embodiments, the selection of the one or more user-interface elements can include detecting a particular cursor position from a plurality of detectable cursor positions of the device, each cursor position being associated with a constituent portion of the user-interface. In some embodiments, the user-interface can include multiple constituent portions.

In some embodiments, the enabled selection of one or more of the user-interface elements by a user includes a user speaking voice command or a defined set of words. The device being configured to limit a length and/or complexity of the voice command or defined set of words that enables the selection of one or more of the user-interface elements based on a speed of a vehicle associated with the device when the voice command or set of words are received.

In some embodiments, the selection of the one or more user-interface elements comprises detecting a particular cursor position from a plurality of detectable cursor positions of the device. Each cursor position can be associated with a constituent portion of the user-interface.

In some embodiments, the device can include a voice recognition system. The voice recognition system can be configured to limit a functionality of the voice recognition system based on a driving condition, which can include a vehicle speed, road noise, and/or a traffic condition.

In some embodiments, the voice recognition system can be configured to determine a beginning and an end of a voice command. The determining of the beginning and the end can include receiving a plurality of audio chunks of equal time frame; calculating an audio level for each of the audio chunks, and determining a background noise level based on the audio level for each of the audio chunks.

In some embodiments, the device can include a telematics sensor for generating telematics data. The method can include monitoring the telematics data from the telematics sensor and limiting a functionality of at least one of the plurality of user-interface elements when a driving condition is detected.

Computer programs, code or instructions for presenting the user-interface to a user, and controlling user interactions with it, may be stored in a memory, and such memory may be included in the media player such as an in-vehicle multi-source infotainment head-unit, a smart device, or a computer The memory may comprise one or more of, for example, a CD, DVD, flash memory, hard disk, memory card or memory containing peripheral, volatile memory, non-volatile memory, or Random Access Memory, for example. In some embodiments, a computer program may be configured to run on an in-vehicle multi-source infotainment head-unit, or, for example, other user devices, as an application. The application may be run by a device or apparatus via an operating system.

The present disclosure includes one or more corresponding aspects, embodiments or features in isolation, or in various combinations, whether or not specifically stated (including claimed) in that combination or in isolation. Corresponding means for performing one or more of the described functions are also within the present disclosure. Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE DRAWINGS

It is noted that some of the Figs. were captured as screenshots on actual working prototypes. They thus may have the label “copied to clipboard” which is part of the device software, and not part of the exemplary screen being captured.

FIG. 1 depicts an exemplary first screen in an intro/tutorial for an in-vehicle satellite radio service according to an exemplary embodiment of the present subject matter;

FIGS. 2-4 depict following screens of the intro/tutorial;

FIG. 5 illustrates an exemplary one-click 60 day free-trial activation screen according to an exemplary embodiment of the present subject matter, presented at the end of the tutorial;

FIG. 6 depicts an exemplary Categories screen, showing various available content categories as well as a “Direct Tune” icon, according to an exemplary embodiment of the present subject matter;

FIG. 7 depicts an exemplary first “Music” sub-categories screen, which a user would see upon touching “Music” in the exemplary screen shown in FIG. 6, according to an exemplary embodiment of the present subject matter;

FIG. 8 depicts a first of five “Rock” sub-categories screen, which a user would see upon selecting the “Rock” sub-category in the screen shown in FIG. 7, according to an exemplary embodiment of the present subject matter;

FIG. 9 depicts an exemplary player screen, showing Channel 21—Underground Garage, (shown in the Rock channels presented in FIG. 8) with the album art conveniently displayed next to the artist and song title according to an exemplary embodiment of the present subject matter;

FIG. 10 depicts a second “Rock” sub-categories screen, which follows the first Rock screen of FIG. 8;

FIG. 11 depicts an exemplary horizontal tile tuning screen that presents the various pop channels in a tile based swipe-screen manipulable format according to an exemplary embodiment of the present subject matter;

FIG. 12 depicts the result of a swipe to the left by a user acting on the exemplary screen of FIG. 11, according to an exemplary embodiment of the present subject matter;

FIG. 13 depicts the result of multiple additional swipes to the left by a user acting on the exemplary screen of FIG. 12, according to an exemplary embodiment of the present subject matter; now Channel 12—Z-100 is the highlighted channel;

FIG. 14 depicts an exemplary top level Categories screen, equivalent to that of FIG. 6, however this screen shows that the Elvis Radio channel has been selected, and is now playing as the user accesses the Categories screen;

FIG. 15 depicts a first of two exemplary Recommended screens according to an exemplary embodiment of the present subject matter;

FIG. 16 depicts an exemplary voice-based search screen according to an exemplary embodiment of the present subject matter—a user may navigate to this page by selecting the search icon at the upper right of the screen shown in FIG. 14;

FIG. 17 depicts an exemplary screen informing a user how to create a preset, according to an exemplary embodiment of the present subject matter;

FIG. 18 depicts an exemplary player screen loading the song information upon selecting Channel 3 “Venus”, according to an exemplary embodiment of the present subject matter;

FIG. 19 depicts the player screen shown in FIG. 18, once the data has loaded;

FIG. 20 depicts an exemplary player screen where Channel 8—80s on 8 has been selected, showing the song and the album art for the album off of which the song originated, according to an exemplary embodiment of the present subject matter;

FIG. 21 depicts a first of two “SIMILAR TO” screens that appear following a user touching the recommended button in FIG. 20, where Channel 8 is still playing, as shown.

FIG. 22 depicts a second “SIMILAR TO” screen arrived at by swiping to the left in the screen of FIG. 21, according to an exemplary embodiment of the present subject matter;

FIG. 23 depicts a screenshot of the News category according to an exemplary embodiment of the present subject matter;

FIG. 24 is a screenshot that would be seen when the user selects the News/Public Radio subcategory tile in the bottom left of FIG. 23, now showing the first of three channel screens for that subcategory.

FIG. 25 shows what happens when the Fox News channel tile at the bottom center left of FIG. 24 is selected by a user; instead of album art, there is a photograph showing known celebrities featured on the channel as the background of this screen;

FIG. 26 depicts the result of a user having activated the “MORE FROM THIS CHANNEL” button in the top right of the screen shown in FIG. 25; it shows similar channels to the one being played, according to an exemplary embodiment of the present subject matter;

FIG. 27 shows a first “RECOMMENDED” screen that a user would see if he or she first activated the X icon in the top right of FIG. 26, thereby exiting the Available Shows screen, and then clicked on the “RECOMMENDED” button in the bottom center of FIG. 25, according to an exemplary embodiment of the present subject matter;

FIG. 28 is a second “RECOMMENDED” screen according to an exemplary embodiment of the present subject matter; inasmuch as there are no additional recommended channels in this screen, the system presents to the user an “IMPROVE YOUR RECOMMENDATION” screen, as shown;

FIG. 29 is the first of a number of recommendations data query screens that a user would see following the screen of FIG. 28;

FIGS. 30-34 depict exemplary remaining data query screens for recommendations according to an exemplary embodiment of the present subject matter;

FIG. 35 illustrates a GO TO CHANNEL screen according to an exemplary embodiment of the present subject matter;

FIG. 36 shows an exemplary result when a user enters the number nine (via the number board) in the “GO TO CHANNEL” screen shown in FIG. 35, according to an exemplary embodiment of the present subject matter;

FIG. 37 is an exemplary player screen for Channel 9 which will present itself upon a user activating either the channel icon or the “Go” button shown in FIG. 36 according to an exemplary embodiment of the present subject matter;

FIGS. 38-39 depict the results of pressing the bottom left center “RECOMMENDED” button in FIG. 37, according to an exemplary embodiment of the present subject matter;

FIG. 40 depicts what happens when a user activates the “Amy Schumer's Favorites” tile in FIG. 39, thus bringing up the set of “Amy Schumer's Favorites”;

FIG. 41 depicts an exemplary player screen for Channel 93—Sirius XM Sports Zone according to an exemplary embodiment of the present subject matter—the “Busted Open” show is currently playing;

FIG. 42 depicts a swipe selection screen, obtained by a user activating one of the arrow buttons on either the left or the right of the player screen of FIG. 41, according to an exemplary embodiment of the present subject matter;

FIG. 43 is a player screen for Channel 94, which was selected as shown in FIG. 42, according to an exemplary embodiment of the present subject matter;

FIG. 44 which is once again the GO TO CHANNEL or Channel Entry screen, which a user obtains by touching or selecting the blue “Channel 94” button shown in the upper left of FIG. 43 according to an exemplary embodiment of the present subject matter;

FIG. 45 is an exemplary player screen for Channel 23 which results from the user actually selecting the depicted tile in FIG. 44 according to an exemplary embodiment of the present subject matter;

In FIG. 46, the user has activated the presets button at the bottom left of FIG. 45, and therefore, while Channel 23 remains playing (as shown by the channel icon and the text in the upper left of FIG. 46) the presets are also shown. As shown, a user has recently added the preset Grateful Dead in the bottom right by a long press on the album art in FIG. 45; in some embodiments a preset may be activated by pressing and holding any channel icon or channel number that appears on the player screen;

FIGS. 47 through 51 depict a sequence of user interactions while Channel 20—E Street Radio has been selected:

FIG. 47 depicts an exemplary player screen for Channel 27—E Street Radio according to an exemplary embodiment of the present subject matter;

FIG. 48 depicts the results of clicking on the “MORE FROM THIS CHANNEL” button at the top right of FIG. 47, showing a listing of similar channels and/or on-demand episodes to that of the currently selected and playing channel;

FIG. 49 illustrates an alternate type of category depiction where not only are the various music categories shown but also some highlighted channels themselves are shown, according to an alternate exemplary embodiment of the present subject matter, where the highlighted channels are recommendations based upon processing user metadata;

FIG. 50 is a second music category screen supplementing that of FIG. 49, obtained by a swipe from right to left;

FIG. 51 illustrates the result of a user selecting the “Latino” tile shown at the bottom right of FIG. 50, according to said alternate exemplary embodiment of the present subject matter;

FIG. 52 depicts Presets with Channel 25 playing in the background, and thus illustrates what happens if a user perhaps moves, from the screen of FIG. 51, forward to Channel 25—Classic Rewind (for example, by first returning to the player screen of FIG. 47, then using the caret on the right side of the screen to advance to Channel 25) and then selects the Presets button at the bottom of the player screen, according to an exemplary embodiment of the present subject matter;

FIG. 53 illustrates what happens if a user has chosen the Spa Channel shown in the top center right tile of FIG. 52 and has also selected the News category while the Spa Channel is playing in the background, according to an alternate exemplary embodiment of the present subject matter;

FIGS. 54 through 59 illustrate various exemplary user interactions while a user is playing Channel 26—Classic Vinyl, as next described;

FIG. 54 illustrates a player screen for Channel 26—Classic Vinyl; the blue star to the right of the channel number indicates that this channel has been saved as a preset for this user profile;

FIG. 55 illustrates the result of selecting the “MORE FROM THIS CHANNEL” button at the top right of FIG. 54—the available shows are presented according to an exemplary embodiment of the present subject matter;

FIG. 56 illustrates the result of the user selecting the “SIMILAR TO” button at the top right of FIG. 55, which displays the first screen of similar channels;

FIG. 57 illustrates the result of the user selecting the “X” icon at the top of FIG. 56, to return to the player screen;

FIGS. 58 and 59 illustrate the result of the user selecting the “Recommended” button at the bottom of FIG. 57, FIG. 58 is the first of two recommended screens, and FIG. 59 being the second, according to an exemplary embodiment of the present subject matter;

FIG. 60 depicts an exemplary personalization screen—“Create SXM Listener”—according to an exemplary embodiment of the present subject matter.

FIGS. 61-73 are exemplary screen shots of an alternate embodiment of the present subject matter, designed for use in a different, more vertical, aspect ratio;

FIG. 61 depicts the various layers and sections of an exemplary visual design according to an alternate exemplary embodiment of the present subject matter, and what content may be placed in such sections;

FIG. 62 depicts an exemplary implementation of the layers and sections of FIG. 61 where the “Now Playing” bottom layer has a navigation application running in it;

FIGS. 63(a)-(c) depict an exemplary implementation of mixed presets in a main screen with application specific presets accessed by selecting a source and selecting a presets button;

FIG. 64 depicts an exemplary automotive center stack, with a more vertical screen aspect ratio, according to the alternate exemplary embodiment;

FIGS. 65(a)-(d) depict a voice search sequence using screens according to the alternate exemplary embodiment;

FIGS. 66(a)-(b) depict profile creation and use using screens according to the alternate exemplary embodiment;

FIGS. 67(a)-(f), and 68(a)-(f) depict screens associated with converting a customer at the end of their free trial to a paid subscription plan;

FIGS. 69(a)-(c) depict user messaging screens according to an exemplary embodiment of the present subject matter;

FIGS. 70(a)-(d) depict various exemplary player, player and presets, search results, and shows in a sub-category using screens according to the alternate exemplary embodiment;

FIG. 71 provides various examples of rotary dials and haptic controllers according to an exemplary embodiment of the present subject matter;

FIG. 72A is an exemplary player screen, as shown above, but here playing a custom mix version of Channel 1—“Sirius XMHIts1”, according to an exemplary embodiment of the present subject matter;

FIG. 72B maps the various active buttons and icons shown in FIG. 72A to 16 selectable positions that may be accessed in order using a rotary dialer, according to an alternate exemplary embodiment of the present subject matter;

FIG. 73 depicts an exemplary audio waveform and illustrates sampling of it to illustrate audio end-pointing in a vehicle;

FIG. 74 depicts an exemplary satellite radio content delivery system in accordance with an exemplary implementation of the present subject matter;

FIG. 75 depicts a simplified diagrammatic illustration of a media device in accordance with an exemplary implementation of the present subject matter;

FIG. 76 is a block diagram illustrating a logical connectivity view of an exemplary implementation of the present subject matter;

FIG. 77 illustrates an example graphical user-interface 200 that provides a unified and seamless access to contents from different sources;

FIG. 78 shows another example graphical user-interface 300 that provides a unified and seamless access to contents from different sources;

FIG. 79 illustrates a flow diagram of a method in accordance with an exemplary implementation of the present subject matter; and

FIG. 80 illustrates a flow diagram of another method in accordance with an exemplary implementation of the present subject matter.

### DETAILED DESCRIPTION

The present subject matter provides efficient methods of enabling users to access, manage and listen to content, whether over a two-way communication channel such as Internet Protocol (IP), a one-way broadcast such as satellite, other communications channel, or any combination of such channels through a unifying user-interface. User-interfaces according to exemplary embodiments include user-interface elements such as tile, active button, icon and album art based, as opposed to mere listings of text. Icons and buttons may be chosen via touch screen, voice commands, trackball and remote touch activated panels, as well as using haptic devices or rotary controllers.

It is noted that various exemplary features and functionalities of embodiments of the present subject matter are described with reference to a user-interface for an in-vehicle radio. Such a radio may, in general, receive a plurality of audio (or even video) signals, including AM-FM radio, HD radio, and satellite radio. It may also be equipped with (or connected to) a cellular or other wireless communications modem, and thus also receive streamed audio. A one-way wireless broadcast signal provider may also send audio content and related data via a two-way wireless communications link, and may use both communications pathways in various complementary and coordinated ways.

For example, a satellite radio broadcaster may provide a personalized streaming app for smartphones, and may allow users of the app to create global profiles, which perpetuate or persist across any device, including software running in an in-vehicle head unit that manages the experience of a satellite radio broadcast subscriber or an app user, or both, in-vehicle. The interface provided herein can provide a unified user experience to allow users to access contents seamlessly from one-way broadcast and/or two-way sources.

Thus, for example, a subscriber to the Sirius XM Radio Inc. satellite radio service, who installs and uses the app on a user device, can enter their user profile created on the user device whenever they access the satellite radio service in their vehicle (or vehicles, if so arranged). The in-vehicle experience can include receiving the personalized streaming audio, as well as any alternate, augmentation or supplemental content sent over an in-vehicle IP connection. Thus, exemplary user-interfaces according to the present subject matter inform a user as to whether both satellite broadcast and IP communications network content is available, whether satellite only, or IP content only is available, or whether neither type is available. Moreover, when both satellite and IP content is available, exemplary user-interfaces clearly indicate which content comes from which communications channel. In addition, an exemplary user-interface will advise users when they are close to using up allotted data transfers under their data plans for the IP content, and if accessing an IP based content item, show, or the like, would “max them out” on their current data plan. In general, a user may see various IP based or delivered content items in response to initiating a search, seeking recommended content, accessing presets and similar content to a content item currently being played, or the like, all as illustrated in the figures, and described below. All of these scenarios, as well as related ones, are contemplated by the user-interface presentations and interactions described below.

Exemplary interfaces and interaction flows according to the present subject matter are believed by the inventors to be at least a step ahead of conventional approaches—in that they are advanced, adept at discovery, and thus make it very easy for drivers or other users to discover content, especially while moving. This includes not only live content, but on demand content as well as customized content, covering all programs that a user may bring up, replay, tag or the like.

Media content consumers today have many choices. For example, in the domain of satellite radio received in a vehicle, there are so many channels and other content available, that it is difficult if not impossible to truly get a feel for all of the content options that one may listen to. Because of this difficulty in discovering the totality of content that an SDARS service has to offer, SDARS providers, such as Sirius XM Radio Inc., for example, are likely limiting themselves in terms of how many people actually subscribe. Thus, while over half the people that buy a new car get a free trial to an SDARS service, it is key to insuring a high take rate that potential users are shown an efficient, pleasant and enjoyable user experience during their free trial, while keeping safe driving in mind.

Various novel features of exemplary embodiments of the present subject matter are described below, with reference to numerous illustrative screen shots from a prototype built by the inventors. As noted above, the prototype uses as its context the Satellite Digital Audio Radio Service (“SDARS”), as augmented by IP channel content delivery, provided by assignee hereof, Sirius XM Radio Inc. (“SXM”), as well as the SXM audio streaming app. As a result, the exemplary channel names, channel icons, and divisions of channels into categories and subcategories are those used in those SXM services. It is understood, however, that the novel interactive and navigational features and functionalities described herein may be applied to any media delivery service and its content categories and, the examples from the SXM service, as well as its organizational structure of media content, being merely illustrative, and non-limiting.

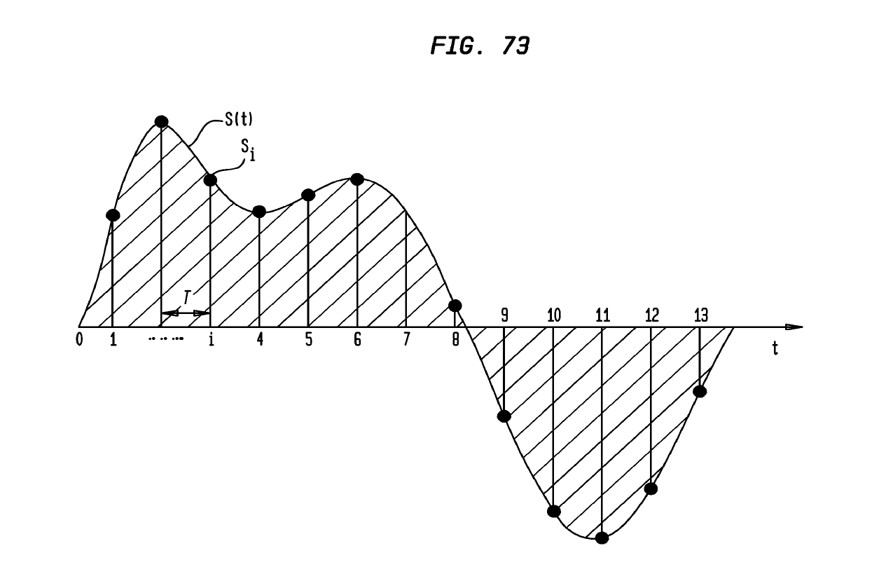

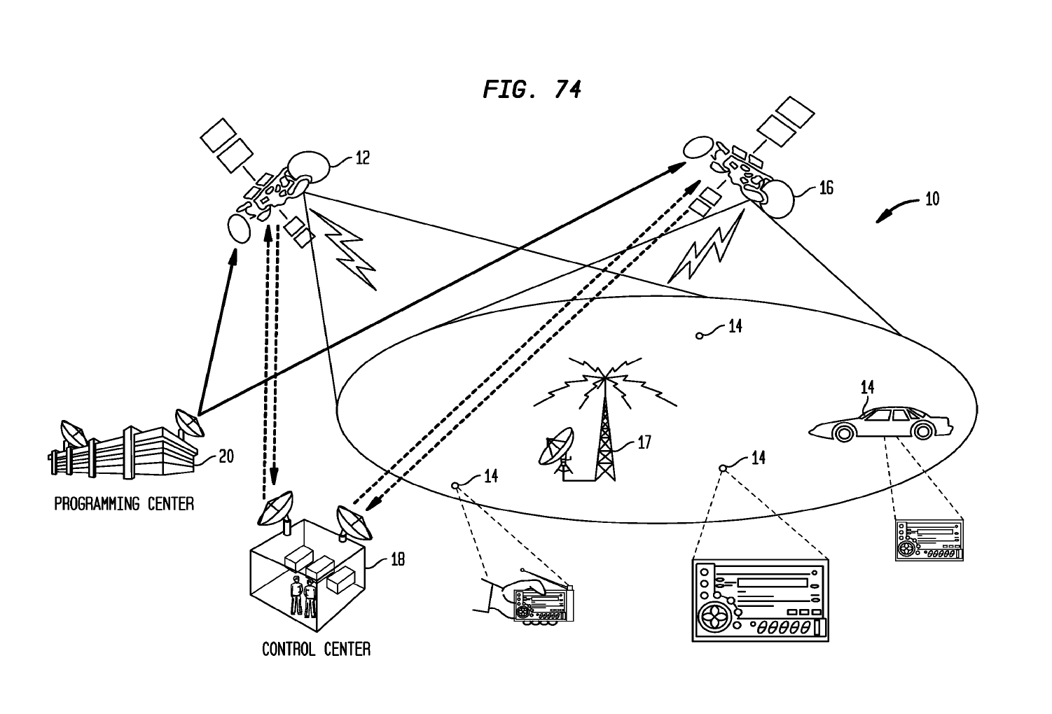

FIG. 74 depicts an exemplary satellite radio content delivery system in accordance with an exemplary implementation of the present subject matter. Here, satellite radio content delivery system 10 includes a plurality of satellites (12, 16) that are controlled by control center 18. The satellites are configured to receive a broadcast signal from programming center 20, and transmit that signal to a plurality of receivers 14. As shown, the receivers can be embedded, for example, in an in-vehicle infotainment system, a home entertainment device, or a portable media player. One or more terrestrial repeaters 17 can also be provided to receive the broadcast signal from the satellites and retransmit the signal to provide better signal coverage for the receivers.

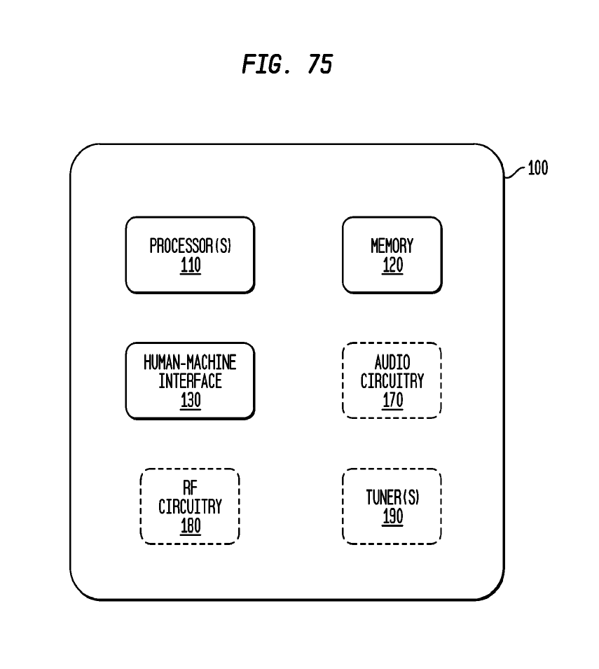

FIG. 75 depicts a simplified diagrammatic illustration of a media device in accordance with an exemplary implementation of the present subject matter. Media device 100 can be, for example, an in-vehicle infotainment system or a smart device such as a smartphone or a tablet. Media device 100 includes one or more processing units or processors 110, memory 120, and human-machine interface 130. Media device 100 can optionally include one or more audio circuitry 170, radio-frequency (RF) circuitry 180, or tuner(s) 190.

Memory 102 can include one or more computer-readable storage mediums. The computer-readable storage mediums can be tangible and non-transitory. Memory 102 can include high-speed random access memory and may also include non-volatile memory, such as one or more magnetic disk storage devices, flash memory devices, or other non-volatile solid-state memory devices.

The one or more processors 110 can be configured to run or execute various software programs and/or sets of instructions stored in memory 102 to perform various functions for media device 100 and to process data.

Human-machine interface 130 can be configured to couple input and output peripherals of media device 100 to the one or more processors 110 and memory 120.

Audio circuitry 170 can be configured to provide an audio interface between a user and device 100. In some embodiments, audio circuitry 170 can receive audio data from human-machine interface 130 and convert the audio data to an electrical signal, and transmit the electrical signal to one or more speakers (which in turn converts the electrical signal to human-audible sound waves). Audio circuitry 170 can also be connected to a microphone to receive electrical signals converted by the microphone from sound waves. Audio circuitry 110 can be configured to convert the electrical signal to audio data and transmit the audio data to human-machine interface 130 for processing.

RF circuitry 180 receives and sends electromagnetic signals, and converts those signals to/from electrical signals to enable media device 100 to communicate with other devices and/or networks via, for example, 4G, Wifi, or Bluetooth.

The one or more tuners 190 can include one or more of AM, FM, HD radio, or satellite tuner such as the Sirius XM (SXM) tuner. The one or more tuners are configured to receive broadcast signal.

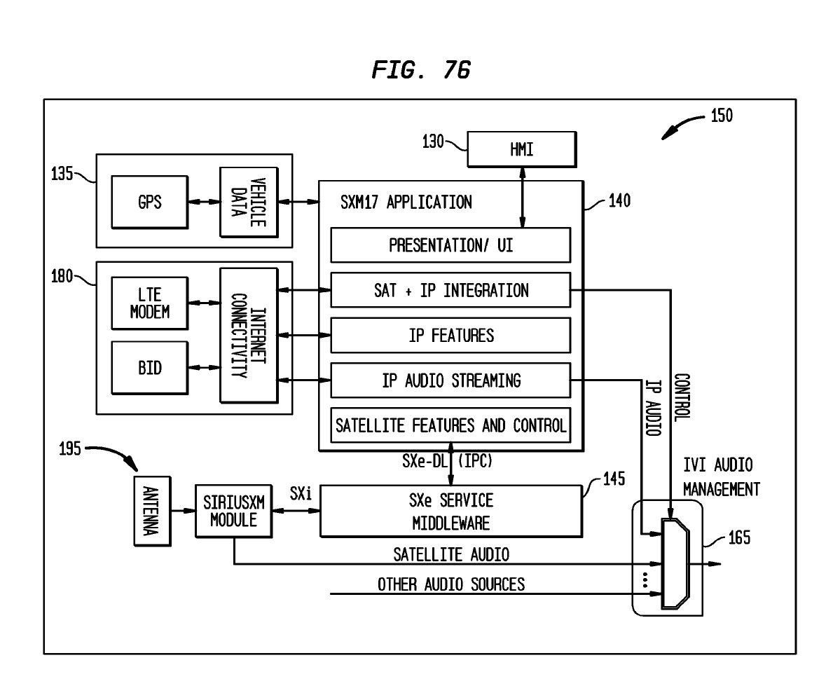

FIG. 76 is a block diagram illustrating a logical connectivity view of an exemplary implementation of the present subject matter. In this example, SXM17 refers to an implementation of a content delivery service that integrates content delivery from a one-way broadcast (such as satellite broadcast) and two-way communication (such as IP). Here, one or more processors are configured to execute instructions stored in memory to implement the SXM17 application layer software component, which provides a number of features including a user-interface (Presentation/UI), satellite and IP integration, IP features (such as album art and/or other enhancements that may not be available from the satellite signal), IP audio streaming, and satellite features and control.

SXe Service Middleware 145 is configured to implement satellite features and control of the satellite module (SiriusXM Module) to deliver satellite audio to the in-vehicle infotainment (IVI) audio management 165. The satellite module is a hardware component that provisions reception of satellite audio and data services.

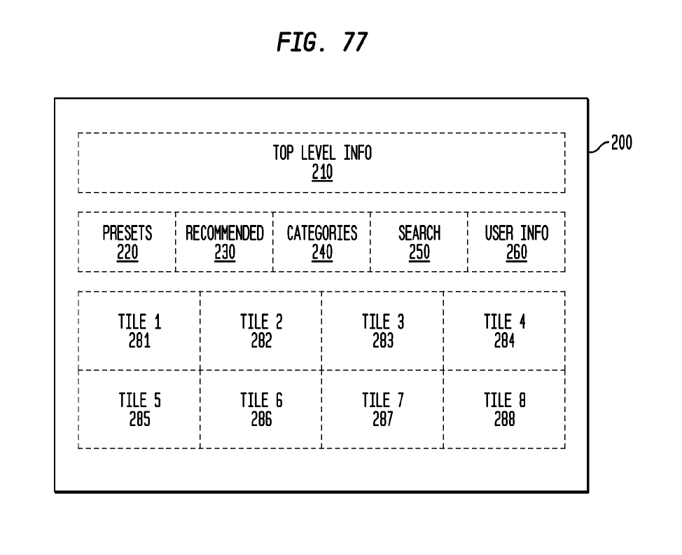

FIG. 77 illustrates an example graphical user-interface 200 that provides a unified and seamless access to contents from different sources (e.g., linear channels from one-way broadcast and/or two-way communications; personalized channels; and/or on-demand content). Unlike conventional user-interface that forces the user to select a source, and limits the content selection to the selected source, the present user-interface removes that artificial barrier based on content source and provides a unified display of contents regardless of the source.

In some implementations, the user-interface can be configured to determine whether a specific content is available based on, for example, the availability of the satellite or IP data connections, and display the available content while graying out the unavailable content, or display only the available content.

In this example, user-interface 200 includes a top-level information section 210, a row of functions 220-260 below section 210, and a plurality of tiles 281-288.

In some implementations, the top-level information section 210 can include one or more of a station/channel name, station/channel number, or the source information (e.g., satellite and/or IP).

The functions in this example include presets 220, recommended 230, categories 240, search 250, and user info 260. In some implementations, one or more of the functions can be omitted or substituted. In some implementations, one or more additional functions can be included.

Although eight (8) tiles are shown in this example, fewer or more tiles can be included. In some implementations, the number of tiles shown can be based on a user-selection. In some implementations, user-interfaced 200 can allow the user to browse/scroll through additional tiles via, for example, by a swiping gesture or other input to access other tiles. In some implementations, each tile can represent a station/channel. In some implementations, each tile can represent a content such as a song or an audio clip.

As can be seen, user-interface 200 provides an icon/tiles-based presentation of contents to allow the user to quickly and intuitively browse through the available selections.

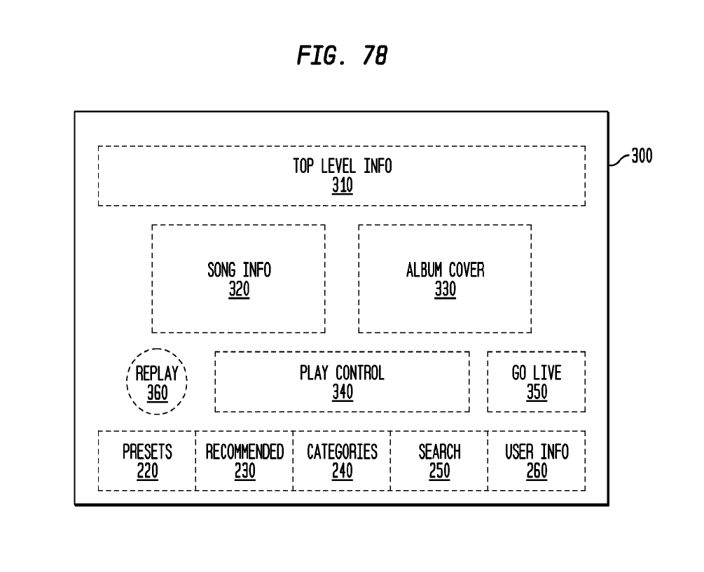

FIG. 78 shows another example graphical user-interface 300 that provides a unified and seamless access to contents from different sources (e.g., linear channels from one-way broadcast and/or two-way communications; personalized channels; and/or on-demand content).

User-interface 300 includes a top level info section 310, which may be similar to top-level information section 210 shown in FIG. 77. User-interface 300 also includes song information section 320, album cover 330, play control 340, “Go Live” 350, and replay 360. At the bottom, user-interface 300 also includes a row of functions 220-260 similar to user-interface 200.

In some implementations, user-interface 300 is provided when the device is playing a particular song or audio clip. In this example, the song being played is being streamed via an IP source, and the song is part of a live channel via broadcast (e.g., satellite). By selecting the “Go Live” 350 option, the user can switch the source from IP to broadcast. This can be helpful, for example, in situations where the user wishes to minimize IP data usage (which may in turn minimize cost). This can also be helpful to allow the user to explore similar content that are available from the broadcast stream.

The replay 360 option can be provided to rewind the content by a certain time period (e.g., 15 seconds). This feature can be particularly useful when the user wishes to rehear a portion of the audio content (e.g., when the user wants to hear an instant replay of a sports contents or an interview).

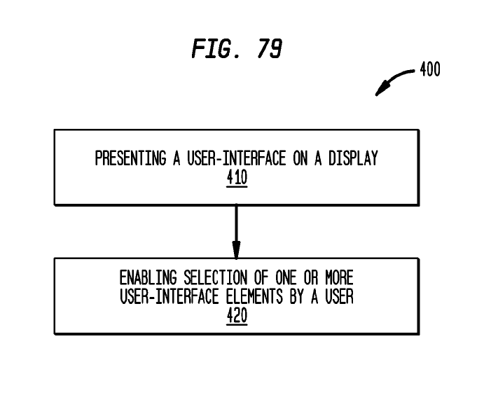

FIG. 79 illustrates a flow diagram of a method in accordance with an exemplary embodiment of the present subject matter. The method includes presenting a user-interface on a display (410) and enabling selection of one or more of user-interface elements of the user-interface by a user (420). In some embodiments, at least some of the user-interface elements are or include tiles, active buttons, icons, or images representing a media content that can be streamed to a media device via a one-way broadcast and a two-way communication channel. In some embodiments, the selection of one or more user-interface elements can be selected via at least one of an interactive touch screen, a rotary dial, a haptic controller, or voice commands.

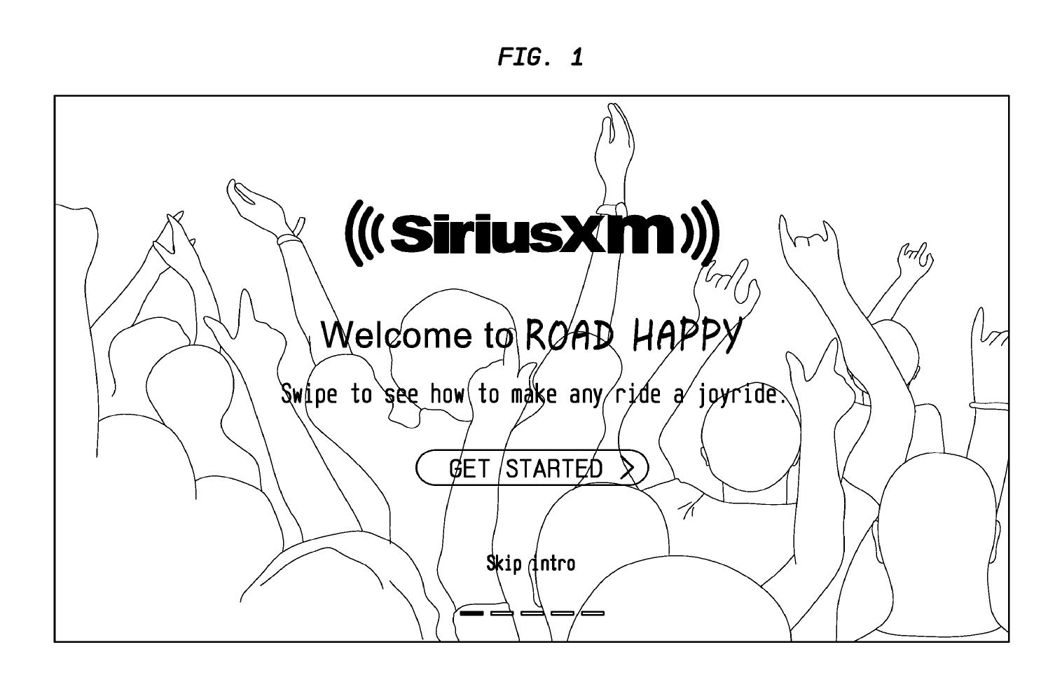

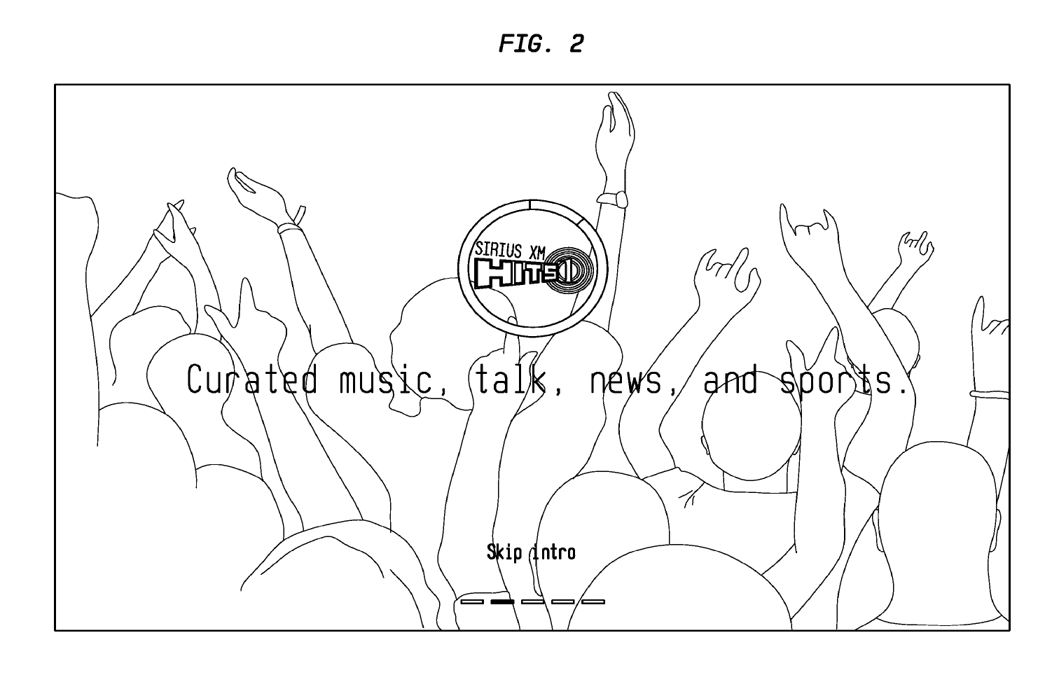

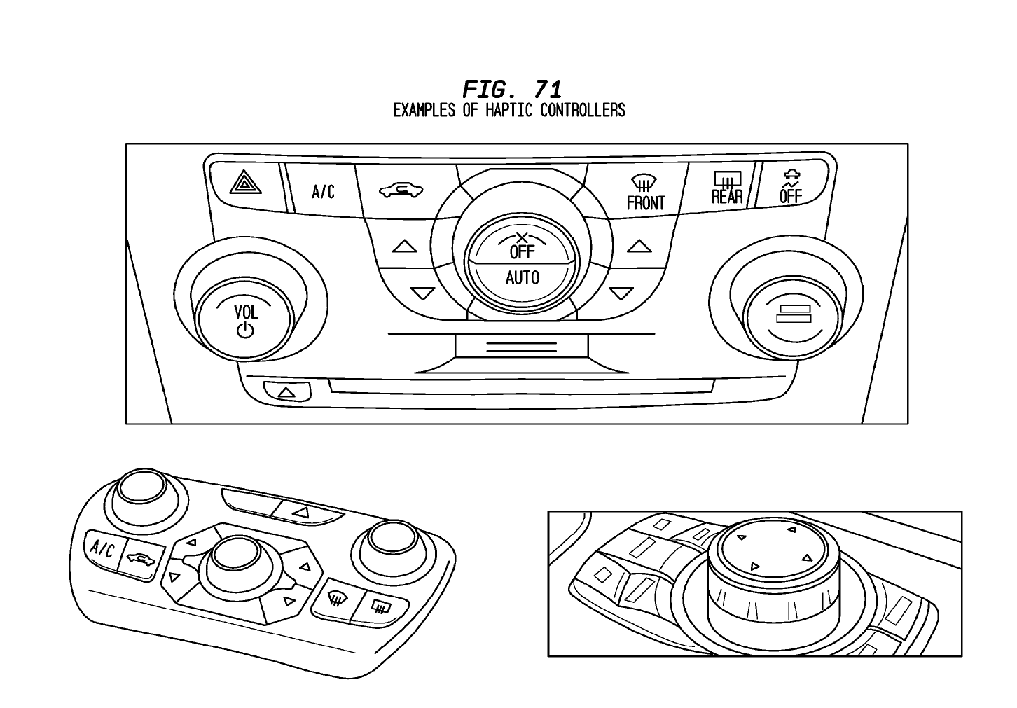

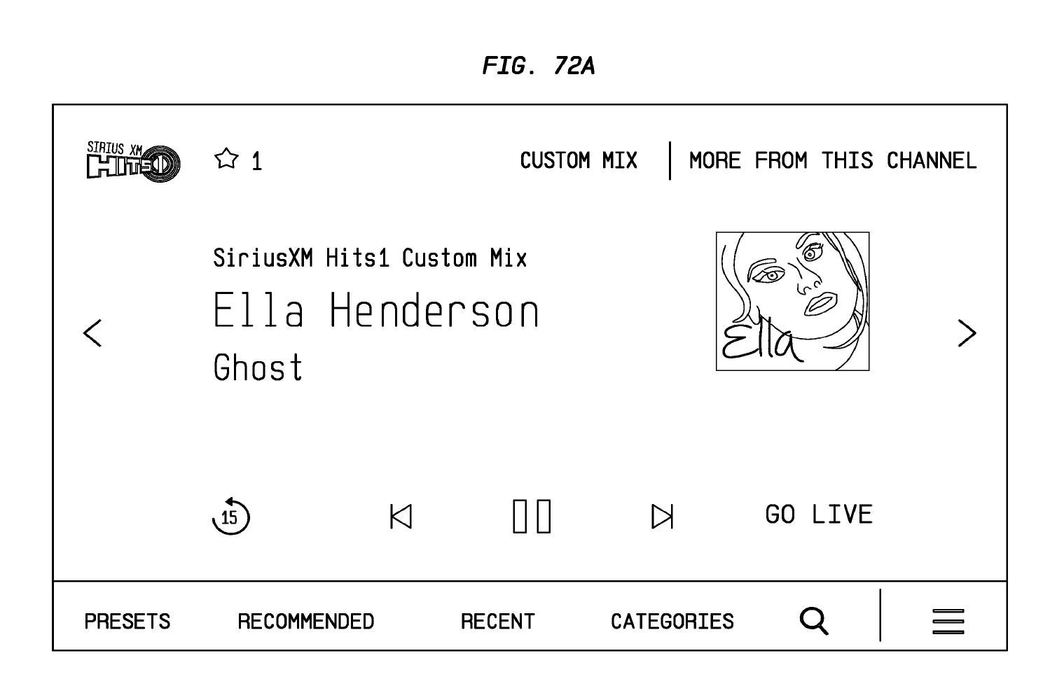

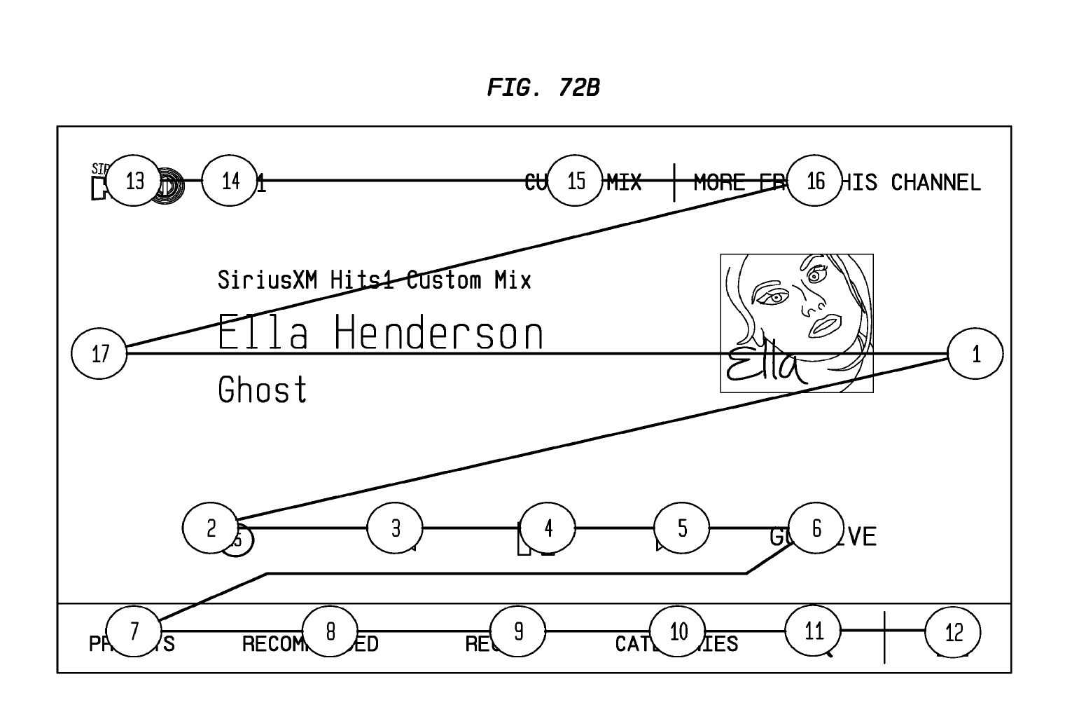

References will now be made to FIGS. 1-72, which depict examples of various implementations of the current subject matter.

### Introduction/Tutorial

FIGS. 1 through 5 illustrate a series of screens which serve as both an introduction and a solicitation to a potential user to learn all of the features that an exemplary satellite radio service can provide. It has a catchy name, “ROAD HAPPY”, and an enticing opening screen which hopefully will induce a user to click the get started button in FIG. 1.

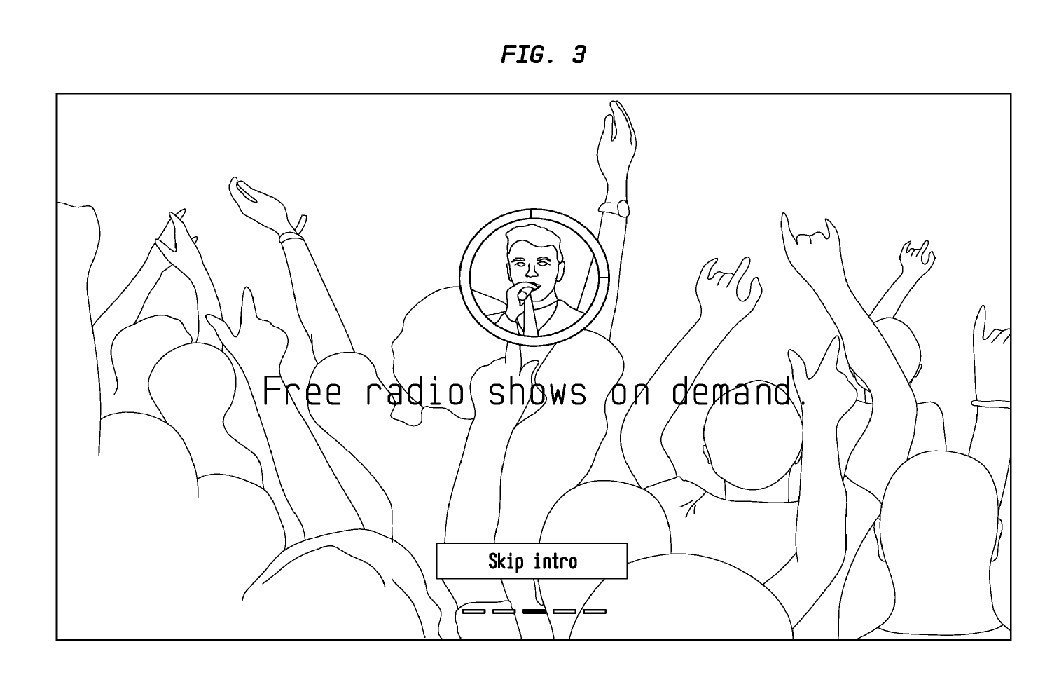

FIG. 2 is the second of the five screens of the introduction and it describes exemplary content categories available from the satellite radio service. It shows a channel name “SiriusXM Hits 1” and uses that as an illustration of the curated music, talk, news and sports that subscribing to the SiriusXM service can provide.

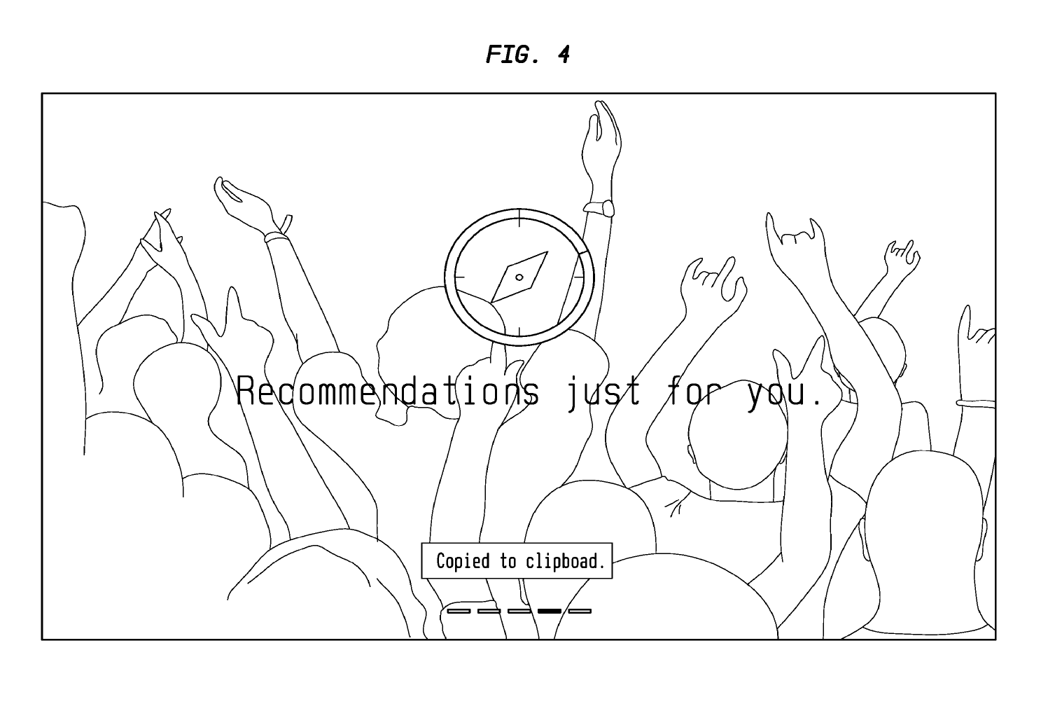

FIG. 3 illustrates that there are free radio shows on demand. In other words, a subscriber has access to various free radio shows in an on-demand service that supplements or augments the various broadcast and IP streamed channels. The on-demand service and other content that is not part of the live broadcast is accessible to users over an IP communications channel, such as, for example, the vehicle's modem.

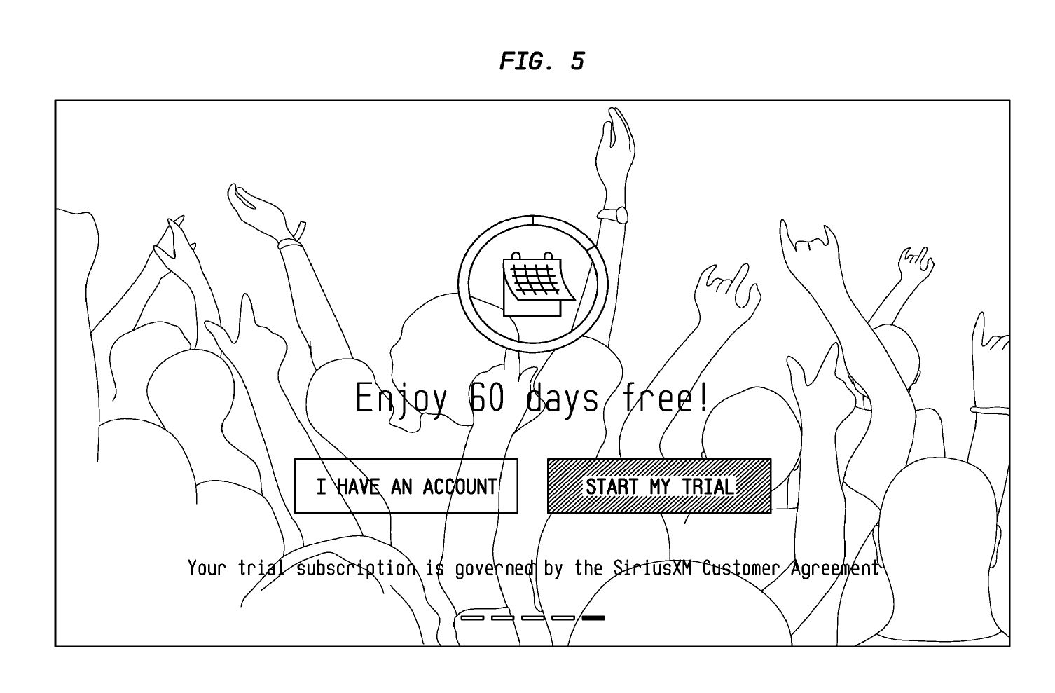

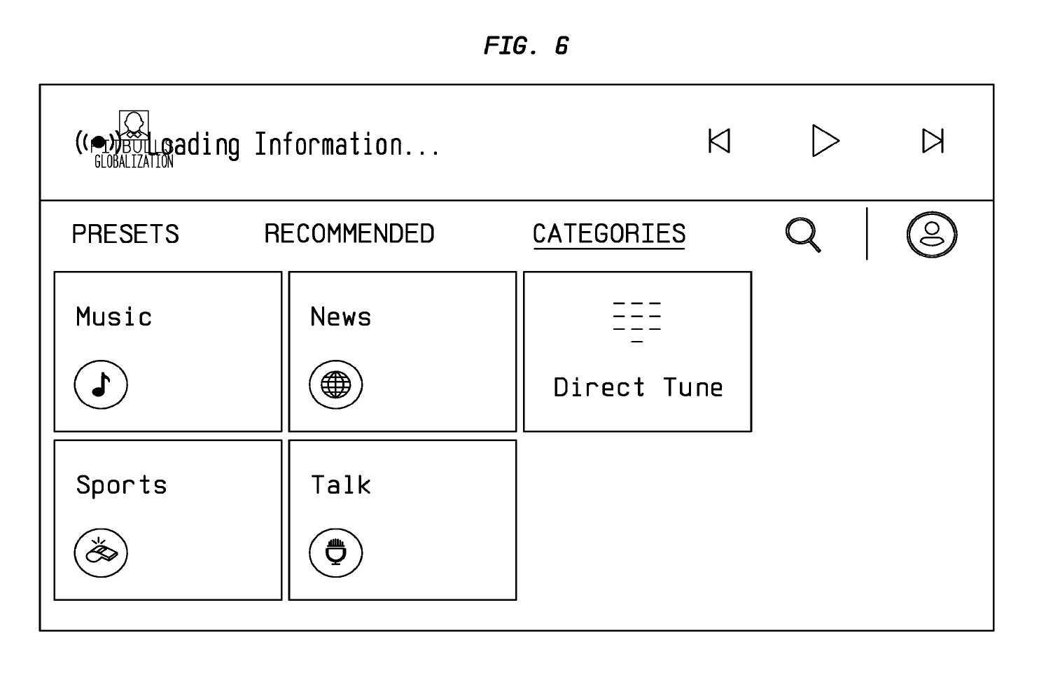

FIG. 4 illustrates that there is intelligence built into the system. Based on user input and listening history, for example, the service can make recommendations for each subscriber as will be described more fully below. These are accessible from almost any screen that a user uses or could interact with via a “Recommended” button. Because user profiles are global in exemplary embodiments, the intelligent recommendations can be based on all user behavior, in-vehicle and otherwise.

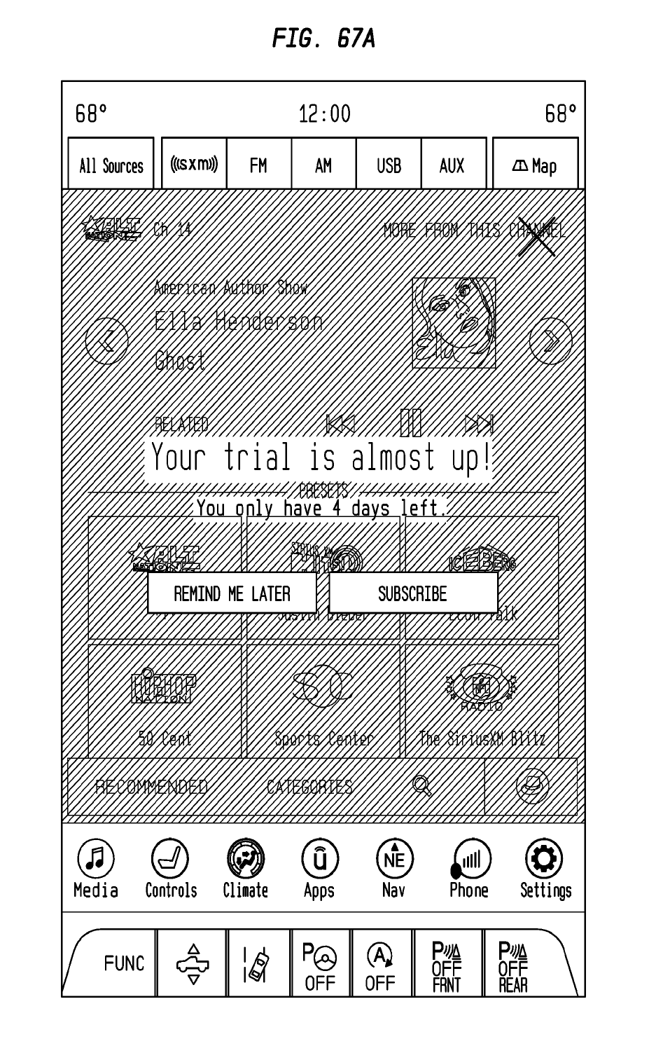

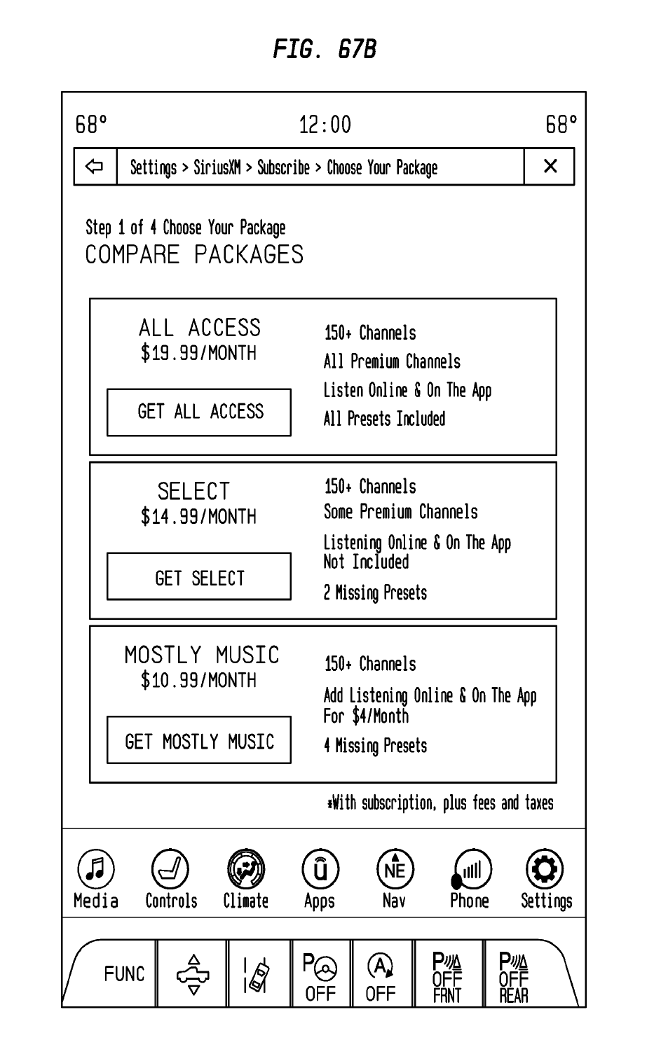

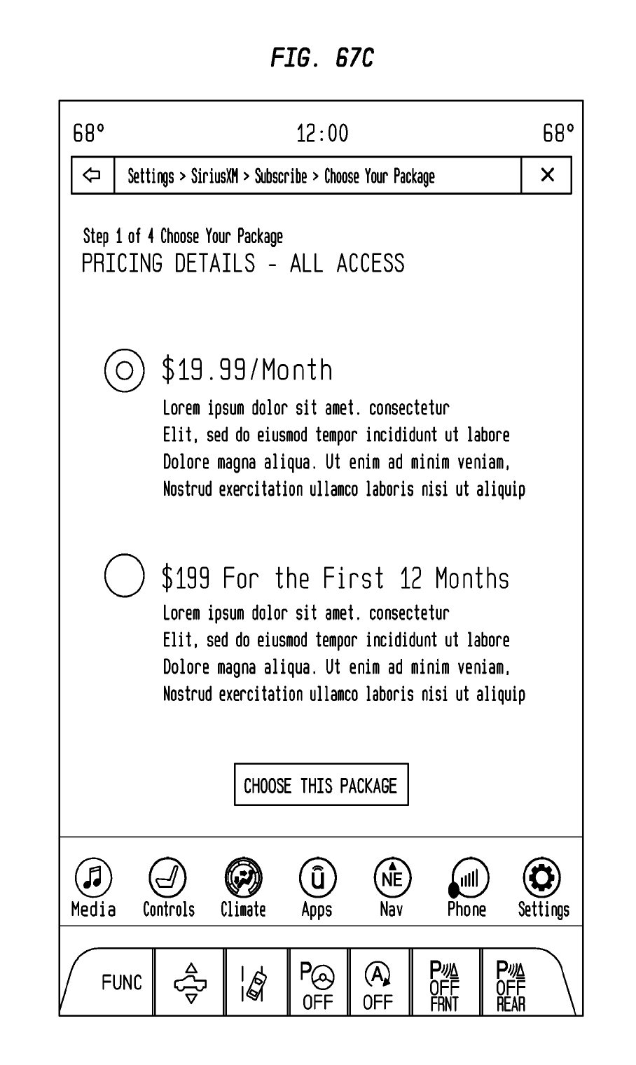

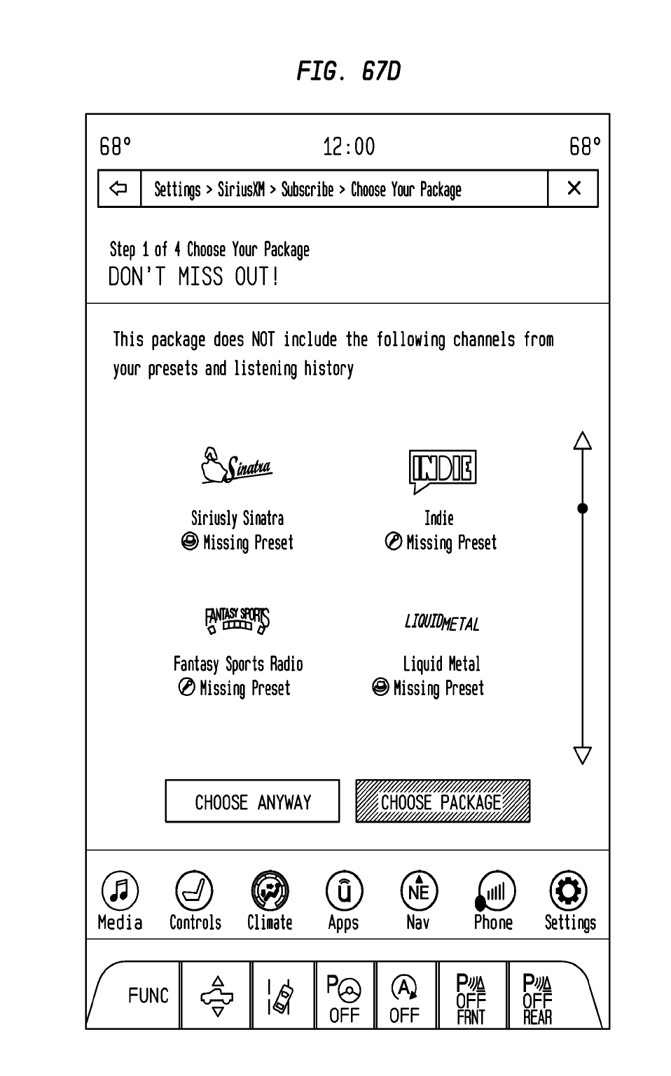

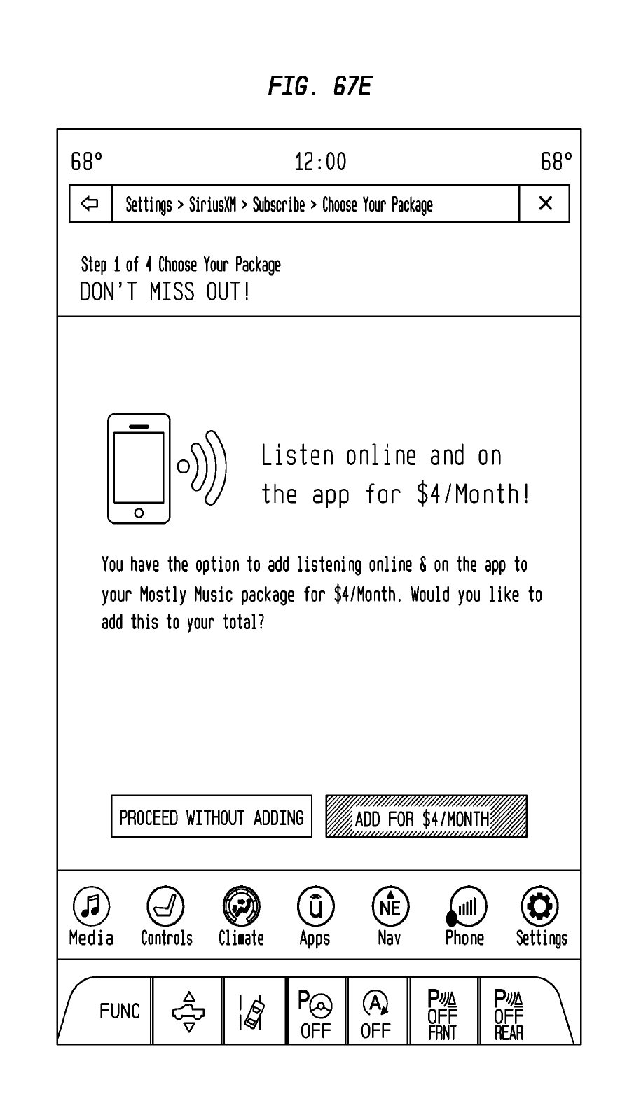

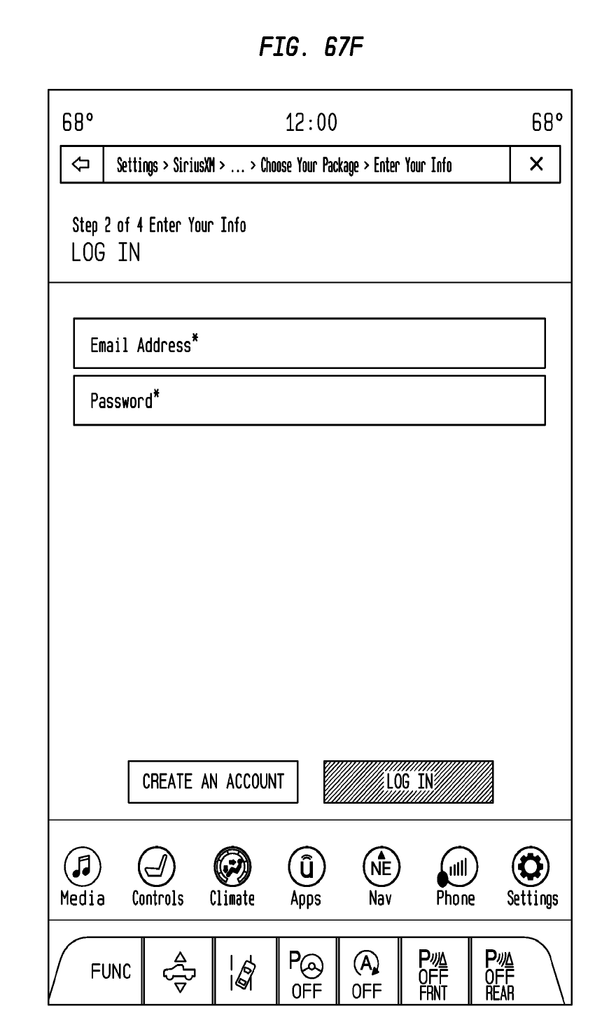

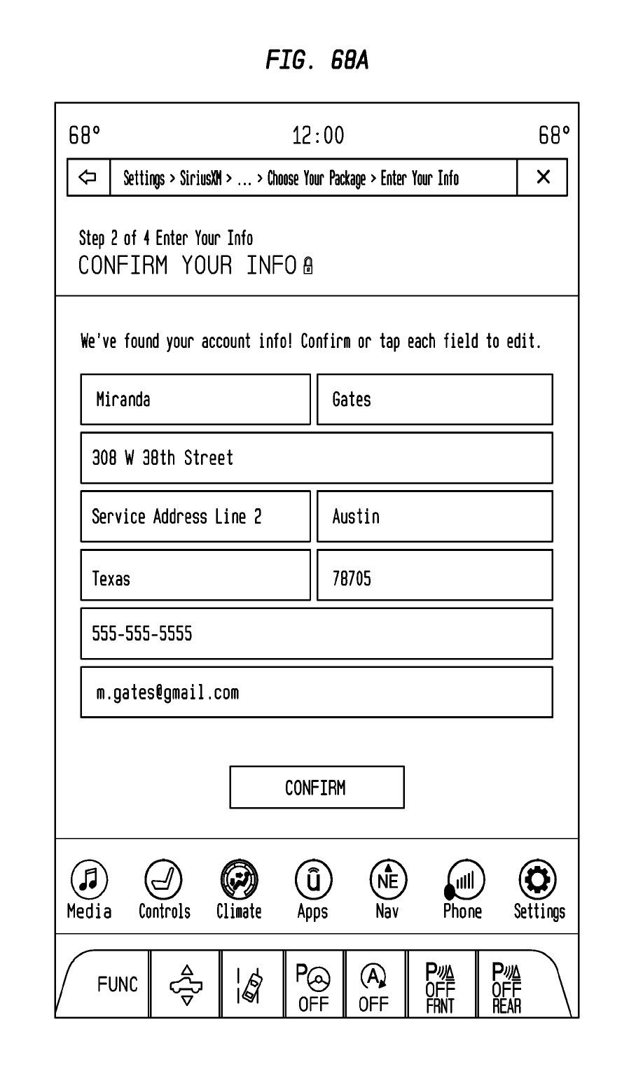

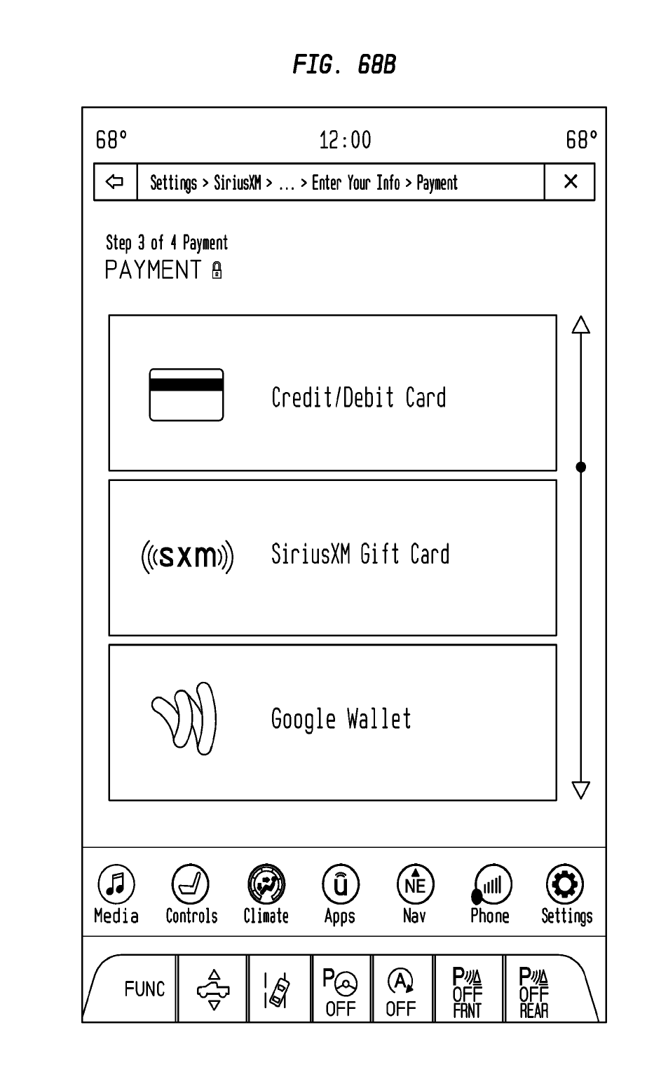

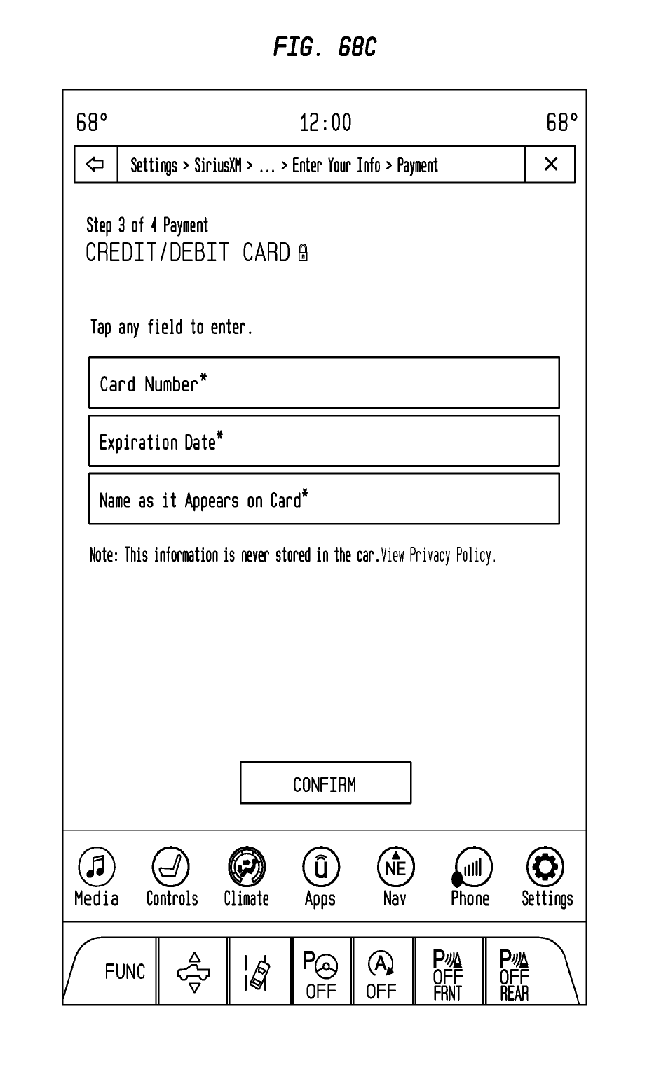

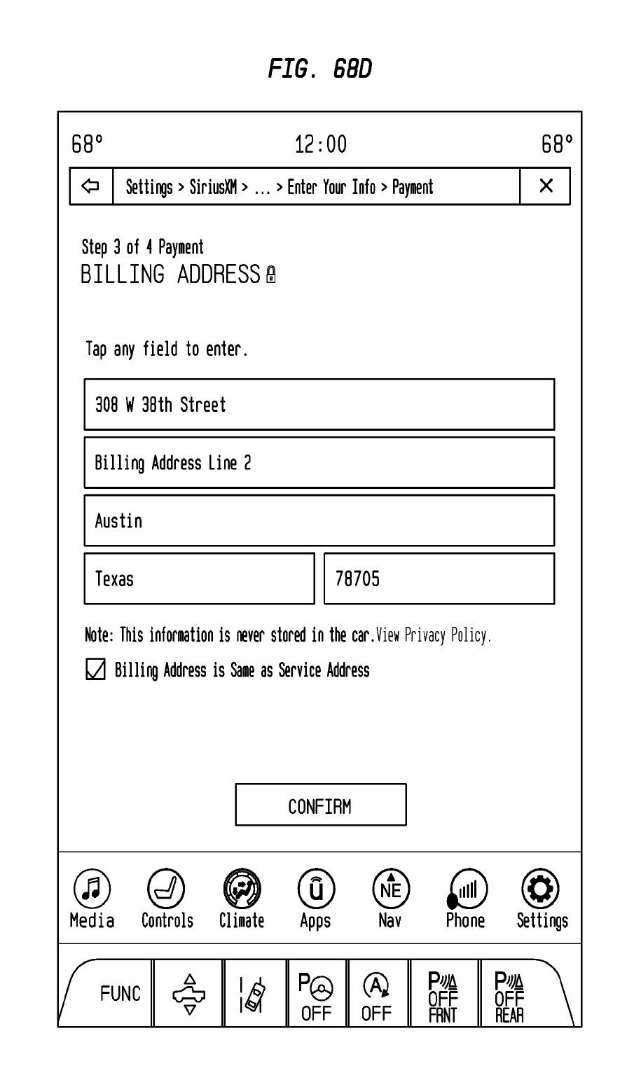

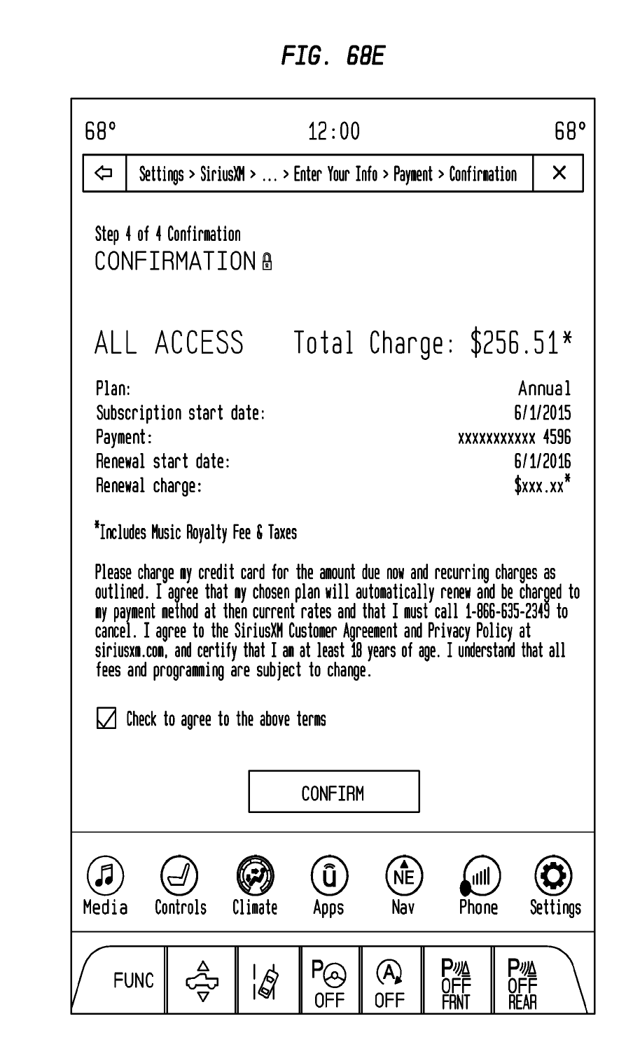

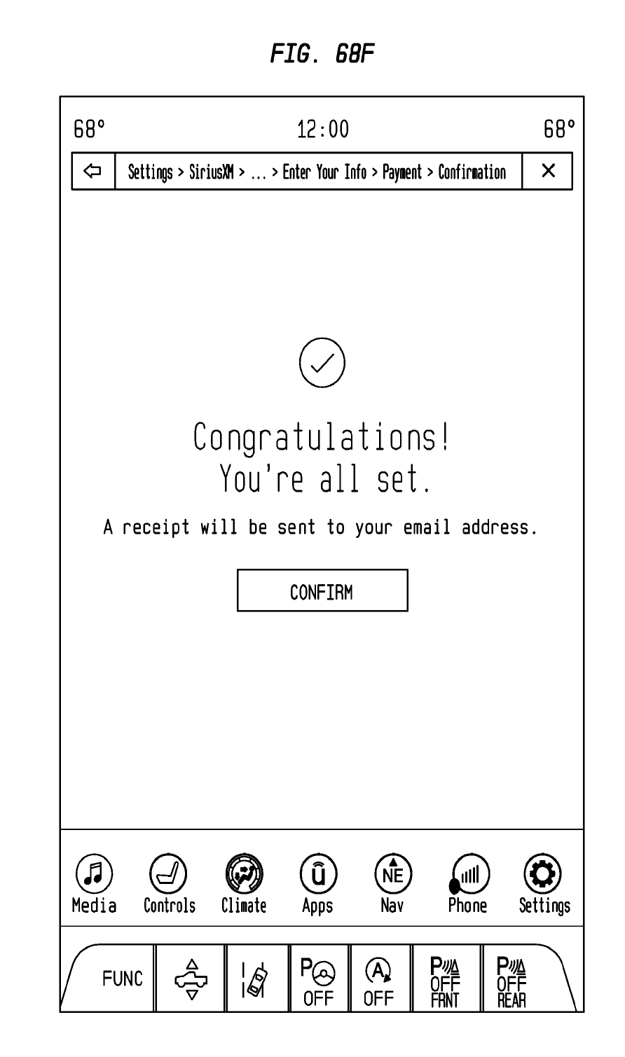

FIG. 5 is the final screen of the introduction. Hopefully the user is sufficiently intrigued enough to click the “START MY TRIAL” button and get a 60 day free-trial service. Thus, FIGS. 1-5 are an example of in-vehicle subscription management. More on that topic is described below, in connection with FIGS. 67 and 68, which are displayed to a user at the end of a free trial.

### Basic User Interactions: Channel Selection and Play

FIG. 6 presents a Categories screen according to exemplary embodiments of the present subject matter. The various screens and sub-screens in the user-interface described herein are organized according to multiple levels of abstraction; echoing how audio content is organized. “Categories” is the highest level of abstraction, and it presents the four categories of content available in the SXM service, along with a direct tune option, which shall be described more fully below.

As shown in FIG. 6, the four main categories are Music, News, Sports, and Talk. These may be accessed by clicking on or selecting the tile for each category. The user is then presented with more options by way of sub-category (e.g., for Music: Rock, Pop, Hip-Hop, etc.), and a listing of channels in each sub-category.

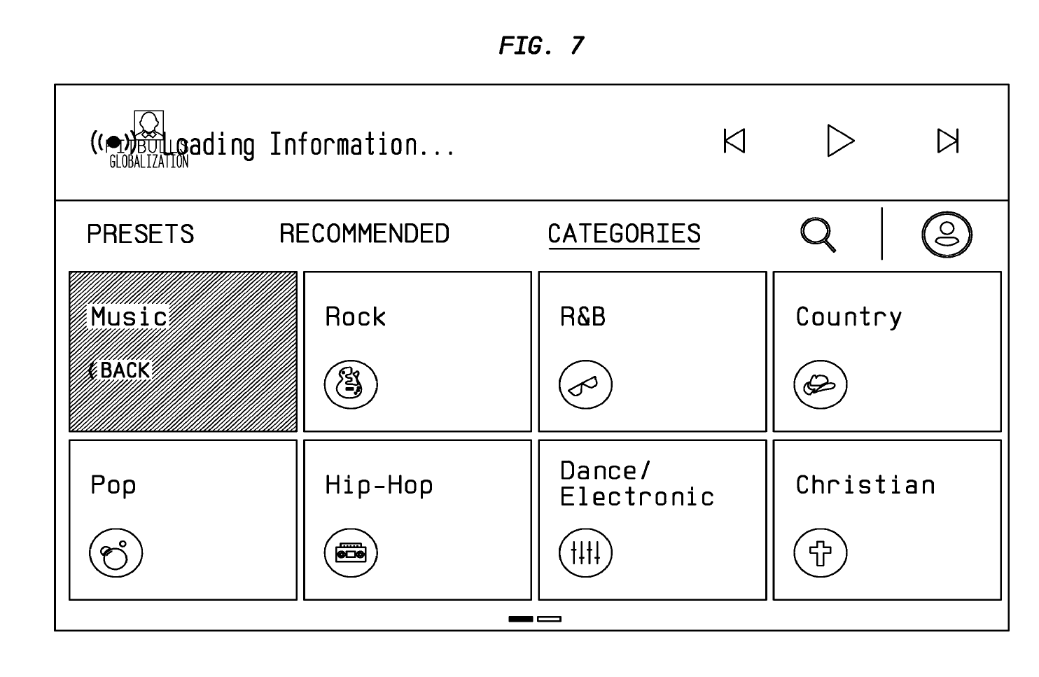

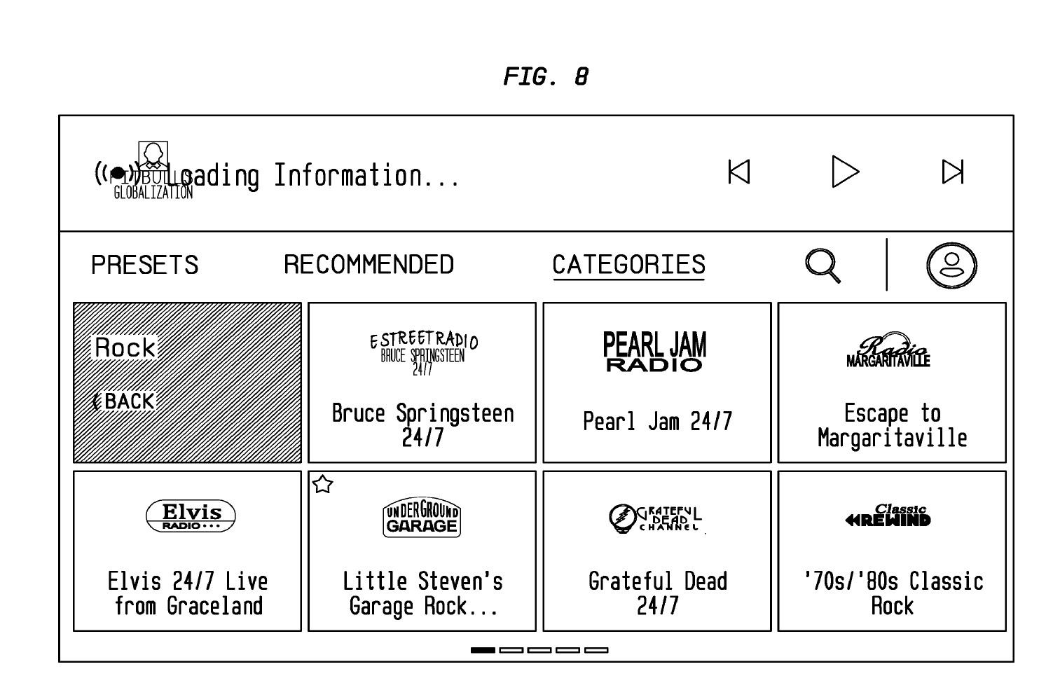

FIG. 7 shows sub-categories for the music category. FIG. 7 would commonly be seen by users selecting the top left icon in FIG. 6 labeled “Music”. In FIG. 7, if a user wants to return to the category screen, all they need to do is select the “Back” button in the top left “Music” tile. As may be seen with reference to FIG. 7, there are 8 tiles shown in this screen, and as seen in the bottom of FIG. 7, there are two horizontal bars, the first of which is highlighted. That means that this screen is the first of two screens of Music sub-categories, and that a total of fifteen icons can be presented in the two screens, 8 tiles per screen. The first screen in FIG. 7 has the Music/Back icon which is the high level category.

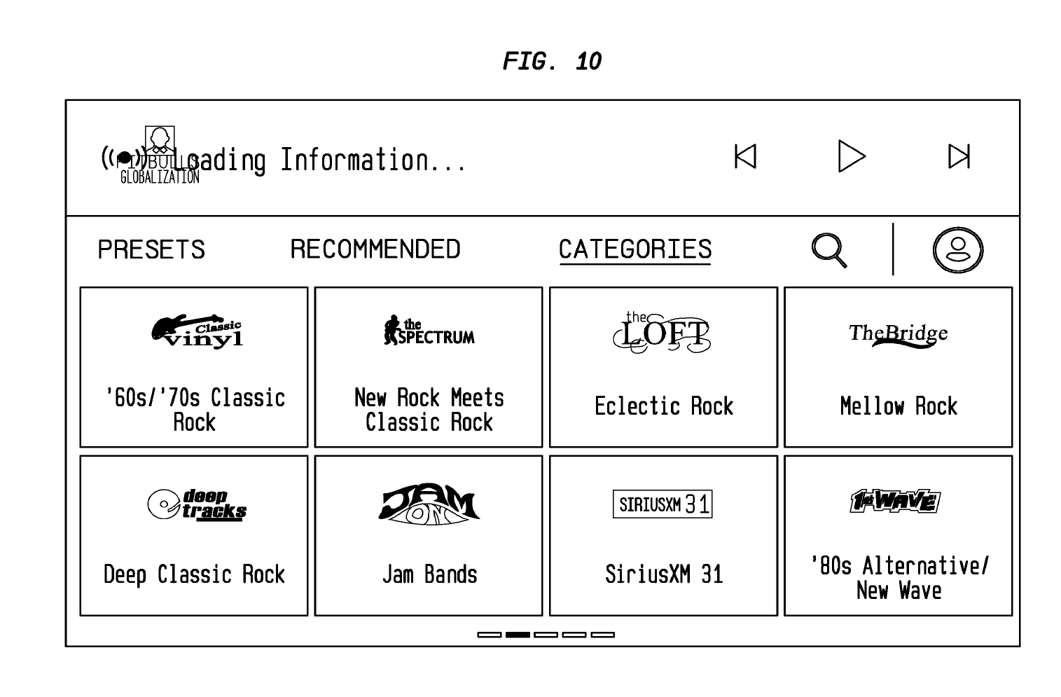

If a user in FIG. 7 selects the Rock tile, then what he or she will see is shown in FIG. 8. FIG. 8 is one of five sub-screens under the Rock category, Rock itself being a sub-category of the Music category. Thus, FIG. 8 shows the bottom level of abstraction where actual channels are presented. The remaining Rock screens can be accessed by swiping from right to left. FIG. 10 shows the second of five Rock screens.

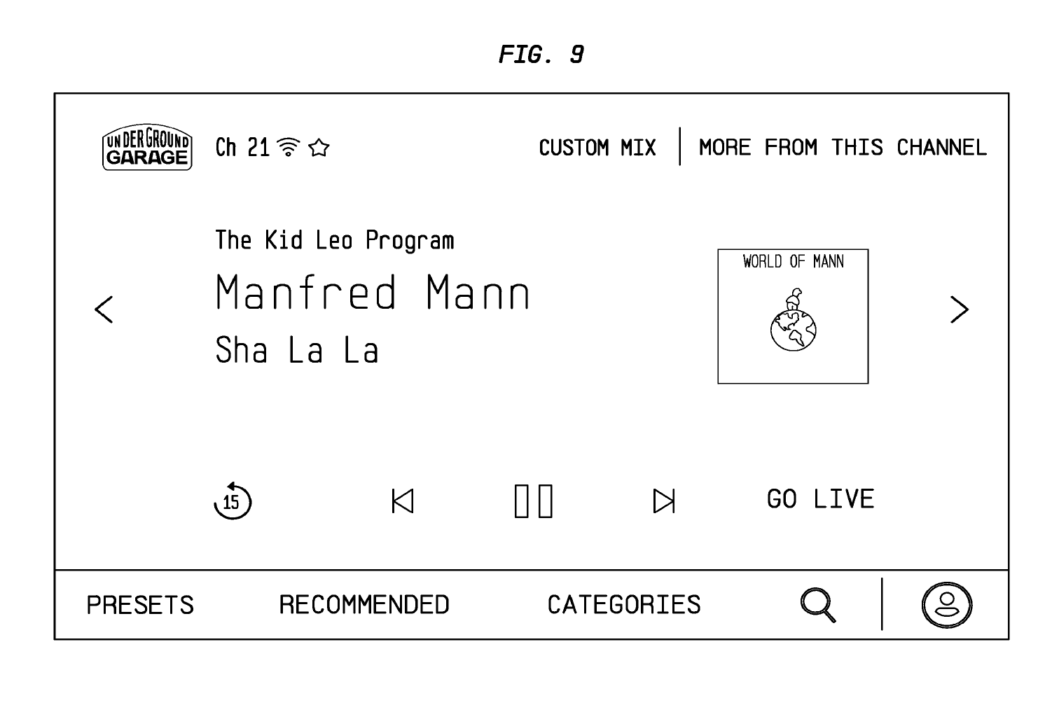

As shown in the bottom left center of FIG. 8, one of the channels presented is “Underground Garage.” It has a star icon at the top left of the tile, indicating that this channel is a preset for this user profile. If a user selects that tile from FIG. 8, by, for example, touching the tile, what they will see is the player screen shown in FIG. 9. This is the generic screen that is shown whenever a user first tunes to a channel and has not selected some other screen or feature while that channel is playing. It is noted that all the selections in FIG. 8 are presented by channel name and distinctive icon, not channel number.

The player screen has various icons and active buttons. In the top left is the channel icon. In exemplary embodiments of the present subject matter, a guiding principle is that users of in-vehicle media content delivery systems recognize and interact with channels that they know or like more by icon and channel name, than by channel number alone. Although the selected channel is Channel 21, the number is presented in a smaller font than the Channel name/icon. Channel 21 is an active button, however, and if the user presses on it, they will go to the channel selection “Swipe” screen described more fully below. It is also noted that in FIG. 8 the Underground Garage icon contains a star in its upper left corner, indicating that it is a preset (for this user's user profile).

Also seen in FIG. 9 is the album art associated with the song currently playing. In this particular example there are a number of things being depicted to a user. First, the current program is called “The Kid Leo Program”, Kid Leo may be a DJ or a celebrity who choses music for listeners and may provide commentary. The song being played is Sha La La, the artist is the group Manfred Mann, and it comes from the album World of Mann shown only by its album art on the right side of the screen. In the event there is no album art, a generic icon may be shown, for example, or there may be no icon shown, in alternate exemplary embodiments.

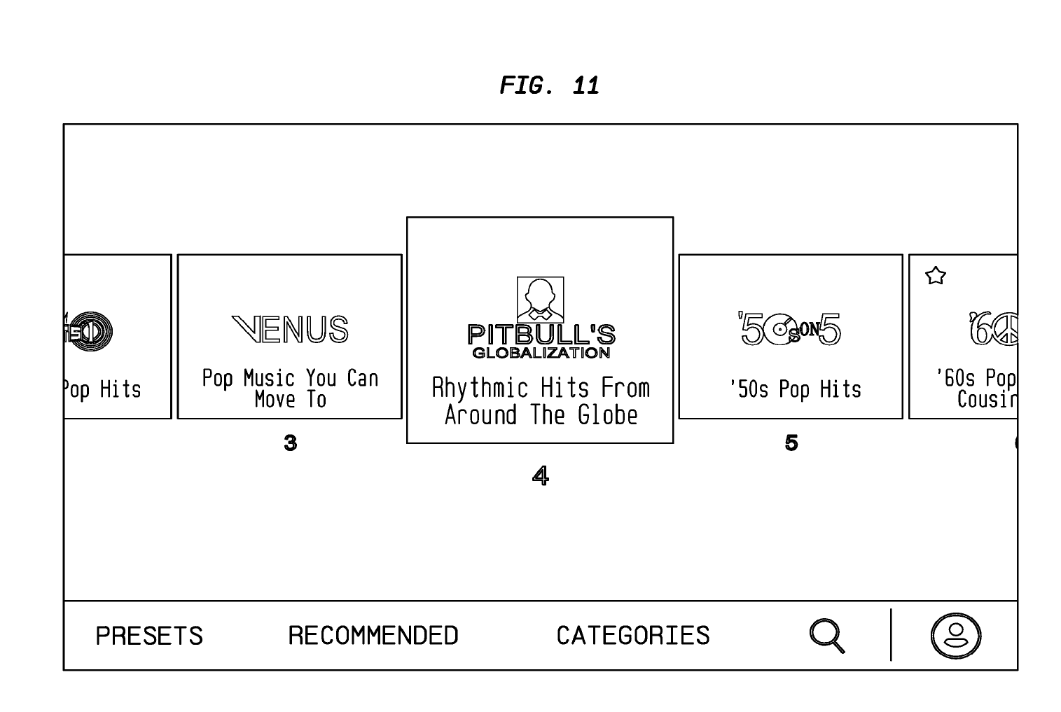

FIG. 10 illustrates the second screen in the Rock Category which follows that of FIG. 8. It has 8 tiles, each representing a different channel. If a user wants to go back to the horizontal tile tuner screen (of FIG. 11, for example) instead of selecting from the various Rock categories by swiping through these category screens, the user should tap the channel icon at the top left of the screen, or simply just touch above the tiles (near the top of the screen), to bring back the player screen, such as shown in FIG. 9. From there the user may swipe across the screen, or select one of the carets at the right or left of the player screen to change channels. It is noted that the horizontal tile tuner screen of FIG. 11 is icon based, not a list of channels in text. It presents a 1D array of tiles in a horizontal line, with the middle tile enlarged to indicate it is the currently active tile. Thus, a user may linearly scroll through the channel lineup in either direction. The elements scrolled are channel icons, with the channel description provided underneath. As noted, one such icon is featured in a larger tile in the center, and the channel it represents is known as the “highlighted channel.”

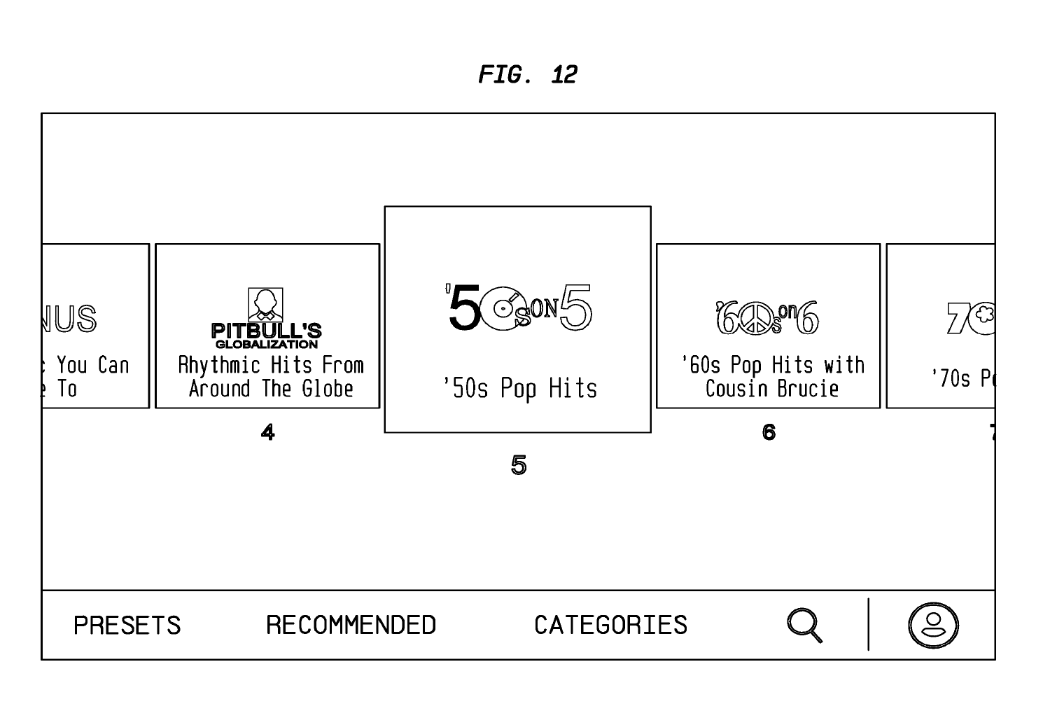

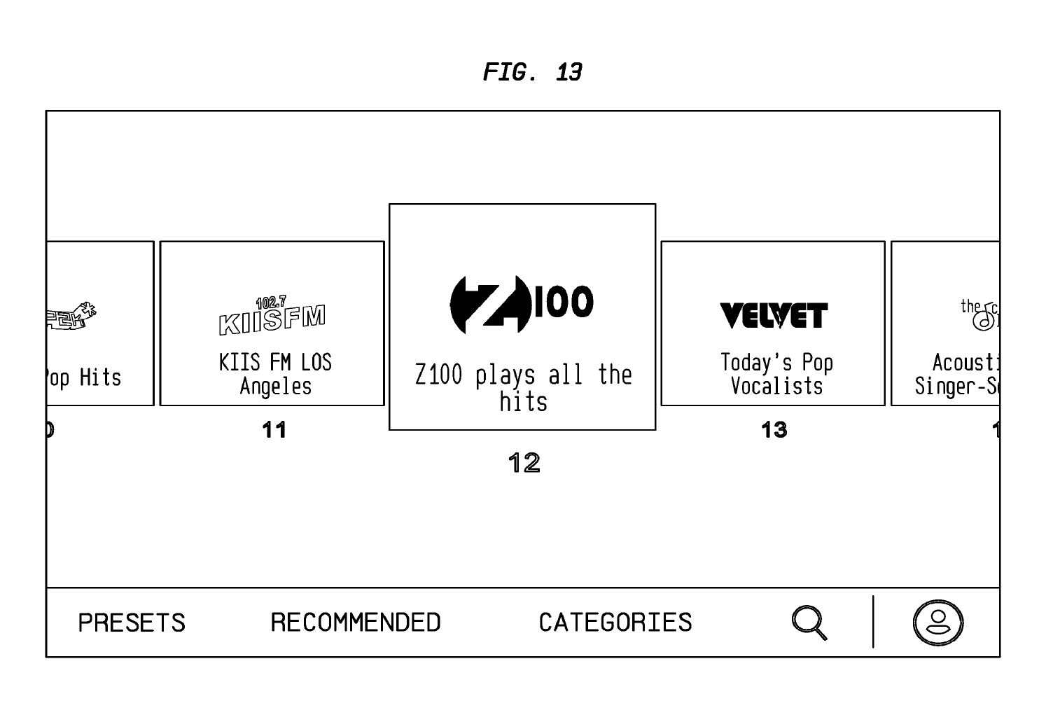

In FIG. 11 a user may swipe to the right or to the left to go down or up in channel sequence to select a new channel. If the user does nothing from this screen of FIG. 11, after a certain defined time period, the highlighted channel, as noted, the one presented in the larger tile in the center, will automatically be selected and the user will see a player screen for that channel. In this exemplary case, from FIG. 11 the user has swiped his or her fingers on the right side of FIG. 11 (swiping to the left of the screen) and moved the highlighted channel one over to Channel 5-50's Pop Hits, as shown in FIG. 12. FIG. 13 shows what happens if the user continues to swipe on the screen and move from channel 5 all the way up to channel 12 according the exemplary embodiments of the present subject matter.

The horizontal tile tuning function illustrated in FIGS. 11-13 can be used with other interactive modalities besides swiping. For example, turning a rotary dial clockwise may be set equivalent to swiping from left to right (or vice versa). Likewise, turning a rotary dial counterclockwise may be set as equivalent to swiping from right to left (or vice versa). The rotary dial, or so-called “tune dial,” is a standard feature in most of today's vehicle radios and user testing performed by the inventors has shown that using the tune dial allows a driver to quickly navigate through numerous channels with graphics that are easy-to-see while driving. In one exemplary embodiment, twisting the tune dial quickly will skip sequential segments of channels, making it easy to go from channel 10 to channel 100, for example. In addition to tune dials, 5-way controllers (similar to gaming joy sticks), commonly found on steering wheels, may be used for operating the linear tuning function in other exemplary embodiments. Thus, selecting the highlighted channel shown in FIGS. 11-13 can also be achieved by pressing down on a tune dial, or by pressing the center button in a 5-way controller, or pressing on an active tactile pad (equivalent to a mouse pad on a laptop computer) remote from the display screen. In the latter exemplary case, a user may touch areas of the active tactile pad, provided, for example, between the two front seats in a horizontal or near horizontal plane, that correspond to areas of the display screen. By this means it is not necessary to reach up and touch a touch screen display.

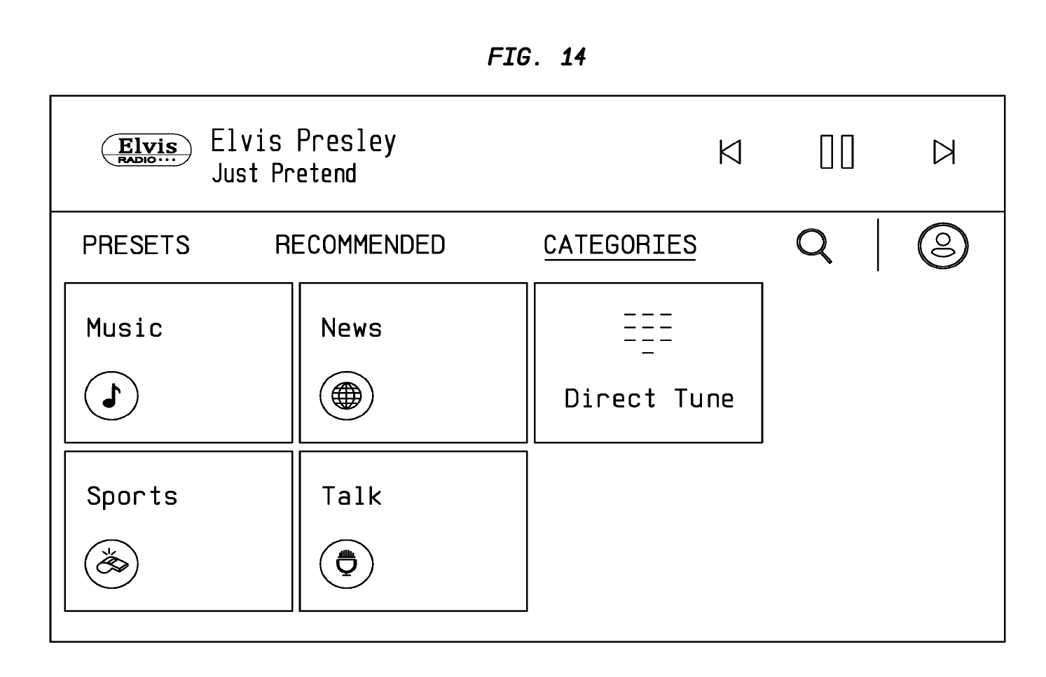

FIG. 14 shows a user looking once again at the top level categories, as in FIG. 6, while Elvis Radio is playing. For ease of illustration, the interim screens by which a user may navigate from FIG. 13 to FIG. 14 are not shown, but are not difficult to understand. Elvis Radio is Channel 19; this is a short hop from Channel 12, shown highlighted in FIG. 13. For this use case, the user selected Channel 19 and then tapped the categories button in the bottom bar, as shown in FIG. 13. They would then see the exemplary screen shown in FIG. 14. This illustrates a basic feature of various embodiments of the present subject matter, where activating or selecting one icon in a player screen brings up a new set of user-interface elements, but preserves and displays a truncated player screen at the top portion of the screen, and also displays common active buttons (e.g., “Presets”, “Recommended” and “Categories”) as well.

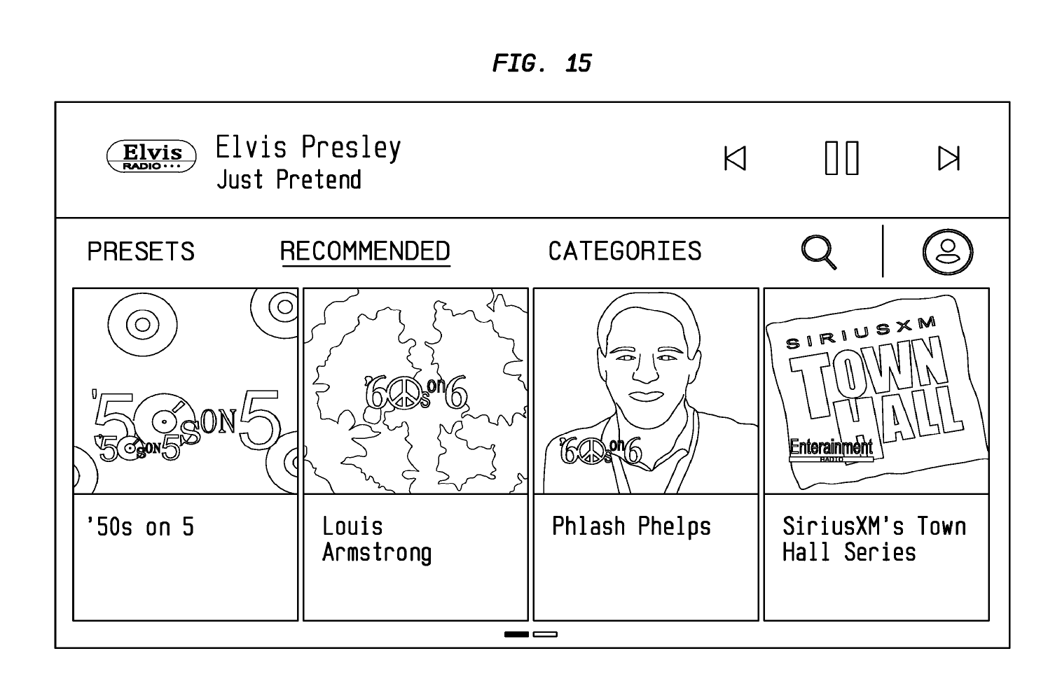

FIG. 15 shows what happens if, at FIG. 14 (or in FIG. 13), the user had activated the recommended button. FIG. 15 displays recommendations. In various exemplary embodiments, recommendations may be based on an individual's listening history, user profile, presets, demography, and various other user metadata, using one or more recommendation algorithms.

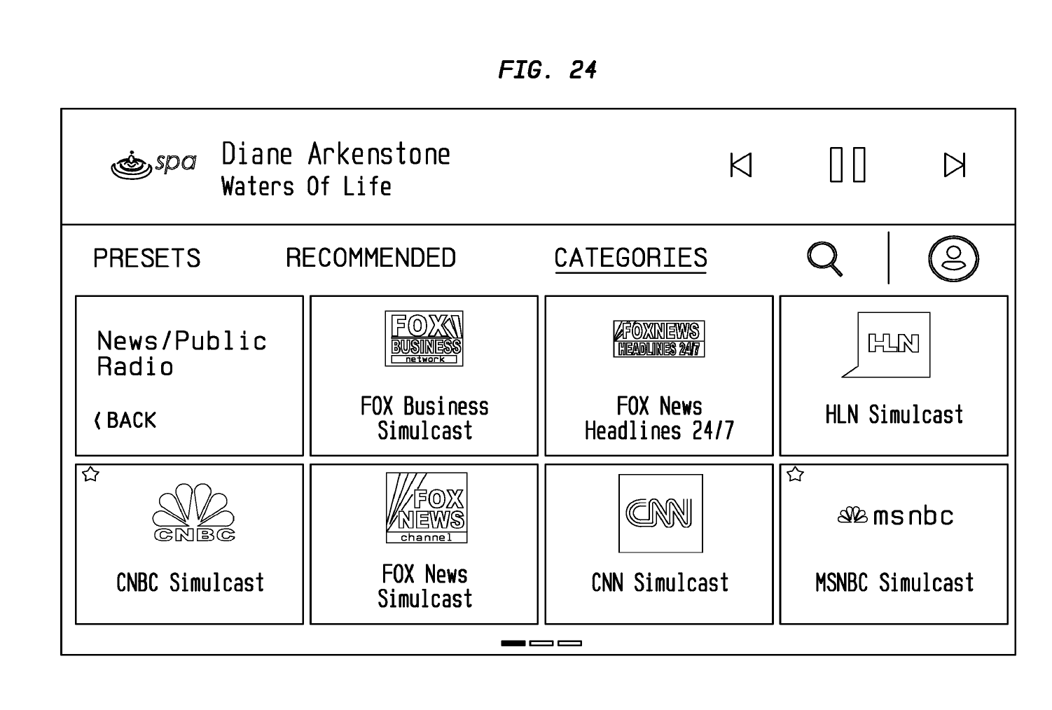

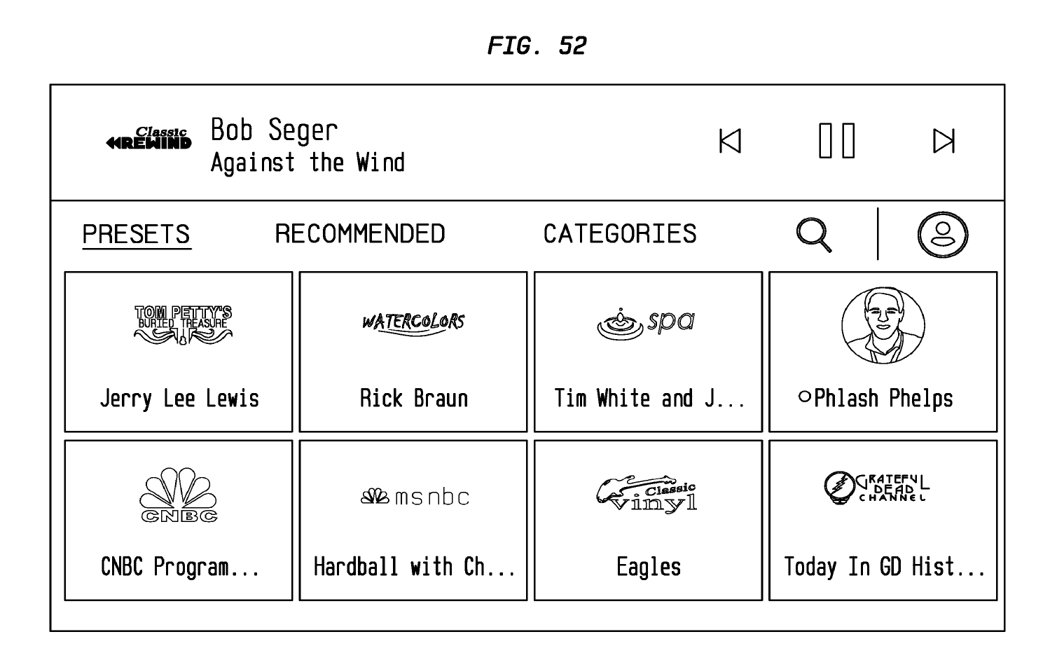

FIG. 15 is the first of two Recommended screens. As noted, there is a distinction between the recommendations screen which has 4 rather large rectangular tiles on the one hand, and the category screens shown in FIG. 10 or 24, or the presets screens shown in FIG. 52, on the other hand, which in the disclosed embodiment have 8 tiles each. By design, in FIG. 15 the tiles are large and the number of tiles is limited to four so as not to overwhelm a user, and keep the interaction simple enough for driving conditions. Also, because these (i.e., recommendations) are not user set options, but system generated proposals, it is assumed that the users do not know what to expect, as opposed to a more familiar browsing experience. Thus, the tiles are designed to inform, with easy to read and mentally digestible content size.

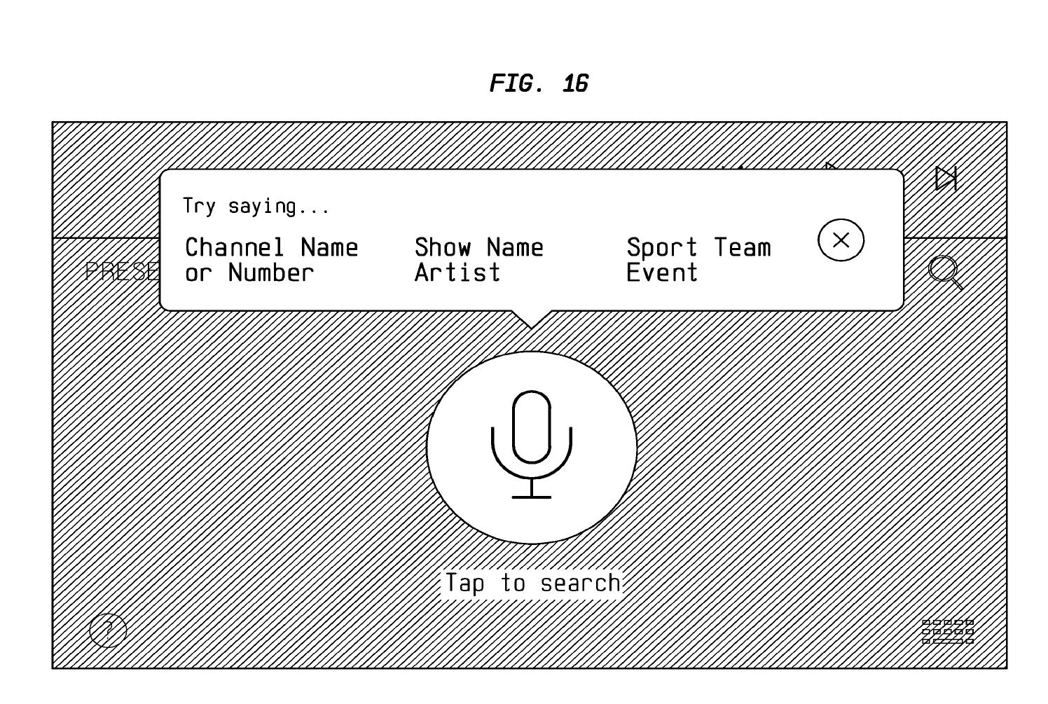

FIG. 16, a search screen, shows what happens if a user taps on the magnifying glass icon at the top right of most screens, such as shown, for example, in FIGS. 14 and 15. As shown here, for a first time usage, this is a voice activated search and there is an informational bubble that informs the user to say either a channel name or number, a show name or artist, or a sports team or event, and then tap the microphone icon after speaking, thereby initiating a search.

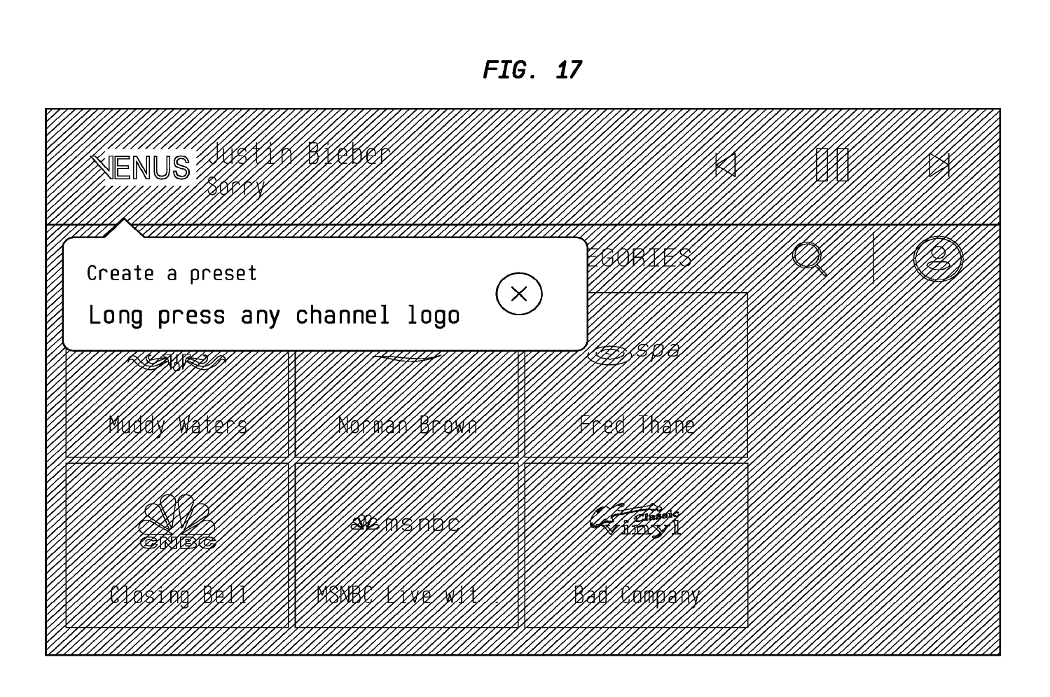

FIG. 17 depicts a presets screen for a first time usage. I.e., a user sees this screen if they selected “Presets” but have none set. Preset buttons are provided at the top of a “Categories” or “Recommended” screen, and at the bottom left of a Player screen. Anytime a user presses on “Presets”, they get a screen depicting their current presets. Here in FIG. 17, because the user has none, the system prompts the user to create a preset and explains how to do that. So, for example, the user now listening to the Venus channel can set it as a preset by a long press on the channel logo.

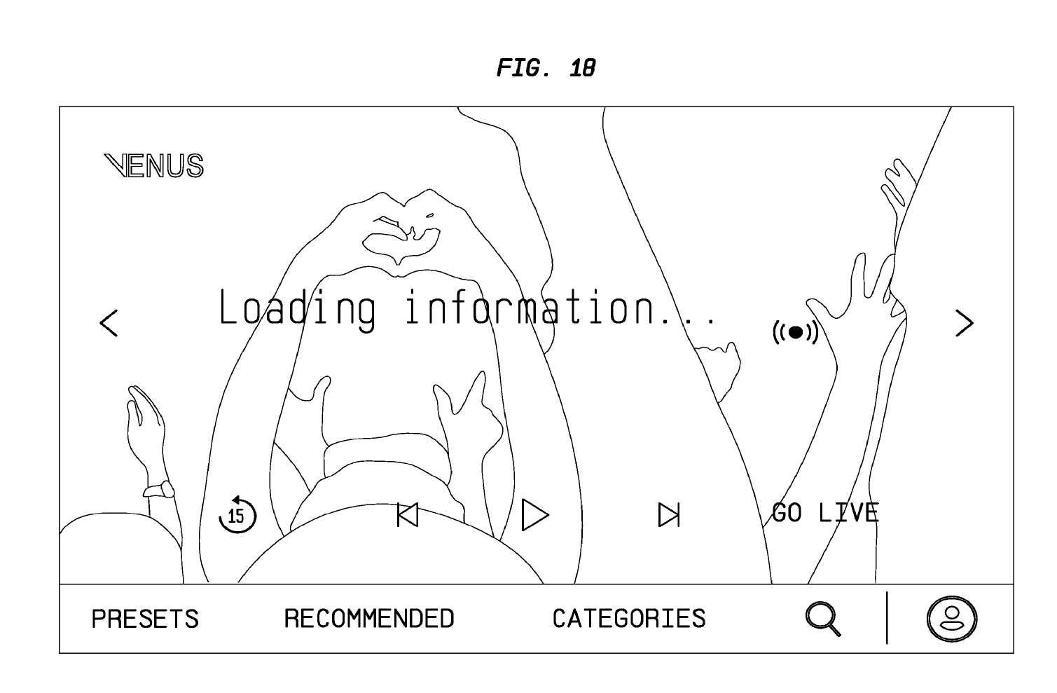

FIG. 18 illustrates once having preset “Venus”, loading the player screen's data. Thus, if a user is playing any channel and then goes to presets, they can change stations by tapping any of the shown presets. Presets are presented as tiles, as opposed to a list of textual phrases. FIG. 52, for example, is an exemplary presets screen. Thus one can easily imagine how easy it would be when driving, to hit presets, spot CNN and just tap that icon to go to CNN. Rotary dials and 5-way controllers are also easy to use for preset selection.

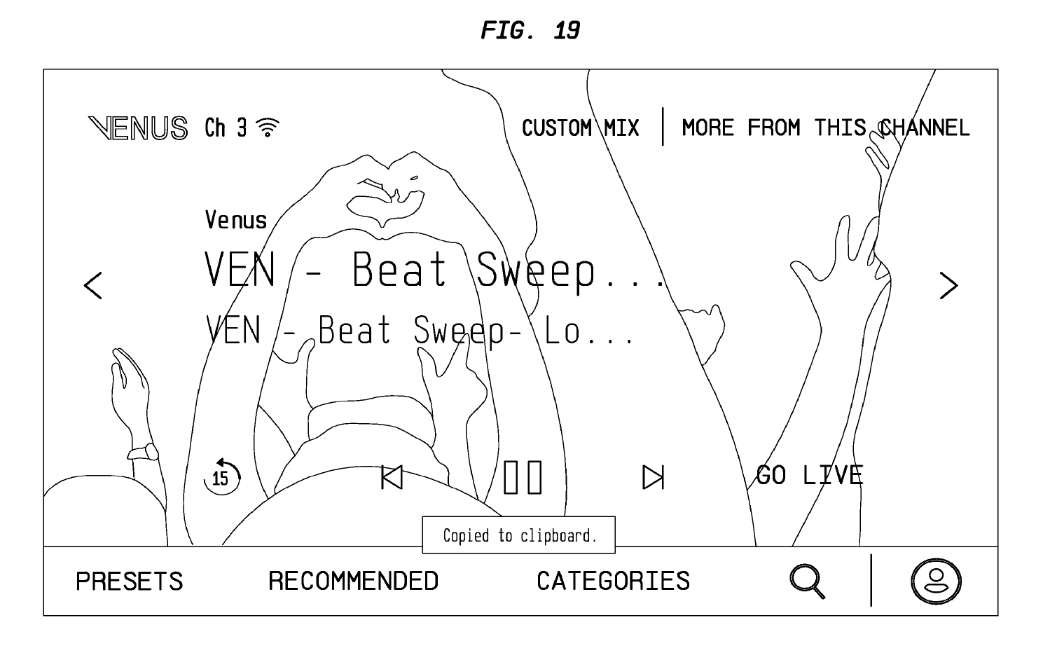

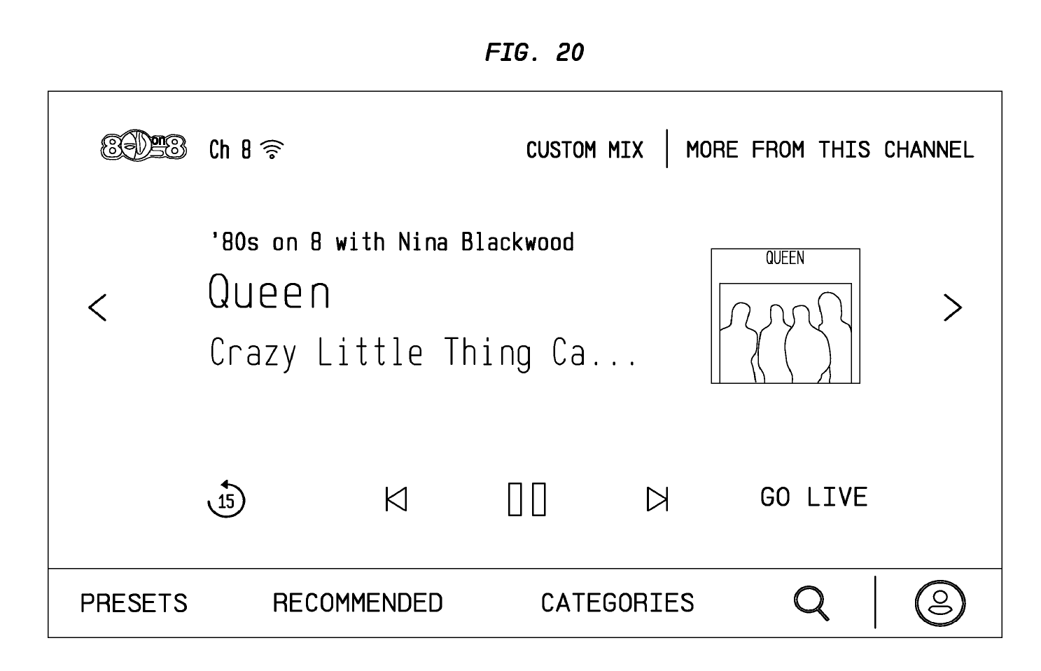

It is also noted that there is a “Go Live” button in all the player screens, such as in FIGS. 19-20. The “go live” button indicates whether or not a user is playing buffered audio content (i.e., buffered—in most embodiments—in the cloud, and sent to a radio via an IP communications channel) available. When the “go live” button is lit, the user has the option of listening to content that is being played live. If “go live” is ghosted then the user is already on the live channel. Thus, in FIG. 19 the user is already live because the “go live” button is ghosted. This illustrates another feature according to exemplary embodiments of the present subject matter where on-demand, or additional content is available to the user, and can be paused and resumed. There is no album art shown here, because in this example there was no available metadata at that moment.

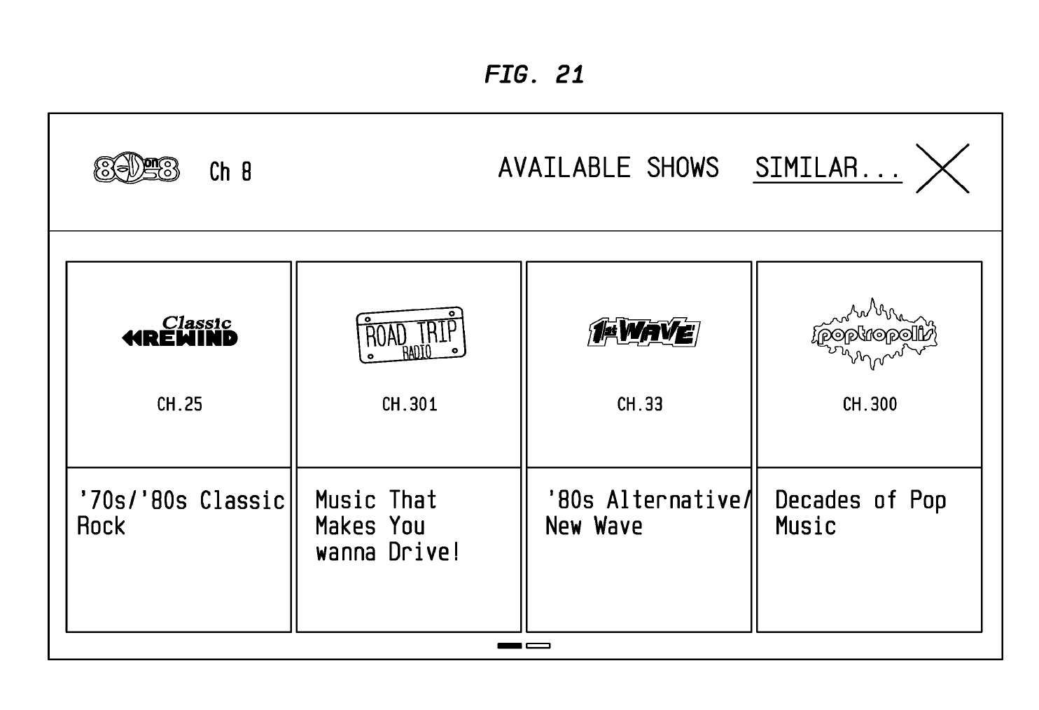

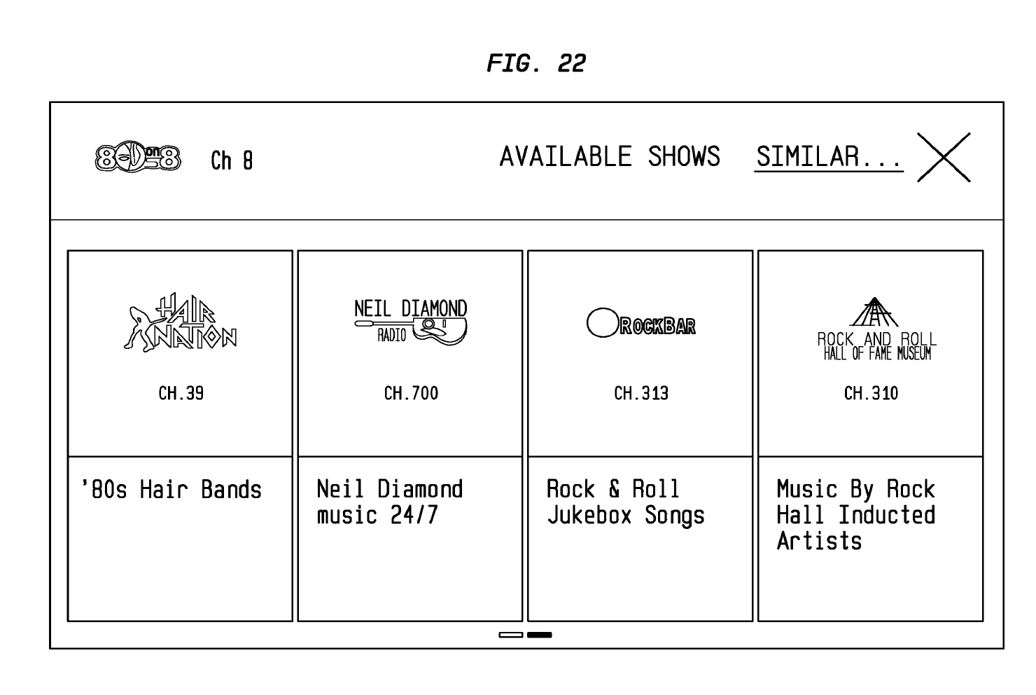

FIG. 20 shows a user listening to Channel 8—80's on 8. This is the standard player screen, as described above. In FIG. 20 one can see the “MORE FROM THIS CHANNEL” button on the top right of the screen. If a user activates this button, whether by touch screen, by voice command, trackball or other interactive device, as noted above, he or she will see the two screens shown in FIGS. 21 and 22, which are Channel 8's similar channels. On the other hand, if the user had clicked the AVAILABLE SHOWS button, they would see on demand or pre-stored content available via the IP communications path. Here, in FIGS. 21-22, we see again the large icons, as, once again, the user may not have seen these channels before. Thus, “Similar” channels, being system generated, are also presented in this exemplary embodiment in the four tile per screen larger rectangle format described above with reference to FIG. 15.

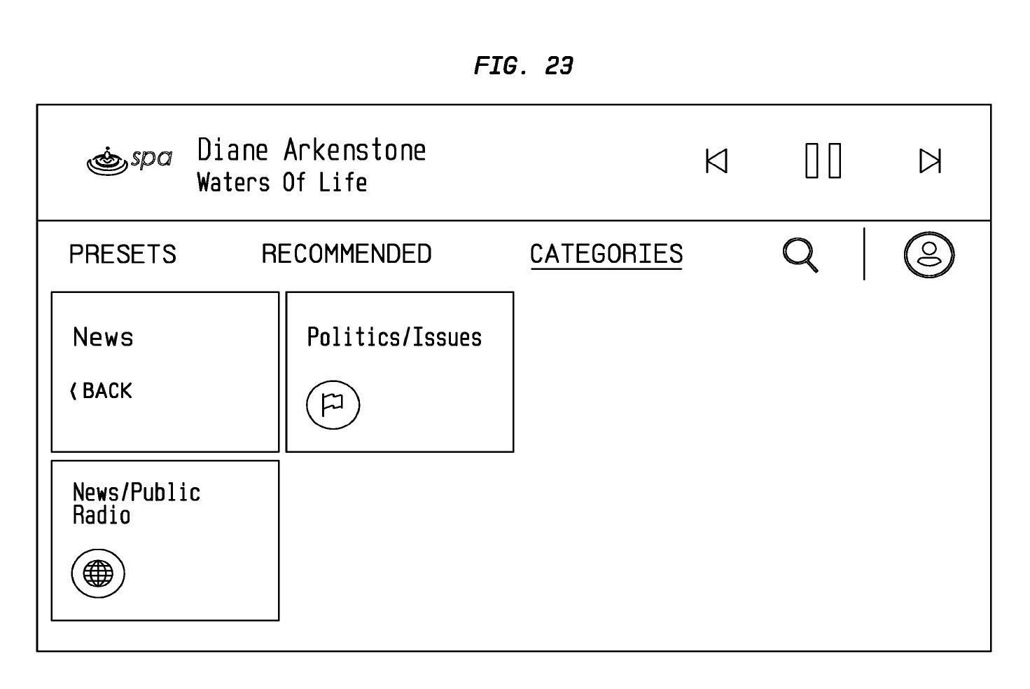

FIG. 23 is a screenshot of the news category according to an exemplary embodiment of the present subject matter, showing two subcategories. FIG. 24 is a screenshot that would be seen upon the user selecting the News/Public Radio tile in the bottom left of FIG. 23, and FIG. 24 thus shows all the channels in that subcategory. The category is News and the subcategory is News/Public Radio.

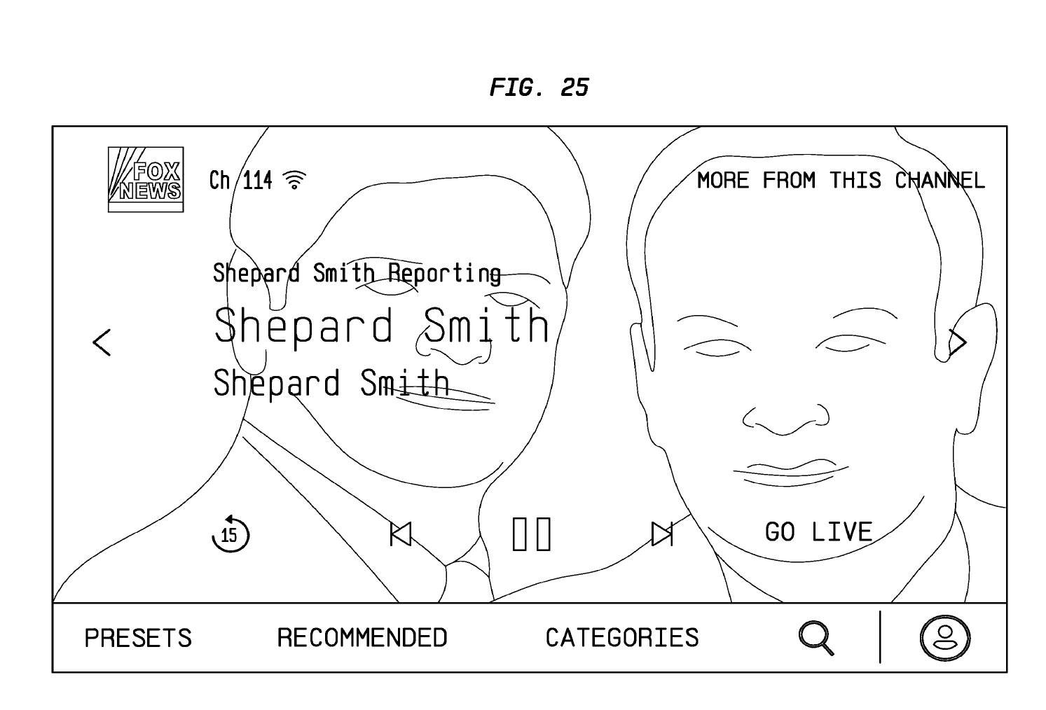

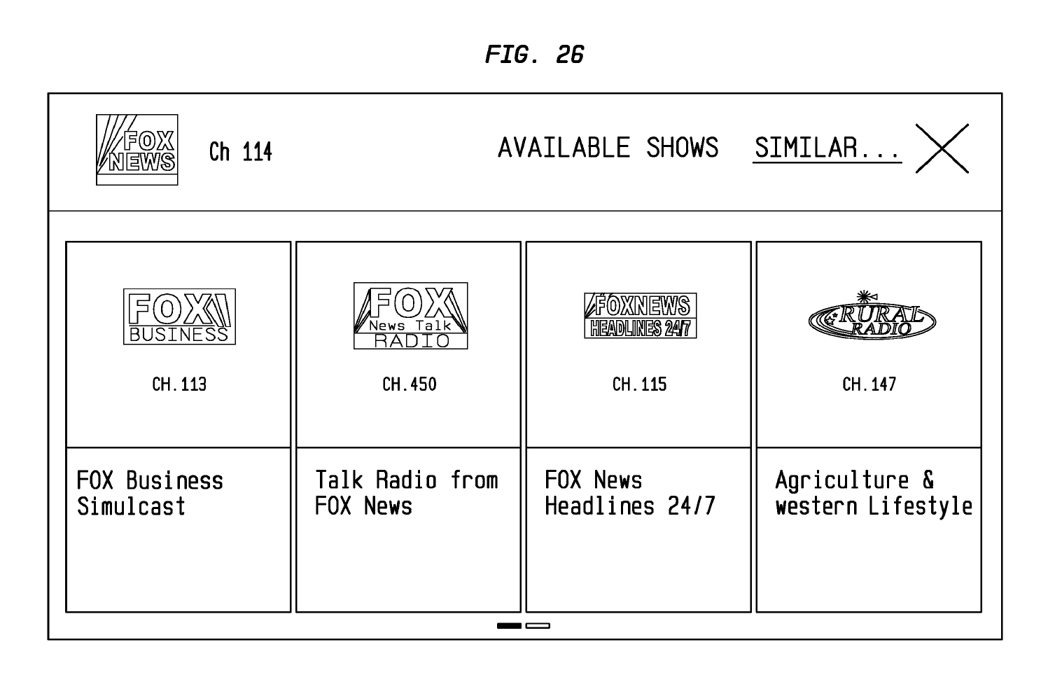

FIG. 25 shows what happens when the Fox News Simulcast tile at the bottom left center of FIG. 24 is selected by a user. As can be seen, instead of album art, there is a photograph showing known celebrities featured on the channel set as the background. In other exemplary embodiments, the background may be a solid color. FIG. 25 also shows at the top right the active button “MORE FROM THIS CHANNEL”. This active button presents a screen showing either available shows or similar channels, and active buttons for both choices so a user can switch between them. Thus, FIG. 26 shows what a user would see having activated the “MORE FROM THIS CHANNEL” button in the top right of FIG. 25, where the system default is to “SIMILAR.” Therefore, it shows other Fox News channels related to Channel 114.

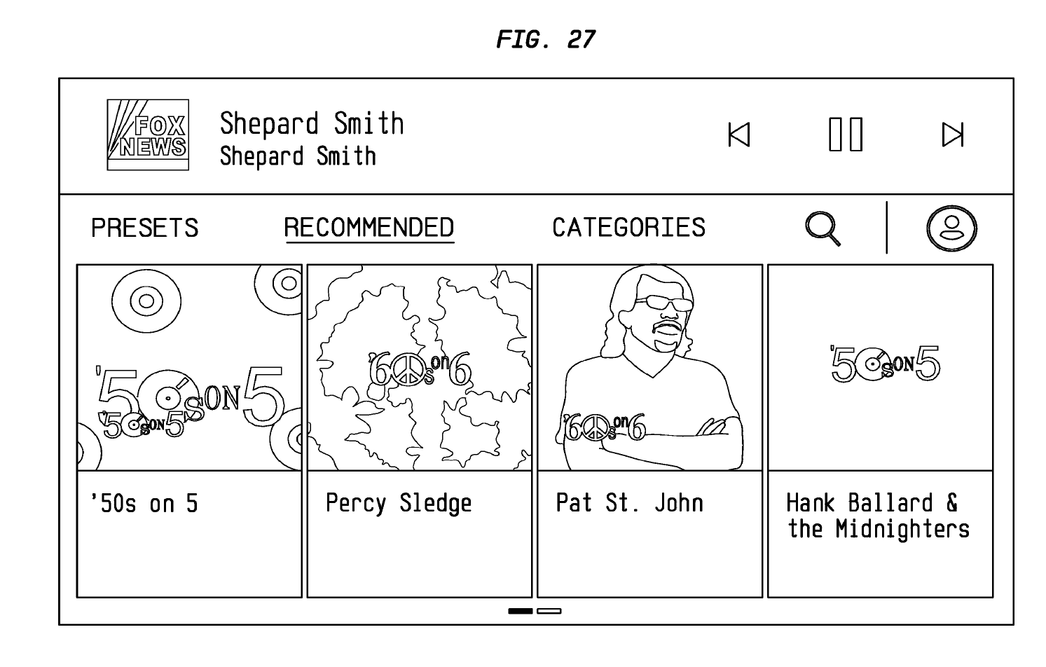

FIG. 27 shows what a user would see if he or she selects the “X” in the top right of FIG. 26, thereby exiting the available shows screen, returning to the screen of FIG. 25, and then clicking on the “RECOMMENDED” button in the bottom center of FIG. 25. Here, again, is the four large rectangle tile per screen format of the Recommended screens.

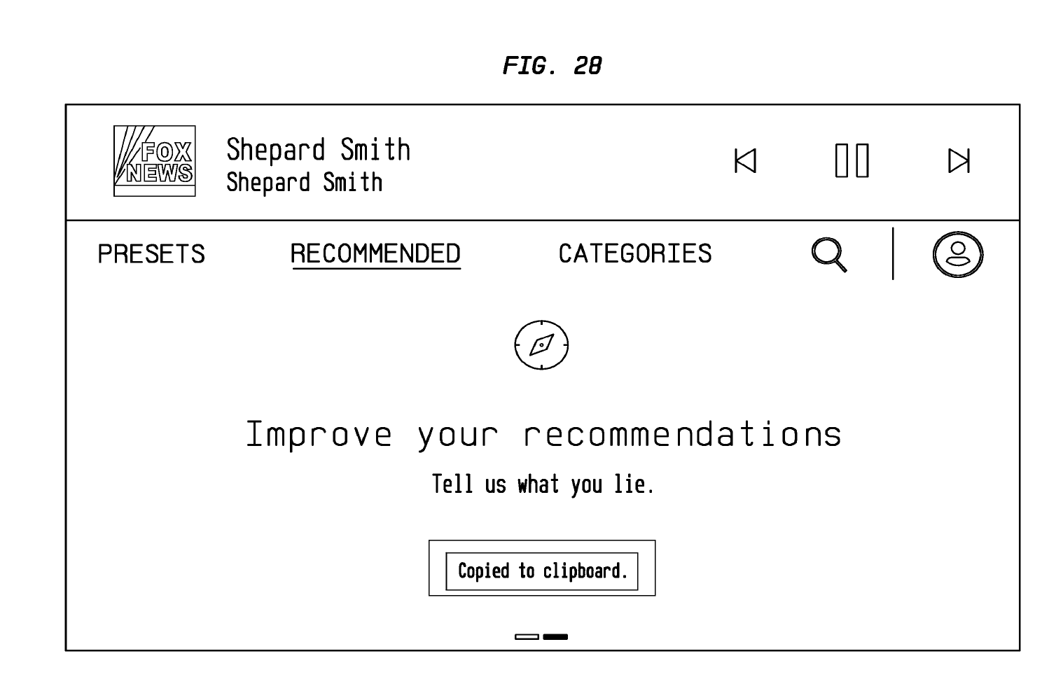

Similarly, FIG. 28 is a second “RECOMMENDED” screen according to an exemplary embodiment of the present subject matter. Inasmuch as there are no additional recommended channels to show, the system presents to the user an “IMPROVE YOUR RECOMMENDATION” screen, as shown, on this second screen. All the while, Channel 114, Fox News, continues playing on audio.

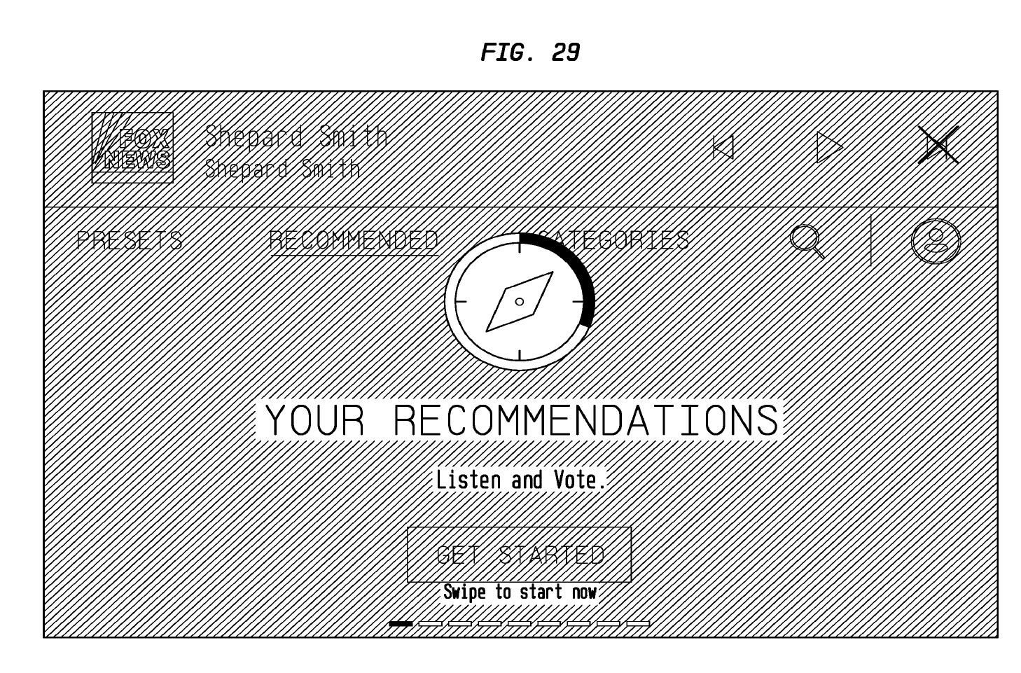

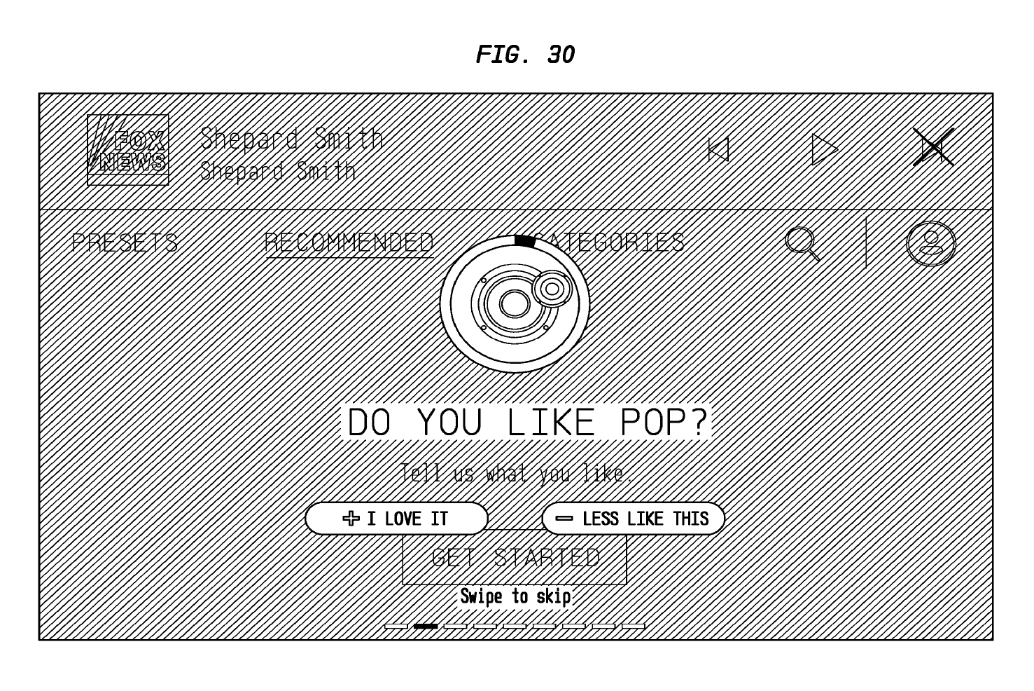

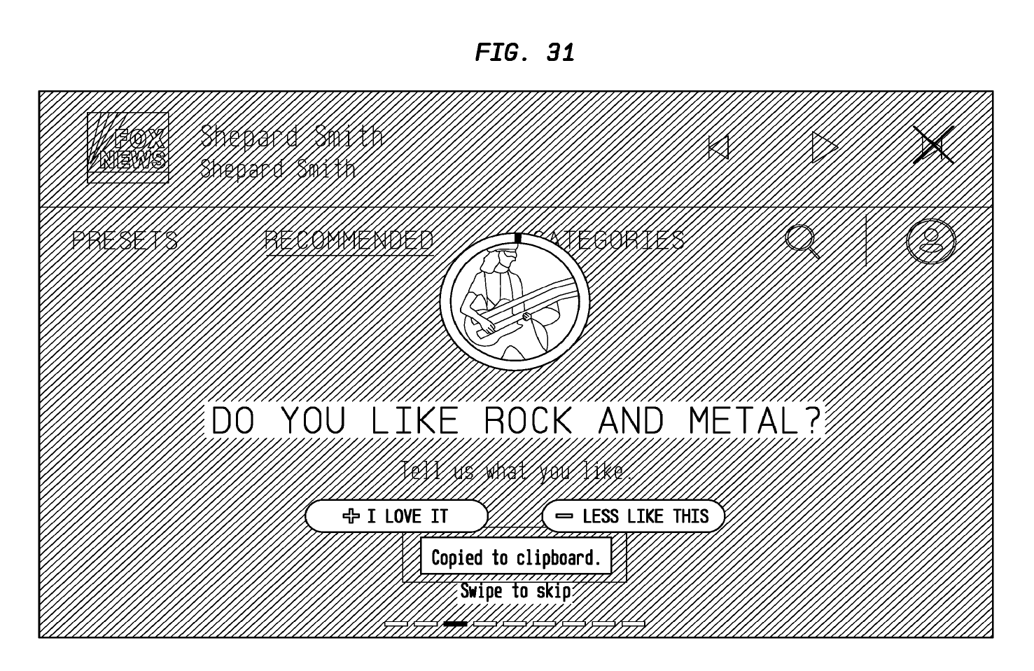

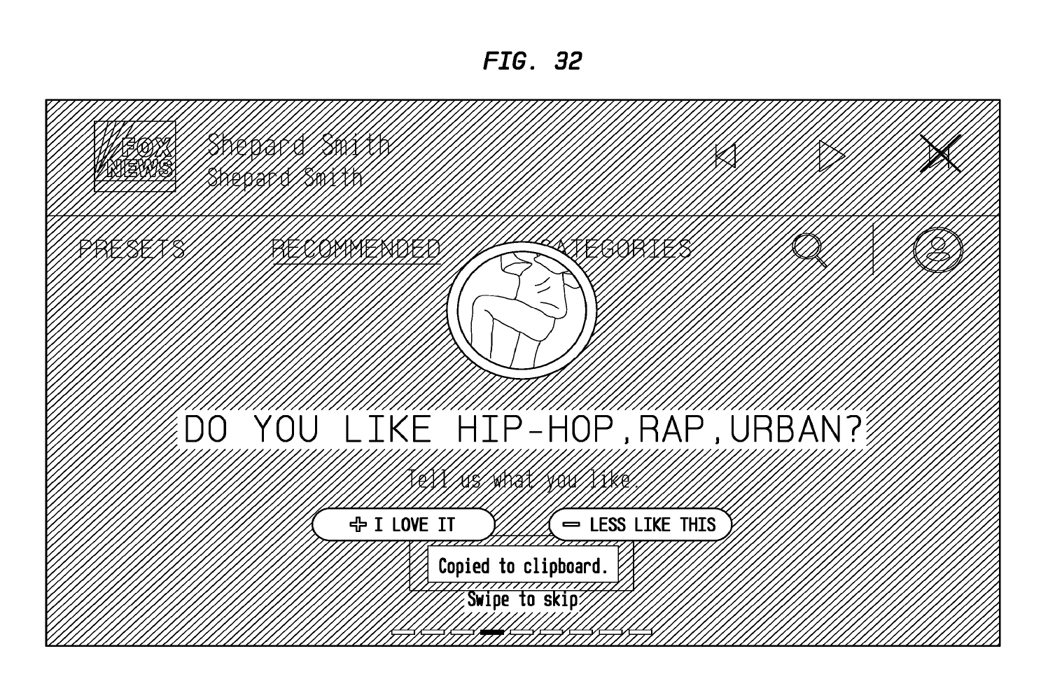

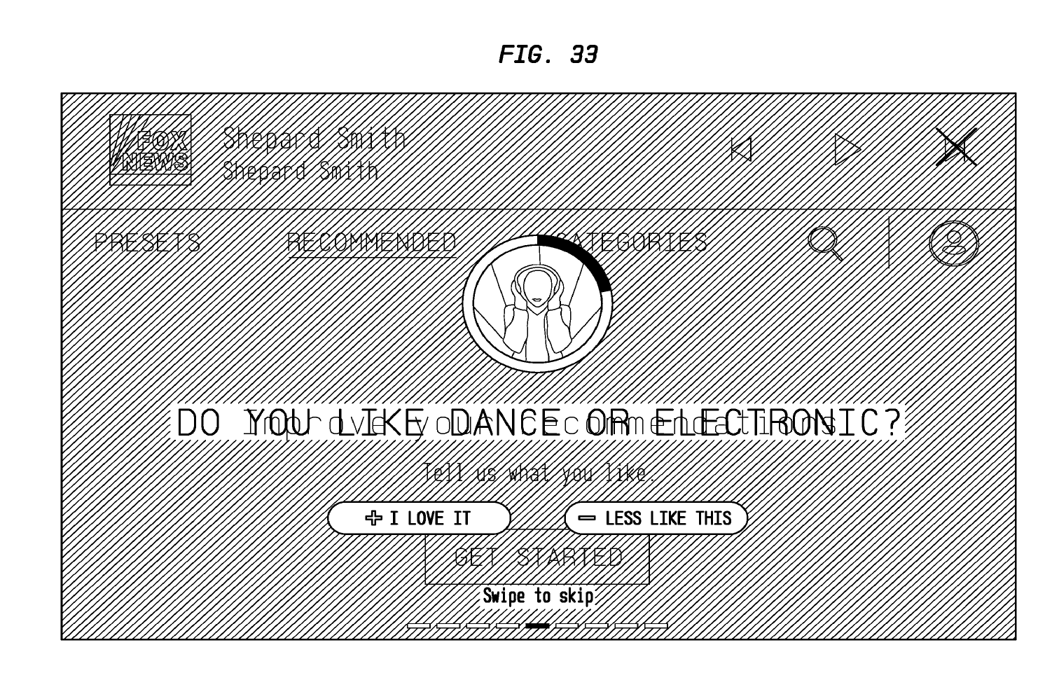

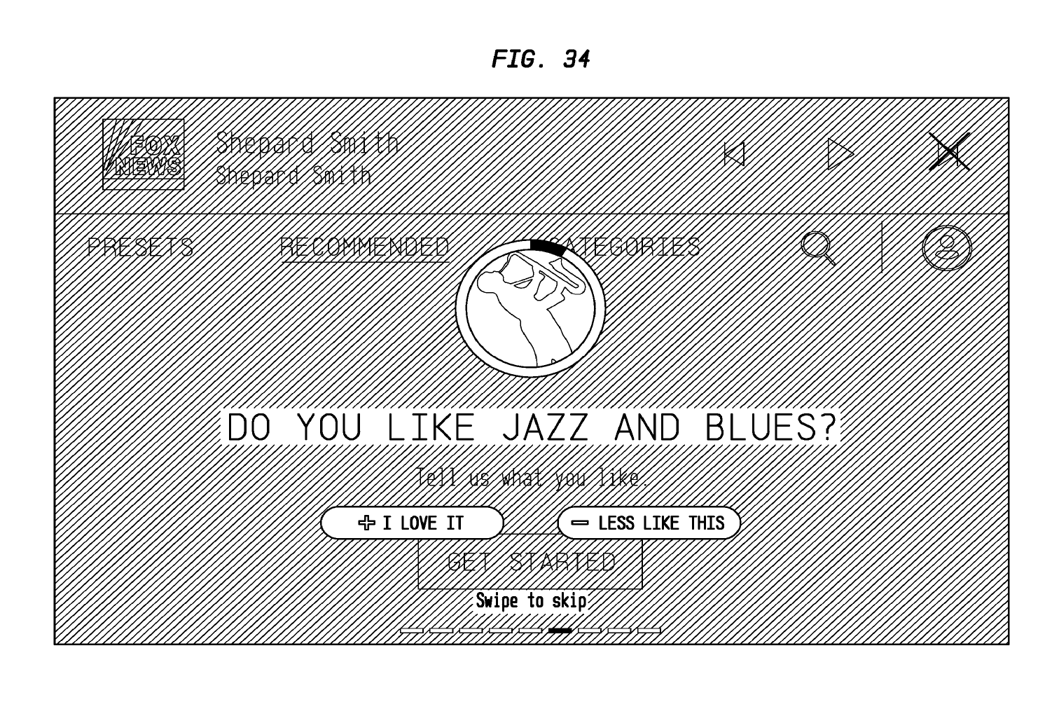

FIG. 29 is the first of a number of recommendations data query screens and these are shown, for example, in FIGS. 30-34, and are self-explanatory. A user may swipe the screen to skip any of them, as indicated.

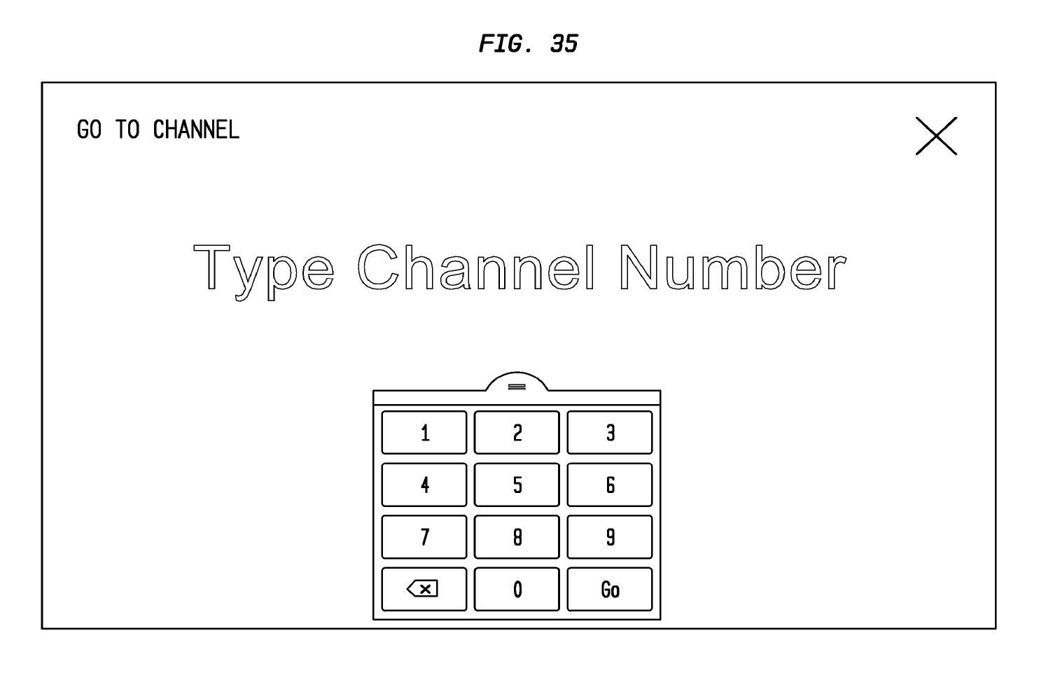

FIG. 35 illustrates an exemplary GO-TO-CHANNEL screen according to an exemplary embodiment of the present subject matter. That screen can be arrived at by either activating the “DIRECT TUNE” tile shown above in FIG. 6, or by clicking on the blue channel number in, for example, FIG. 25 or any other player screen, which is always shown immediately to the right of the channel icon. Activating the channel number at the top left of any player screen will always bring a user to the “GO TO CHANNEL” screen, such as is shown in FIG. 35.

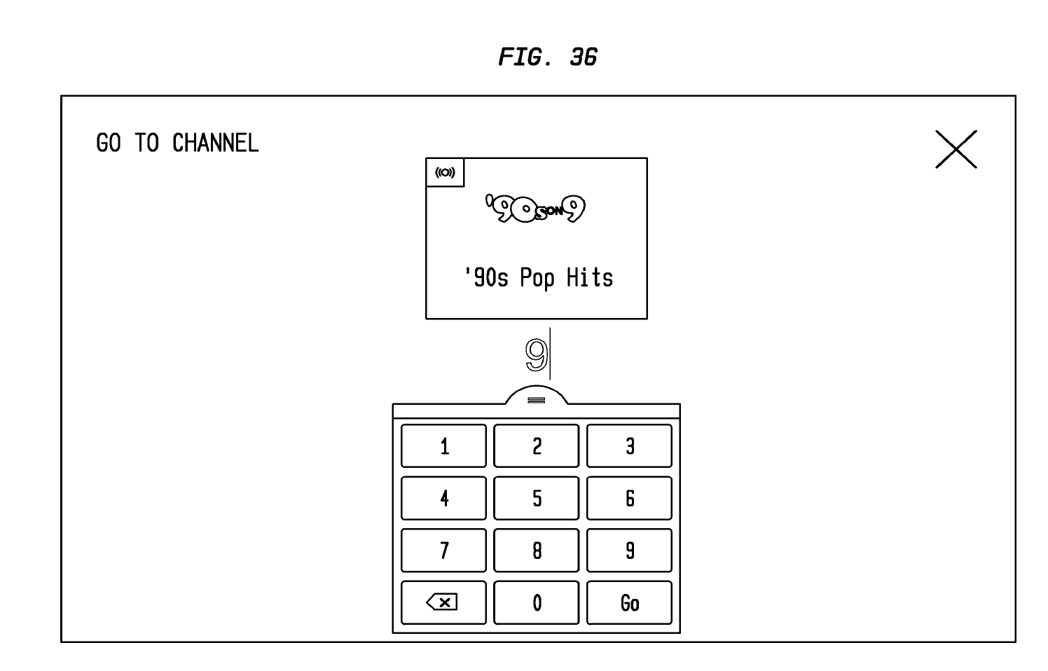

FIG. 36 shows what happens when a user enters the number nine in the “GO TO CHANNEL” screen, via the number array, shown in FIG. 35. Namely, the icon for the entered channel and its channel number appear on top of the number board, but nothing happens unless and until a user touches the channel icon according to an exemplary embodiment of the present subject matter. In alternate exemplary embodiments, after a defined time period, the system may automatically switch to the entered (but not selected) channel. In either embodiment, the user can also tap the “go” button to select a channel. In still alternate embodiments, for example, not only the icon for the entered channel may be displayed, but the entire channel carousel, as in FIG. 6, with the entered channel being the highlighted channel. Thus, a user may scroll through the channels nearby the one entered, in case he or she forgot the actual number they wanted, and instead typed in (or speak) a neighboring number. This is good for users who recall the “vicinity” of the channel they actually were looking for, but may not have the exact number correct.

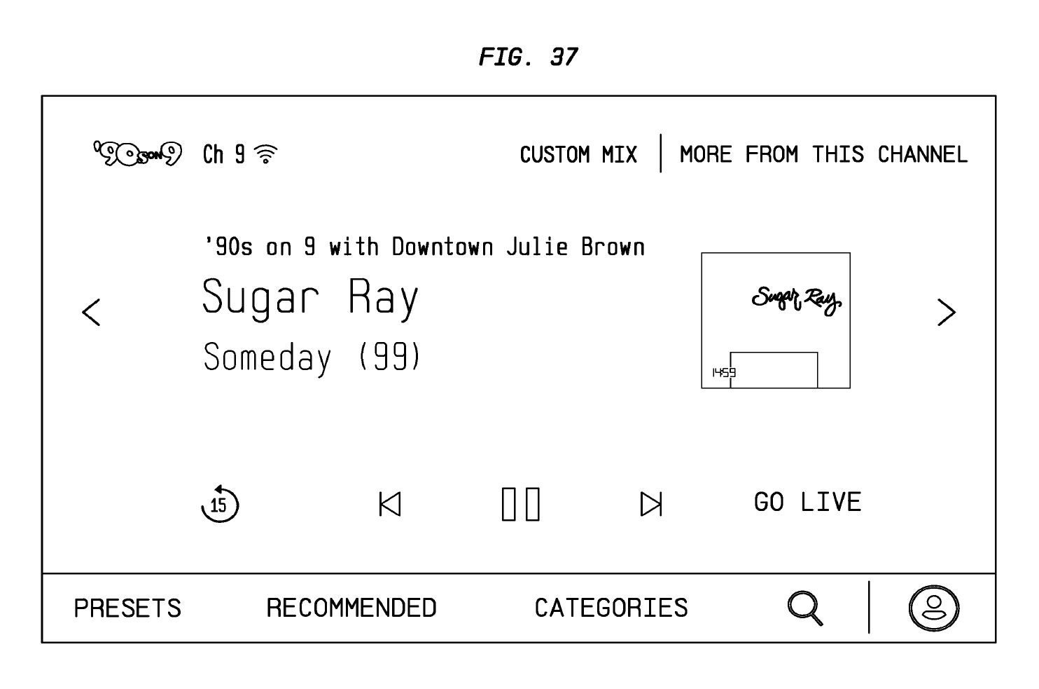

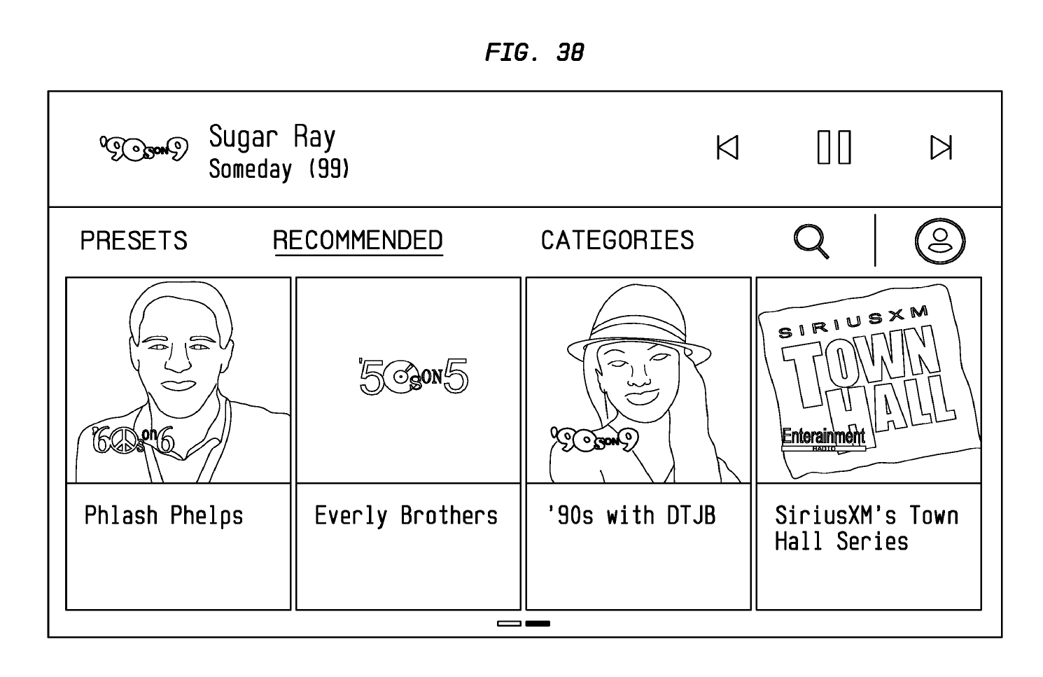

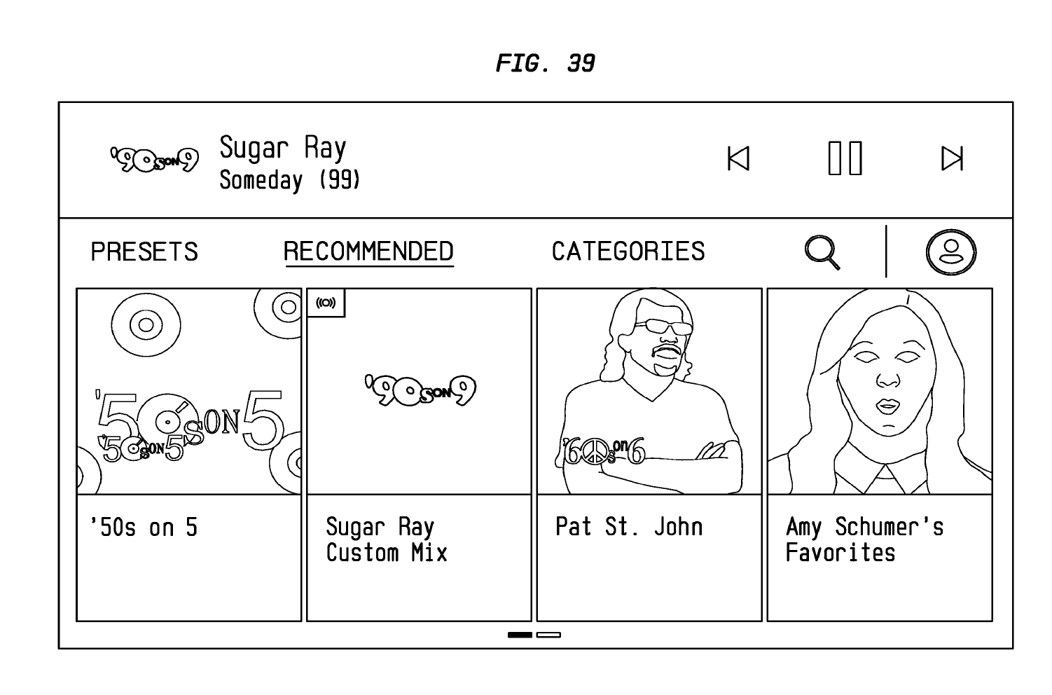

FIG. 37 is the familiar player screen for channel 9, which will present itself upon a user activating either the channel icon, or the “go” button, in FIG. 36. It is noted that Sugar Ray's “Some Day” is playing on channel 9 at the time. Upon pressing the bottom left center “RECOMMENDED” button in FIG. 37, the recommendations for this user appear as shown in FIG. 38. In fact, there are two screens of recommendations. FIG. 38 is the second, as can be seen by the activated second horizontal bar at the bottom center of FIG. 38, and FIG. 39 depicts the first of the two recommended screens for this user. As can be seen in the far right of FIG. 39, one of the recommendations is “Amy Schumer's Favorites.”

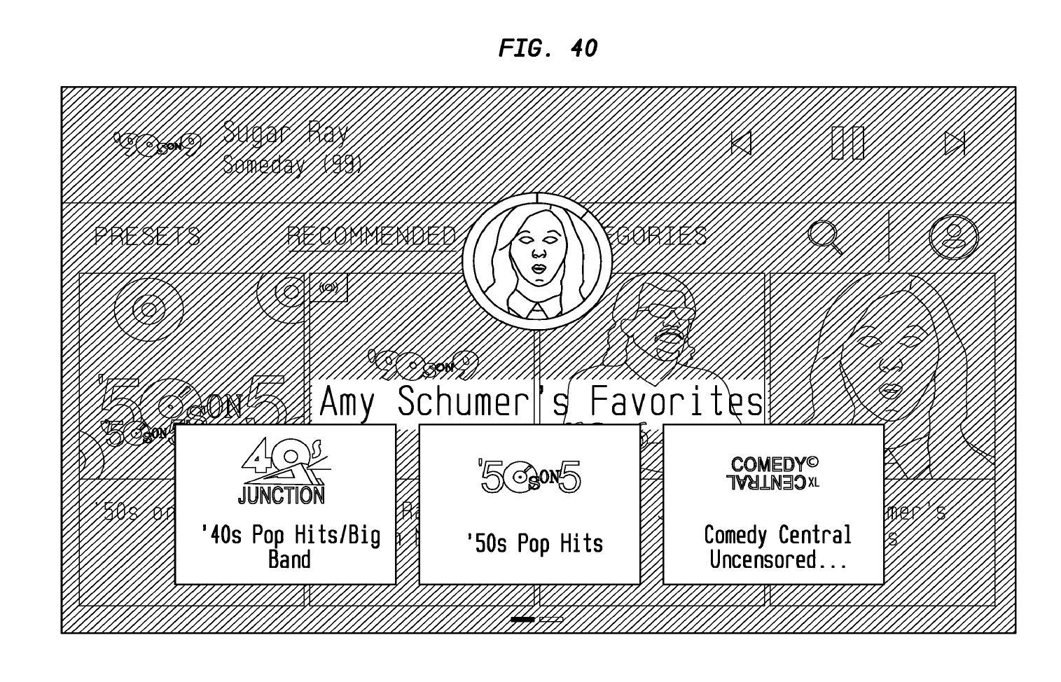

FIG. 40 shows what happens when a user activates the “Amy Schumer's Favorites” tile in FIG. 39, thus bringing up the set of “Amy Schumer's Favorites” as shown in FIG. 40, which include three channels.

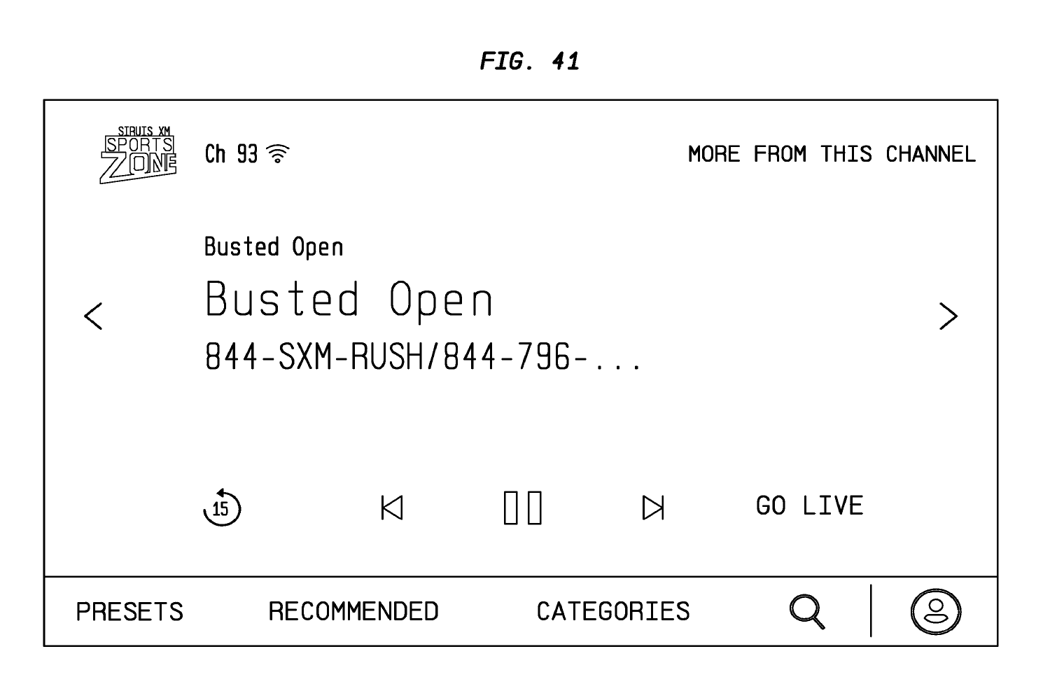

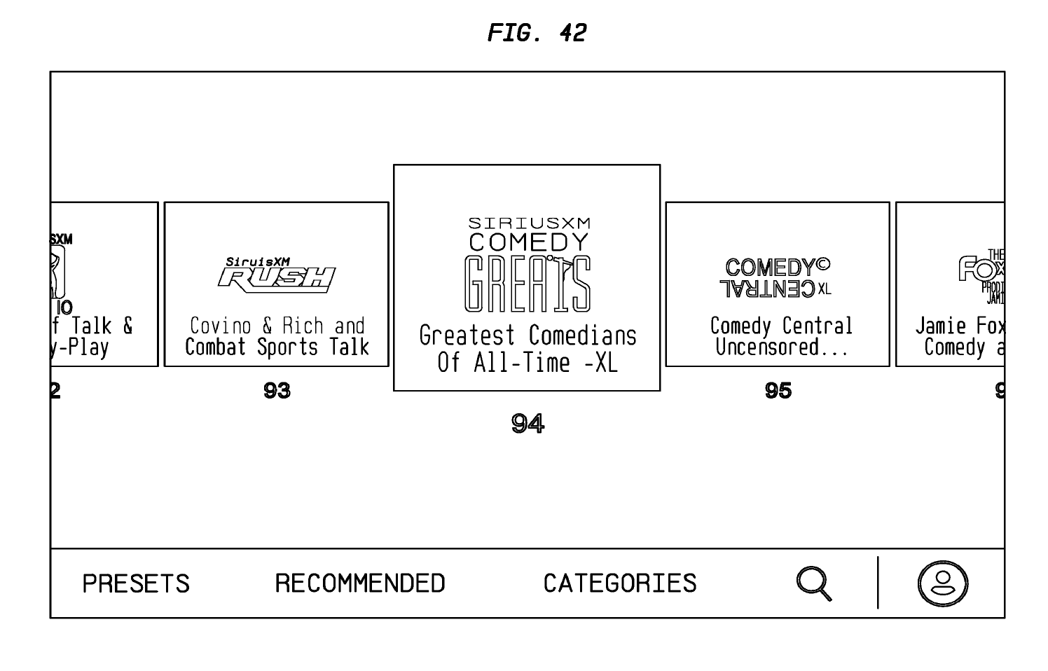

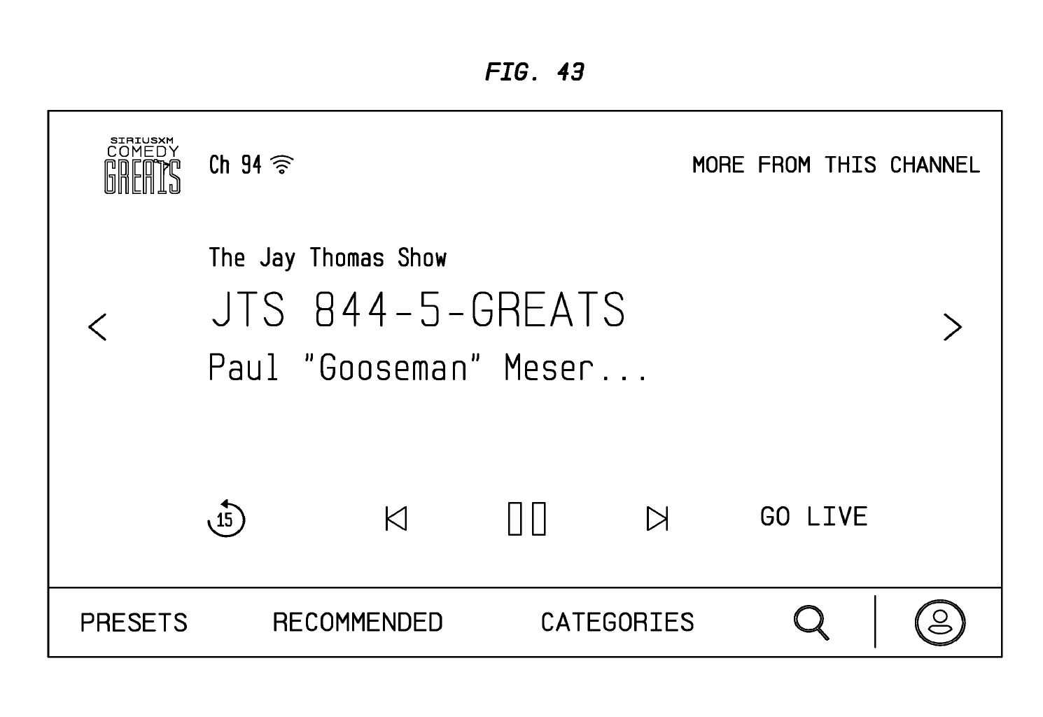

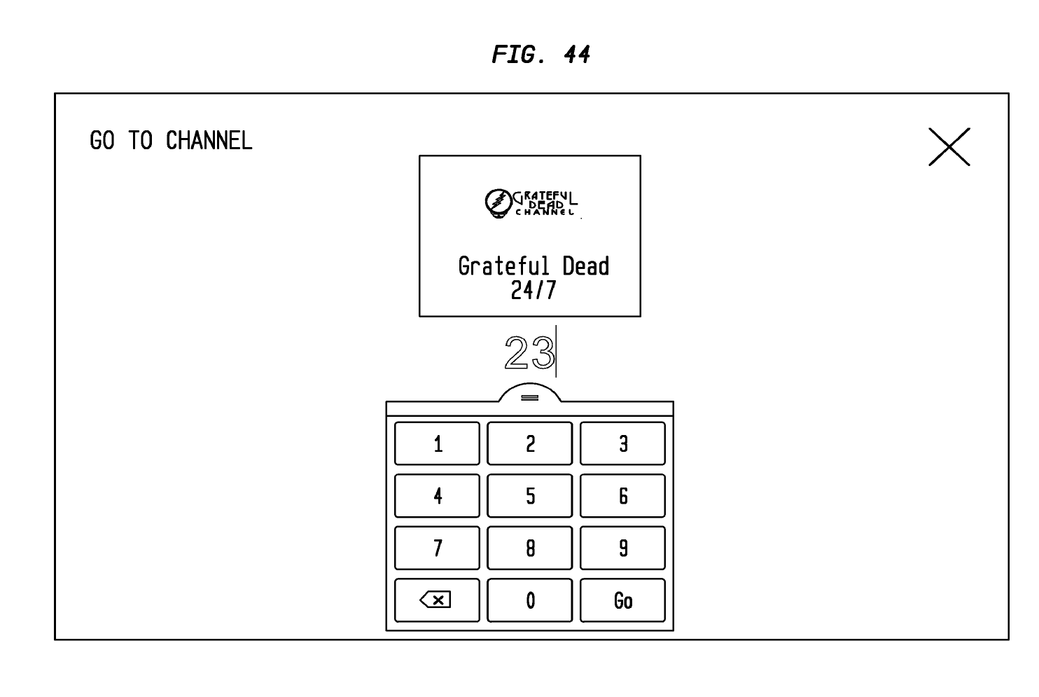

FIG. 41 depicts an exemplary player screen for Channel 93 which is “Sirius XM Sports Zone” according to an exemplary embodiment of the present subject matter. If a user activates one of the arrow buttons on the left or the right of the player screen of FIG. 41 (or any player screen), they will see the horizontal tile tuning screen as shown in FIG. 42. The activated channel is the next channel from Channel 93, as shown in FIG. 41, namely, Channel 84—Sirius XM Comedy Greats. A user may either select that tile, or may do nothing and after a certain lapse of time, the screen will move to that channel, as shown in FIG. 43. Thus, FIG. 43 is the player screen for Channel 94 which was selected as shown in FIG. 42. If the user touches or selects the Channel 94 button shown in the upper left of FIG. 43 they will arrive at FIG. 44 which is, once again, the GO TO CHANNEL screen. Here, the user has already selected or input the numbers 2 and 3 for Channel 23—Grateful Dead Channel, but nothing happens until the user either selects the tile icon or the “go” button, in FIG. 44. If the user does neither, and presses the active “X” button at the top right of FIG. 44, they are returned to the player screen of FIG. 43. There is also an “undo” button in the number array bottom left, which removes the last entered digit.

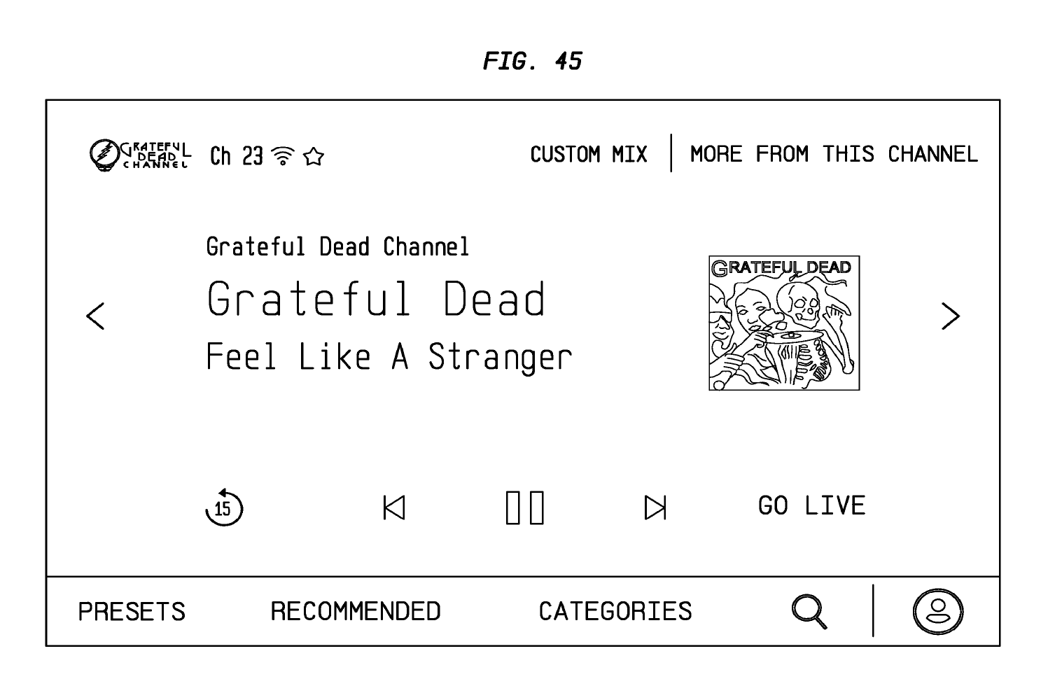

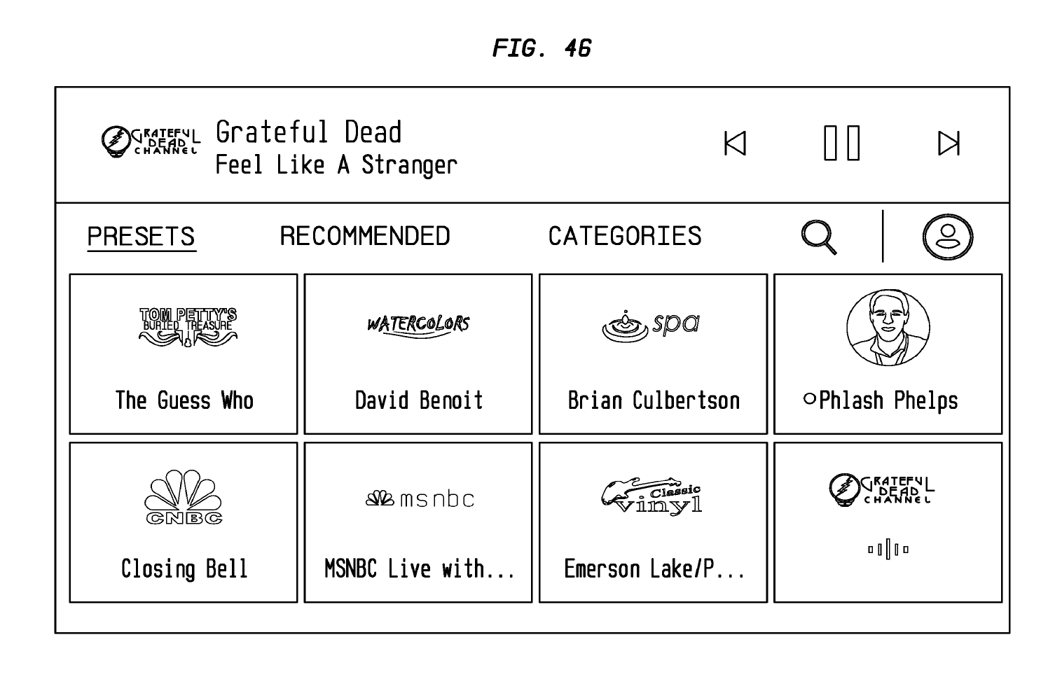

Assuming the user has selected the channel shown in FIG. 44, FIG. 45 is an exemplary player screen for Channel 23. In FIG. 46, while still playing Channel 23, the user has activated the presets button at the bottom left of FIG. 45. Therefore, while Channel 23 remains playing through the audio system, the user's presets are also shown. It is noted that a user has recently added the preset “Grateful Dead” in the bottom right by a long press on the album art in the player screen of FIG. 45. The recently added preset is shown in a darkened tile, as seen in FIG. 46, to indicate this recent addition to the presets.

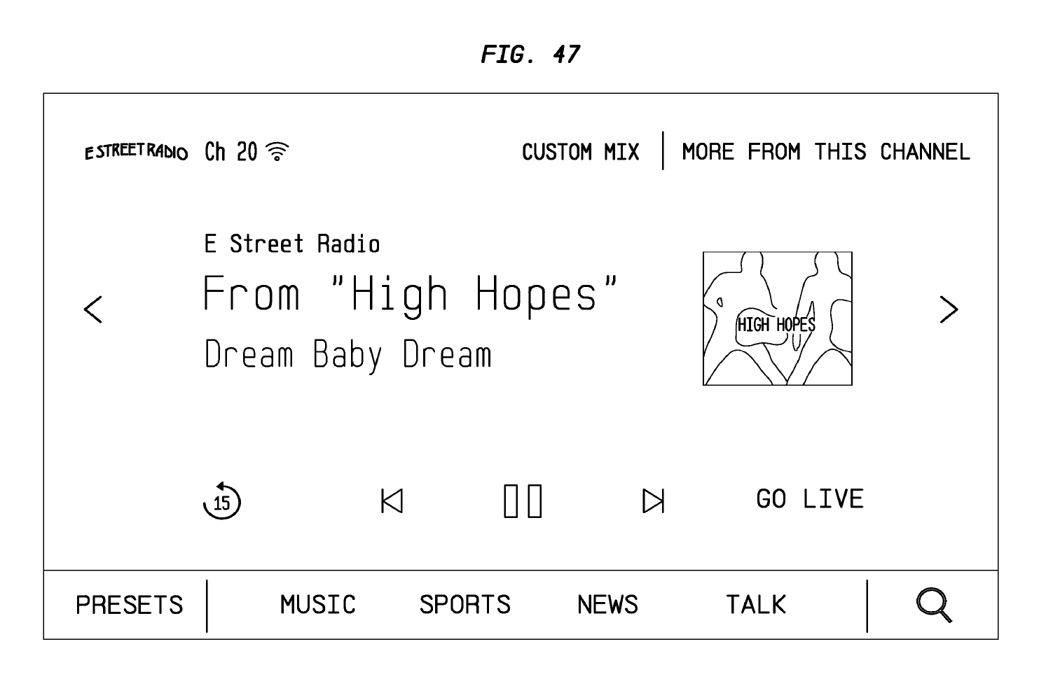

FIGS. 47 through 51, next described, depict a sequence of user interactions while “Channel 20—E Street Radio” has been selected.

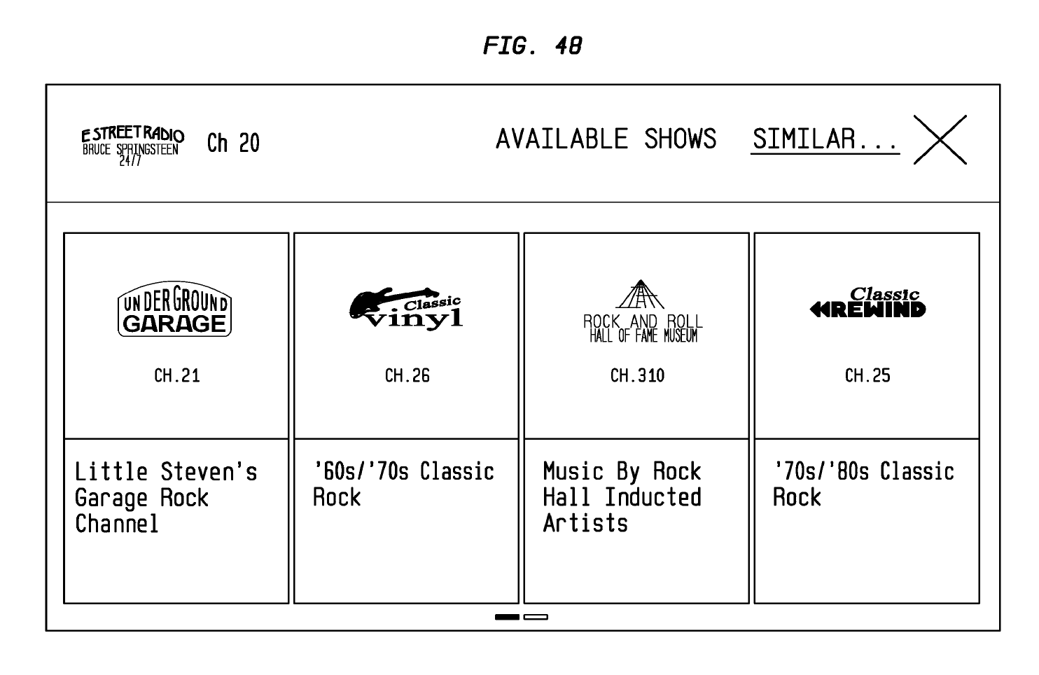

FIG. 47 depicts the player screen for Channel 27—E Street Radio. By clicking on “MORE FROM THIS CHANNEL” at the top right of FIG. 47, the user arrives at the exemplary screen shown in FIG. 48 which is a listing of similar channels to that of the currently selected channel that is now playing. Those are all channels which have similar content and feel to Bruce Springsteen and the E. Street Band type of songs. Only the first of two similar channel screens are shown, as indicated by the blue horizontal bar at the bottom center being highlighted, and a second one ghosted.

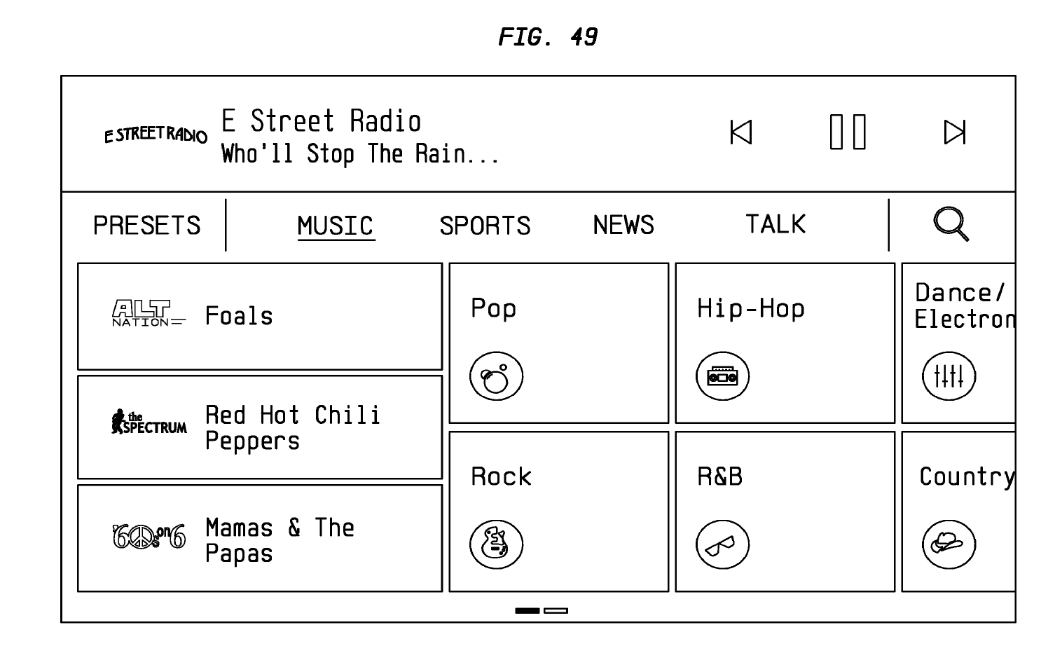

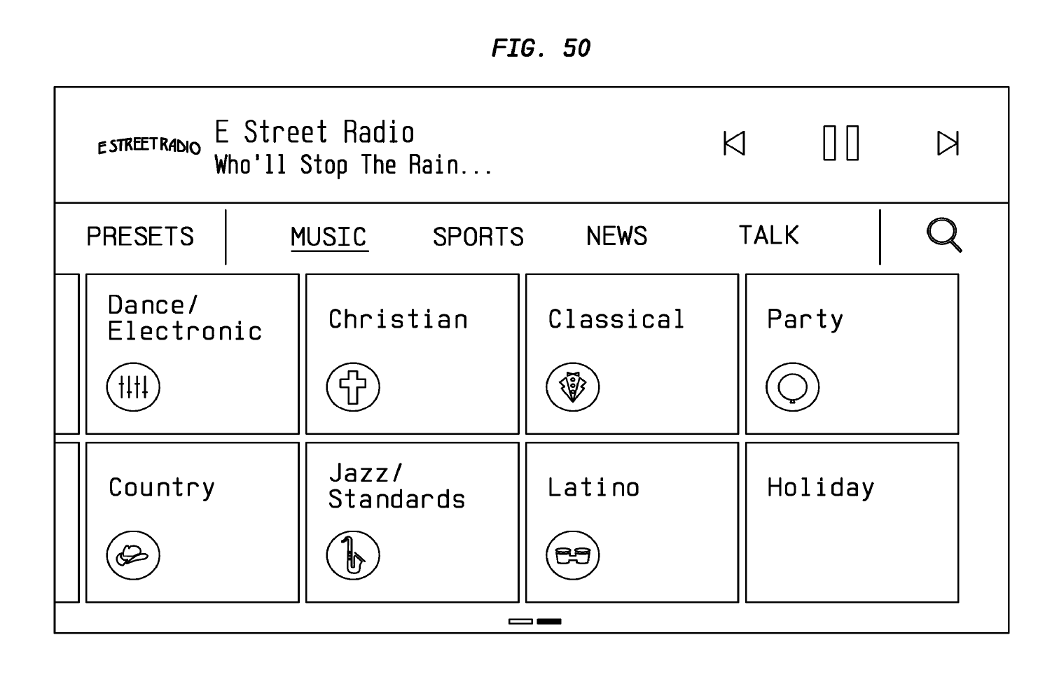

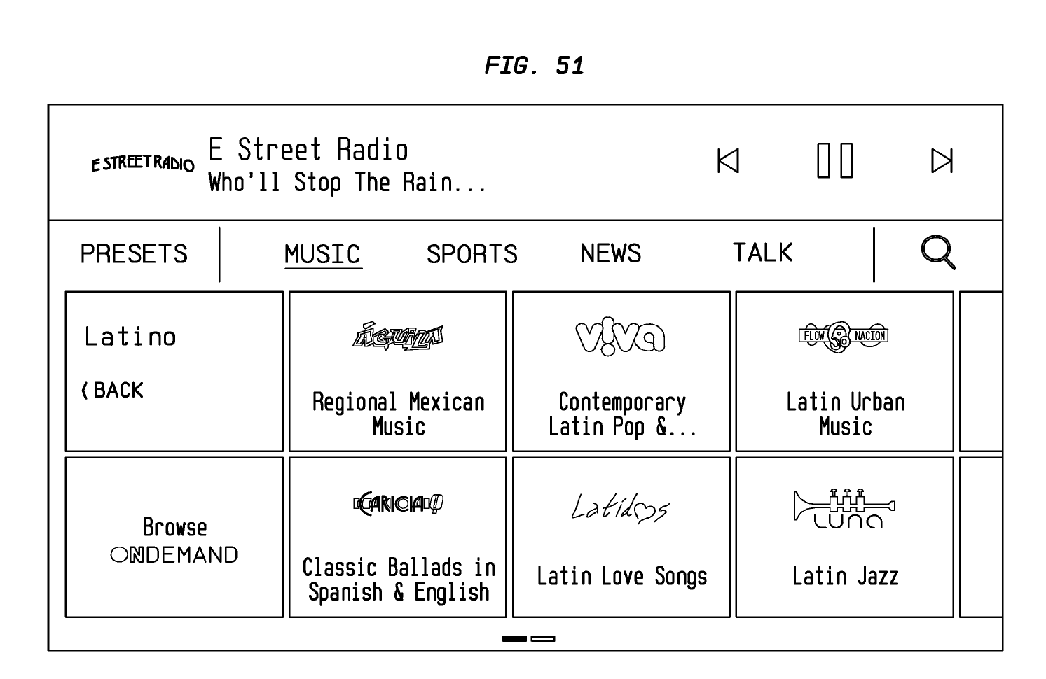

FIG. 49 illustrates an alternate type of category depiction where not only are the various music categories shown, but there are also shown some highlighted channels themselves, with their channel art, much as would be seen in the background of a player screen as shown in FIG. 47, for example. Here, in the music category depiction of FIG. 49, we have the subcategories of pop, rock, etc., as well as three featured recommended channels. This is an alternate presentation of a subcategory screen according to an exemplary embodiment of the present subject matter. It is the first of two screens which depict music categories, the second one being FIG. 50, which shows the remainder of the tiles which were cut off in FIG. 49 as can be seen.

FIG. 51 shows what happens if a user selects the Latino tile shown at the bottom center right of FIG. 50. Here the various channels in the Latino mix are shown by their tiles, all identified by channel icon, usually in a vivid set of colors, with the channel description underneath according to an exemplary embodiment of the present subject matter. It is also noted that in the bottom left of FIG. 51 is a “BROWSE ON DEMAND” tile which allows a user to access any content that is not currently playing, but may be available on-demand from the SDARS's service provider via IP streaming, as noted above. FIG. 51 ends this sequence of user interactions implemented while playing “E Street Radio”, as shown at the truncated player screen at the top of each of FIGS. 47-51.

FIG. 52 shows what happens if a user has moved up ahead to “Channel 25—Classic Rewind” and then selected the Presets icon. It is noted that eight tiles are shown in this exemplary presets screen in this embodiment. This was chosen to be aesthetically pleasing to someone interacting with this type of screen in a vehicle environment. In other exemplary embodiments, more or fewer tiles could be shown per screen and, of course, if screen size gets larger, more tiles can be shown, or channel art can be made larger. It is noted that the unconscious (or conscious) associations to the pictures or images is what allows a user to quickly navigate. The user does not necessarily recognize all of the words of the channel name, but rather the images associated with the channel.

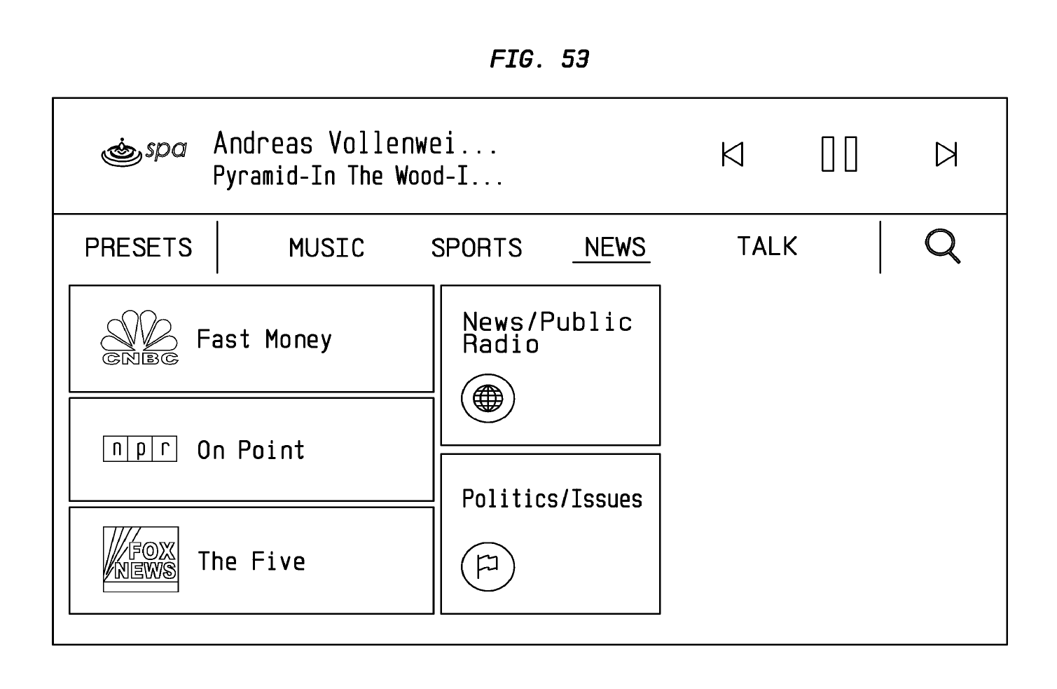

From FIG. 52, FIG. 53 illustrates what happens if a user has chosen the Spa Channel shown in the top center right tile of FIG. 52, and has then also selected the News category from a category screen while the Spa Channel is playing in the background. This again is the alternate presentation screen for a sub-category, similar to that shown in FIG. 49. However, here, for the News category, there are three recommended channels (shown as highlighted) as well as two subcategories;

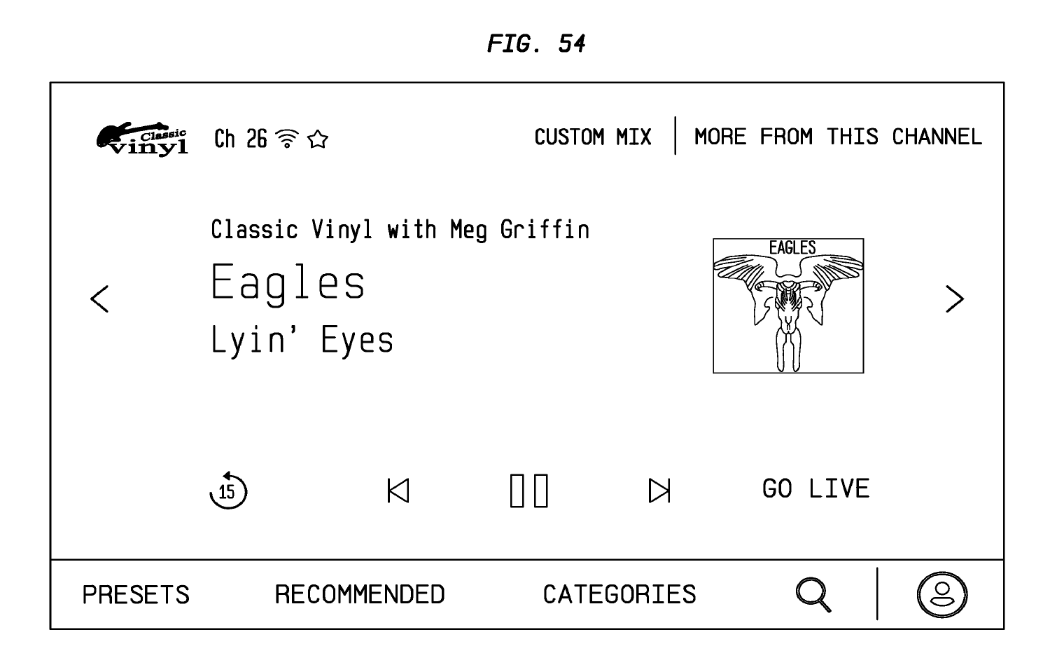

FIGS. 54 through 59 all show various exemplary user interactions while a user is playing “Channel 26—Classic Vinyl.” The user could have easily selected Channel 26 by, for example, entering the horizontal tile tuner from Channel 25 which was the Classic Rewind shown playing above in FIG. 52, prior to the Spa Channel being selected in FIG. 52 from the presets for that user. Or, for example, by returning to the player screen while Channel 25 was playing, and then use the carets on the right and left sides of the player screen of FIG. 54 to move forward or backward (here it would be forward one channel).

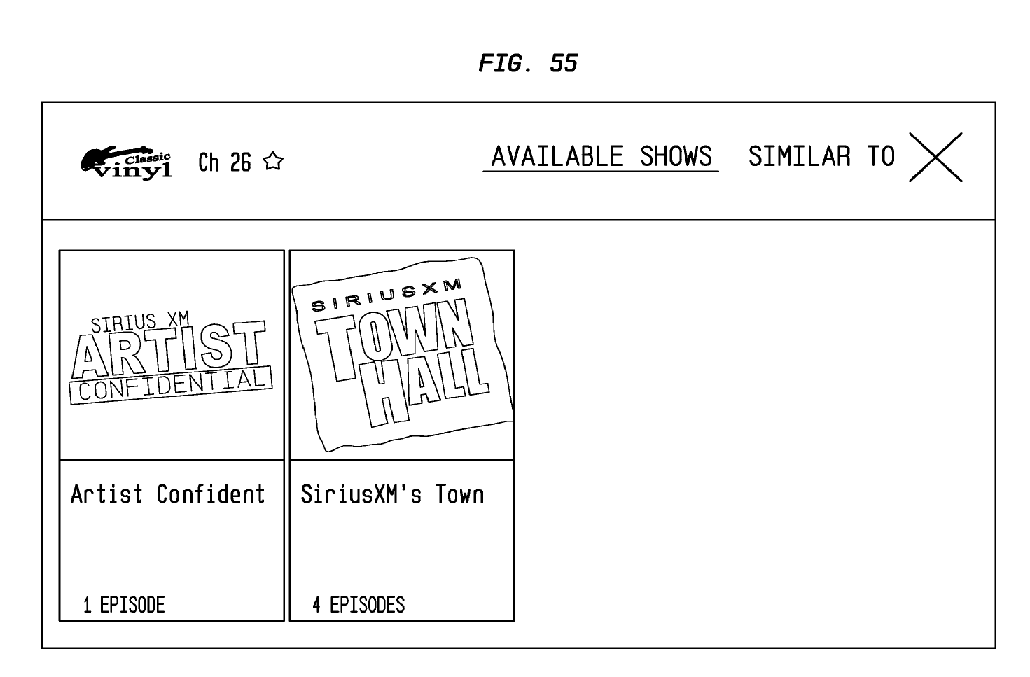

In FIG. 54 we see the familiar player screen showing the Classic Vinyl and Channel 26 icons; the blue star to the right of the channel number indicates that this channel has been saved as a preset for this user profile. In FIG. 55 the user has once again chosen the “MORE FROM THIS CHANNEL” feature in FIG. 54. This button has two possible categories as shown in FIG. 55, the AVAILABLE SHOWS and the SIMILAR TO categories. FIG. 55 depicts AVAILABLE SHOWS which, in this example, are on-demand content associated with Channel 26. As shown, there is one episode of Artist Confidential and four episodes of Sirius XM's Town Hall Available which have similar music content to that played on Channel 26. This is a good example of what is meant in exemplary embodiments of the present subject matter by the “MORE FROM THIS CHANNEL” feature, where a user can easily navigate to, and then experience, enhanced, augmented, or richer versions of the content he or she hears on the live channel.

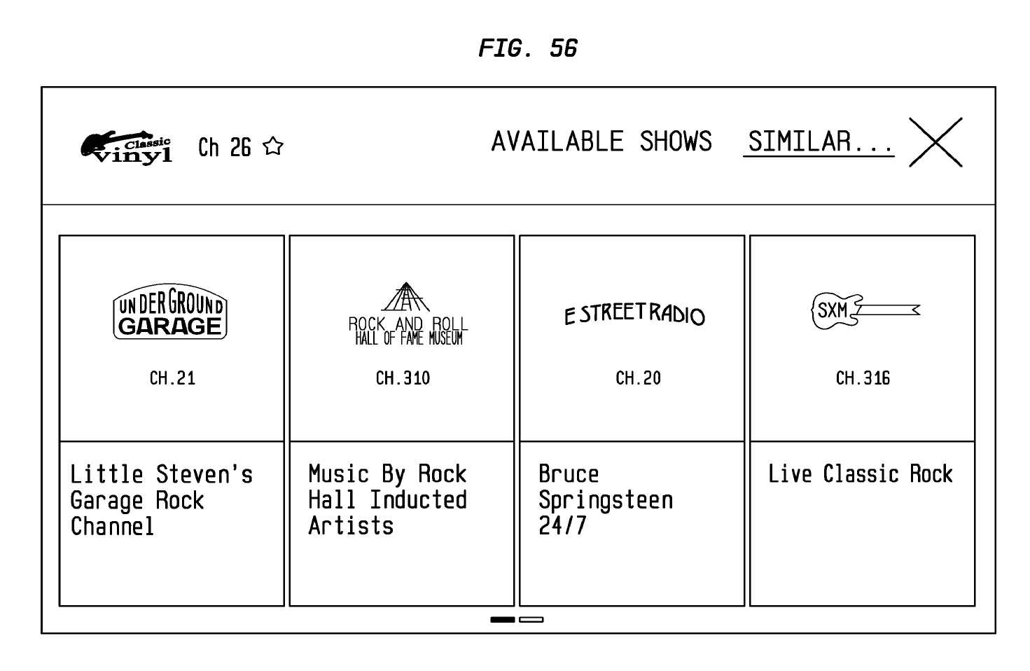

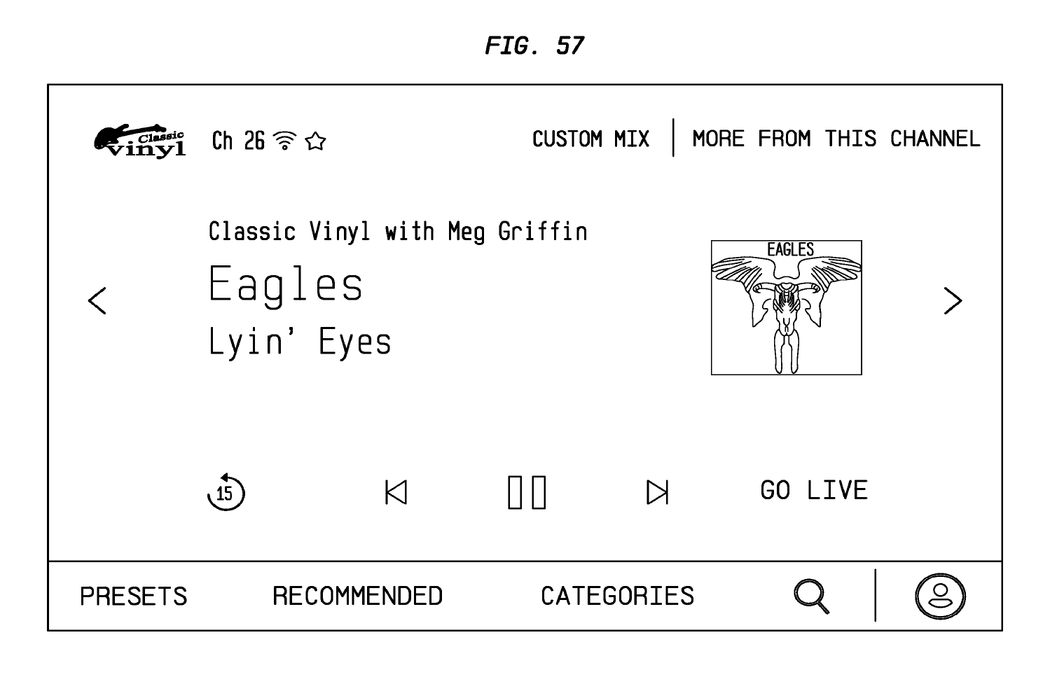

Continuing from FIG. 55, assuming the user has now selected the “SIMILAR TO” active button at the top of FIG. 55 (and it is noted that this is all under the “MORE FROM THIS CHANNEL” series of screens), we see in FIG. 56 that there are two screens of SIMILAR to channels. FIG. 56 is the first one, showing four tiles. These tiles are rectangular and the top of each is prominently features the channel icon, underneath it the channel number, and underneath the upper portion of the tile, the channel description. FIG. 57 shows a return to the player screen for Channel 26. This can be achieved by simply exiting the SIMILAR TO screen of FIG. 56 by touching the “X” icon in the upper right of FIG. 56 which brings the user back to the player screen for Channel 26, as shown in FIG. 57.

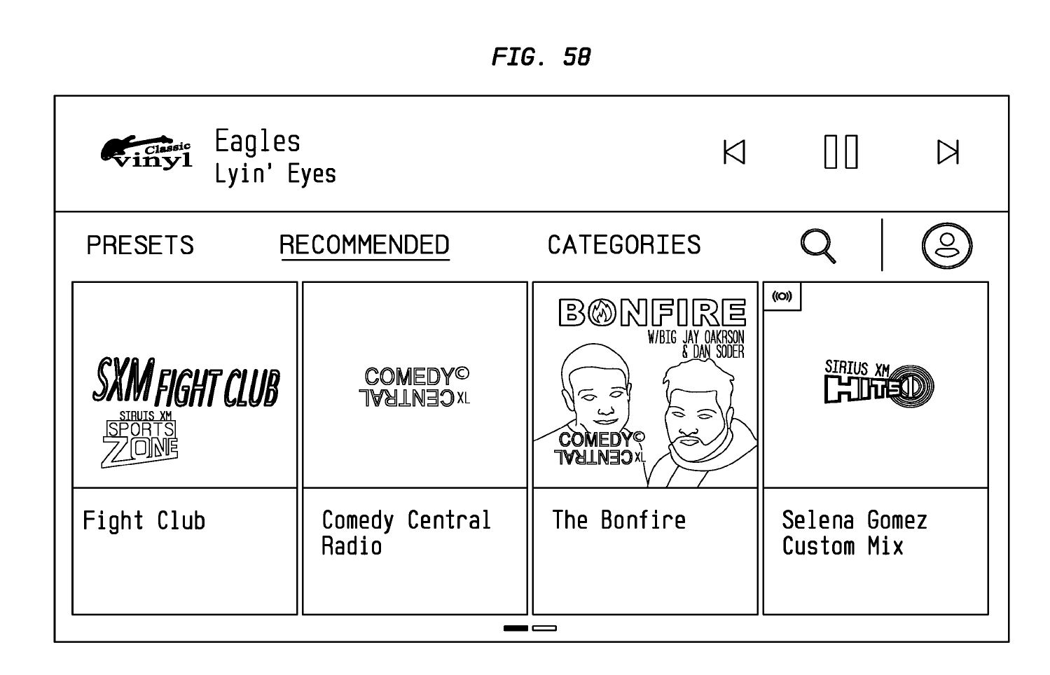

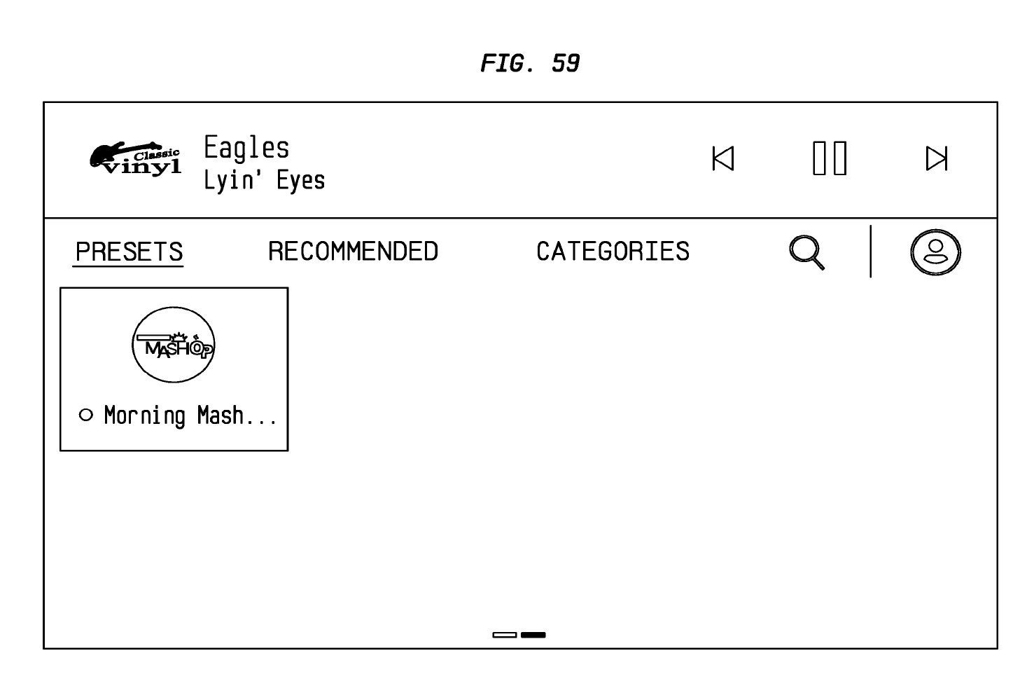

FIGS. 58 and 59 illustrate the result of the user selecting the “Recommended” button at the bottom of FIG. 57. FIG. 58 is the first of two recommended screens, and FIG. 59 being the second, according to an exemplary embodiment of the present subject matter.

A user may navigate between the two recommended screens by swiping right or left. Thus, from FIG. 58 a swipe to the left at the right side of the screen will bring up the next set of recommended icons or tiles in FIG. 59. Each of the two recommended screens uses the same four-per-screen static icon or image on top and channel description on the bottom. It is noted that the blue icon in the upper left of the “Sirius XM Hits 1” channel tile in FIG. 58 is an indication that this is streamed content coming from IP.

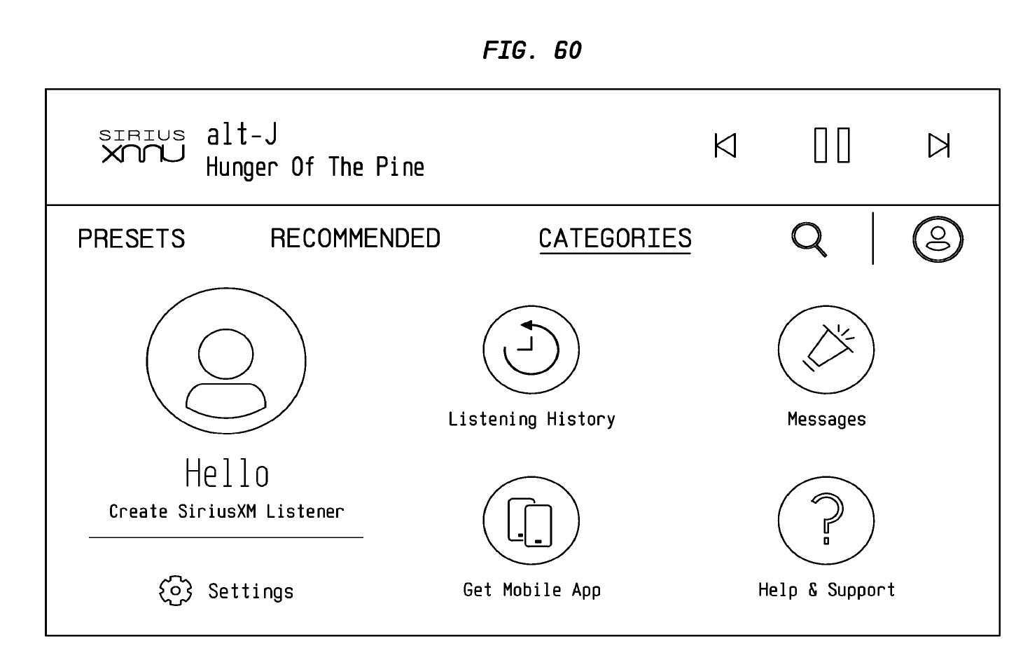

Finally, in many of the screens shown, there appears an icon showing a human surrounded by a circle, located at the upper right area of the screen. The icon includes a stylized head and torso, surrounded by a circle. If a user activates that symbol, what he or she sees is a screen such as is shown, for example, in FIG. 60. This interactive screen presents various options to the user to create personalized data as well as a number of other features, as next described.

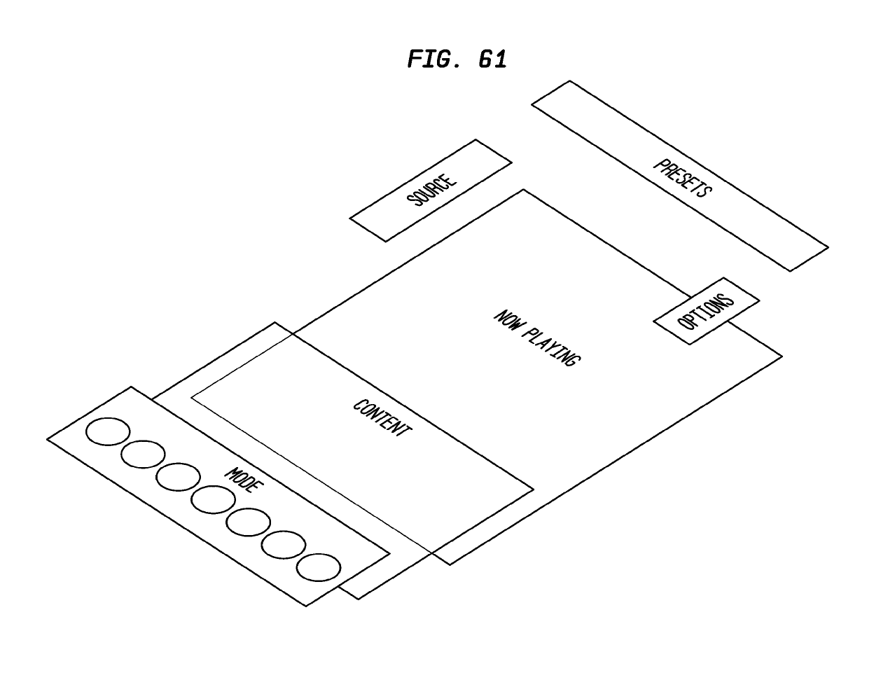

FIGS. 61-70 are exemplary screen shots of an alternate embodiment of the present subject matter, designed for use in a different, more vertical, aspect ratio. These figures are next described. Thus, the various interactive presentations and screens of the present subject matter are not limited or restricted to any size, shape, or aspect ratio of display screen, and all features shown in this disclosure in one exemplary display screen context may be readily ported and adapted to any other display context.

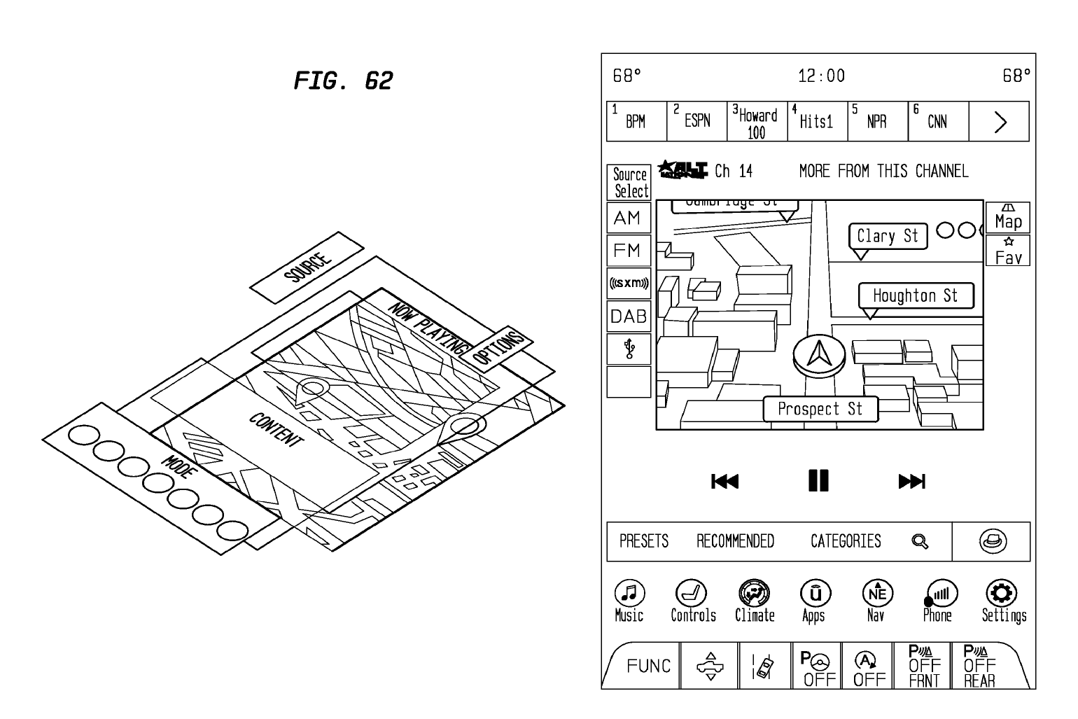

FIG. 61 depicts the various layers and sections of an exemplary visual design according to an alternate exemplary embodiment of the present subject matter, and what content may be placed in such sections. As can be seen, the bottom layer is the show, event or the like then playing, and the various icons, buttons and informative messaging appears on upper layers superimposed upon the bottom layer. Thus, FIG. 62 depicts an exemplary implementation of the layers and sections of FIG. 61 where the “Now Playing” bottom layer has a navigation application running in it.

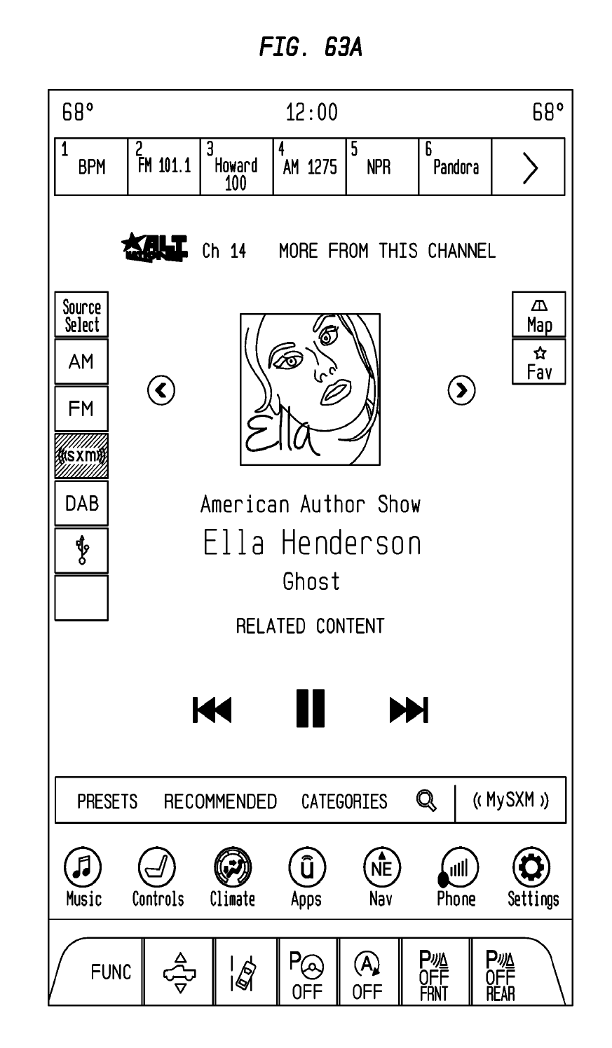

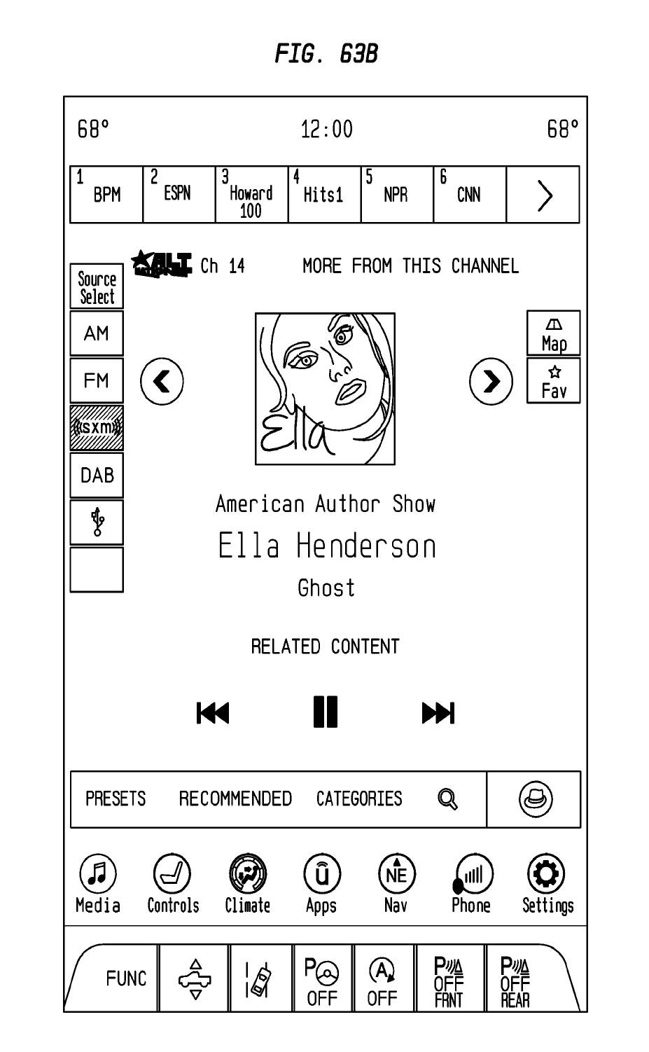

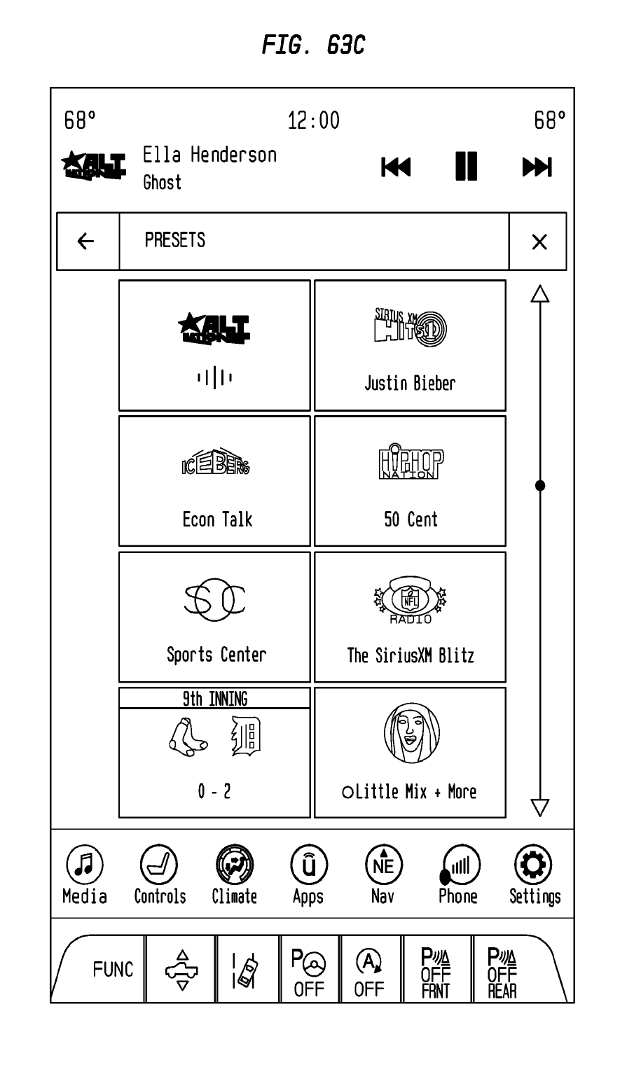

FIG. 63 depict an exemplary implementation of mixed presets in a main screen with application specific presets accessed by selecting a source and selecting a presets button. Given that an in-vehicle radio or receiver is integrated with the other media content sources in-vehicle, including other radio pathways as well as IP communications via a modem, to make the satellite radio service (with its large screen displays of album art, icons, etc., as demonstrated above) the “home” application, in some embodiments the presets from all other applications may also be displayed in an integrated presentation, to give the user a global view. This is shown in FIG. 63(a). FIGS. 63(b) and 63(c) depict application specific presets, where the “SXM” button is active. Thus, pressing “presets” as shown in FIG. 63(b) results in only SXM presets being shown, as in FIG. 63(c).

Noteworthy elements of the presets shown in FIG. 63(c) are the content provided over IP, namely a custom mix channel for this user, “Little Mix+More” (bottom right icon) and the live sports icon (bottom left icon). The “Little Mix+More”, being a custom mix channel, displays a green dot to indicate it is not on the live satellite radio broadcast. The live sports icon shows that there is a game between a user's designated team, one of the Boston Red Sox and the Detroit Tigers. The icon is also dynamic, and here shows that the indicated game is in the ninth inning. In exemplary embodiments of the present subject matter, a live sports icon will only be shown in “Presets” when an actual game is in play.

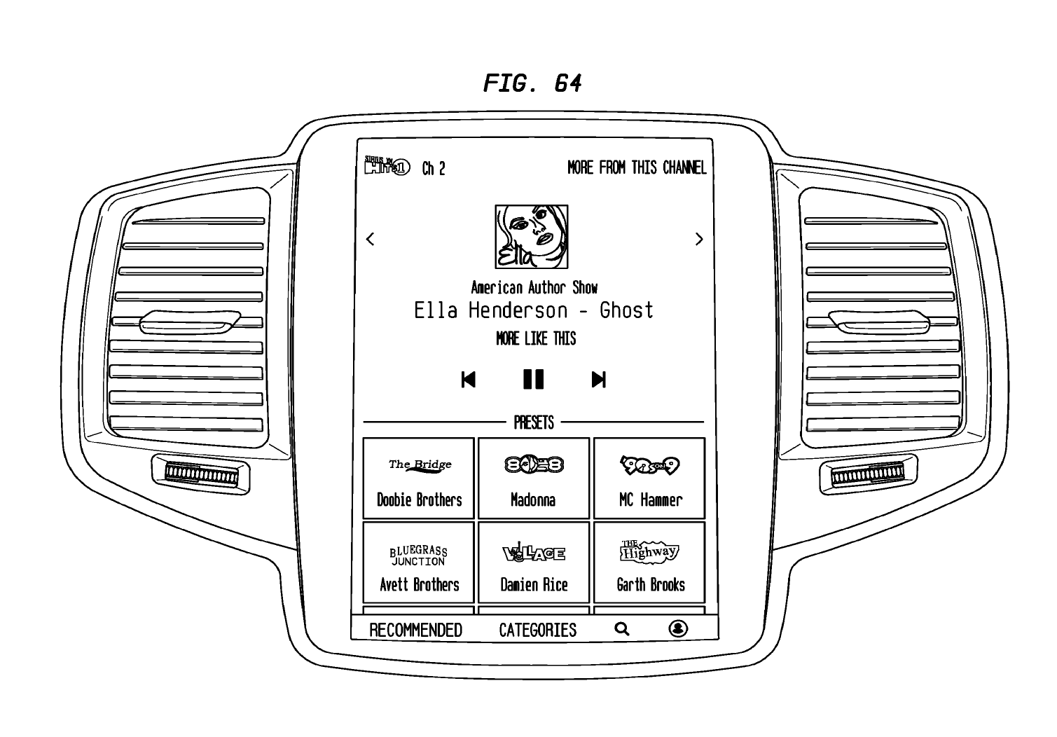

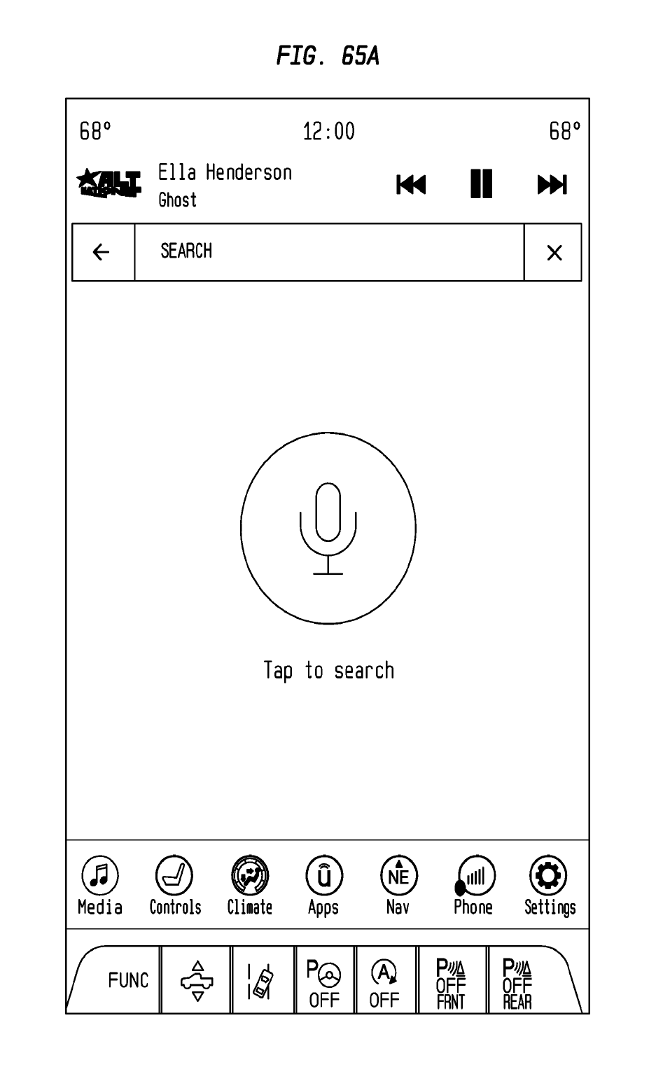

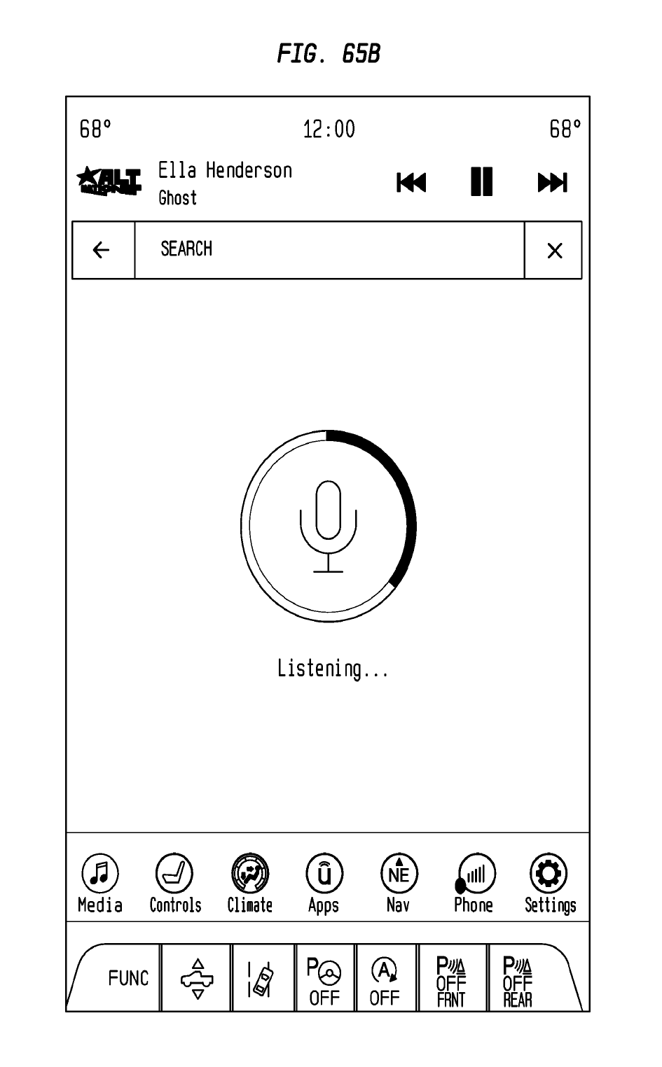

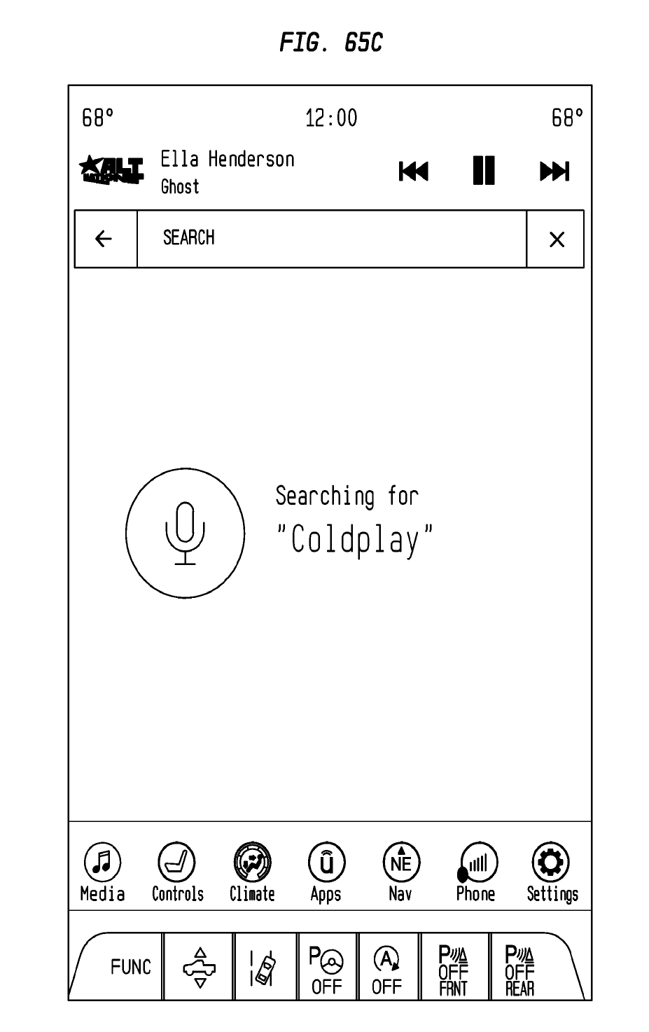

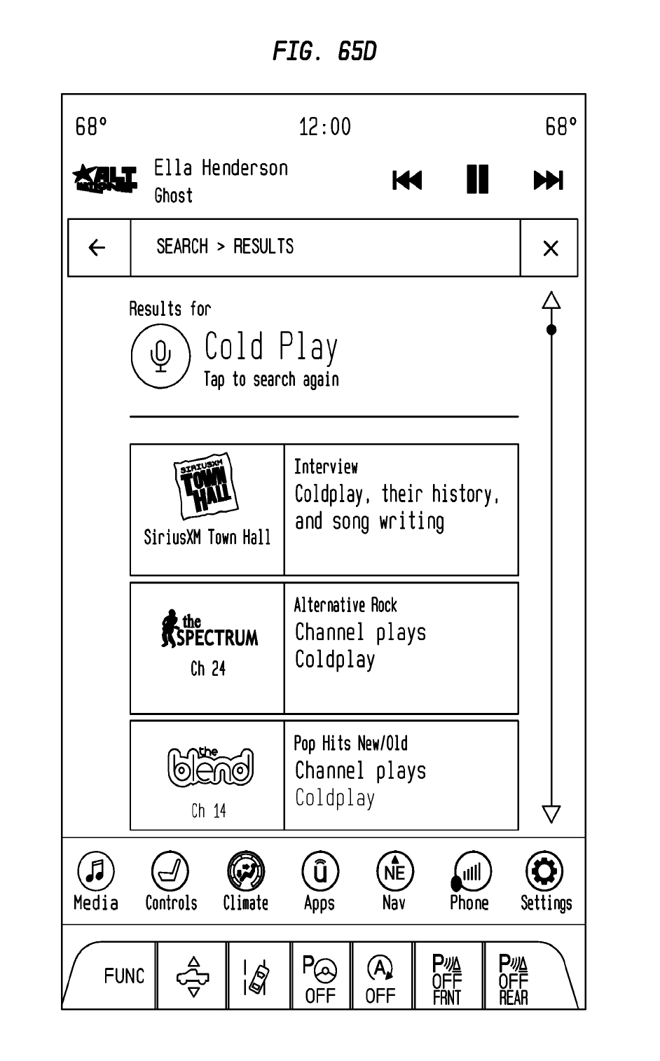

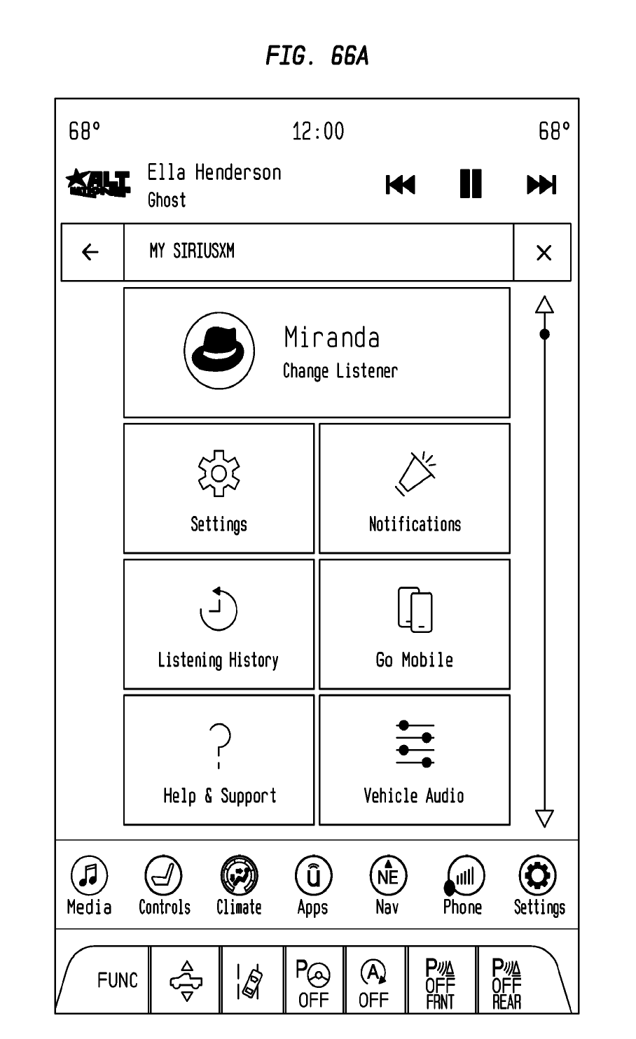

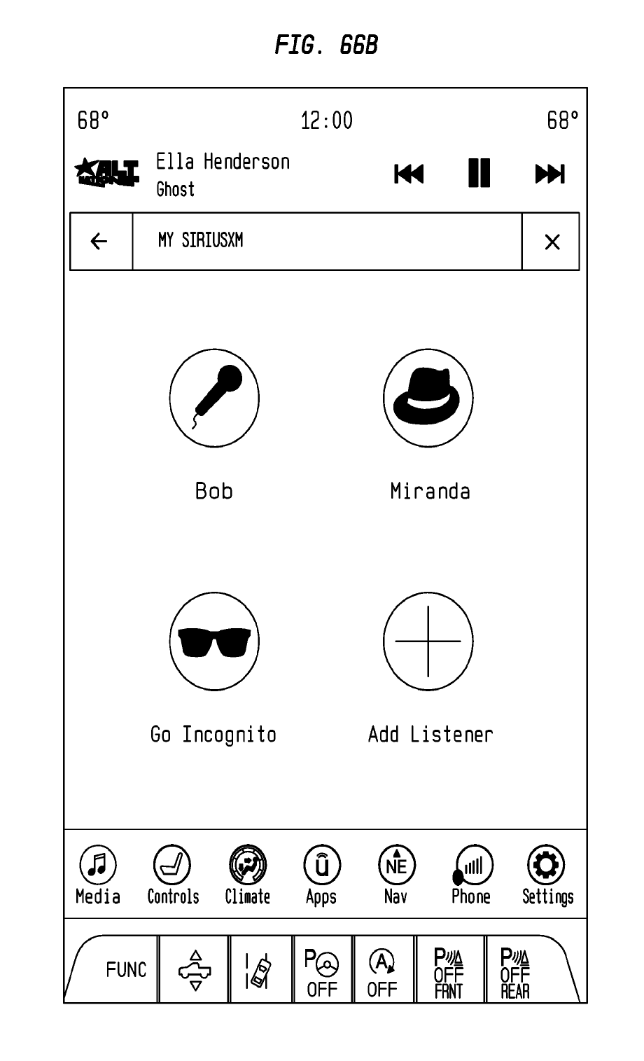

FIG. 64 depicts an exemplary automotive center stack, with a more vertical screen aspect ratio, according to the alternate exemplary embodiment for which the more vertical screen shots were developed. The hat icon at the bottom left is the equivalent of the head and torso icon shown above, which, when pressed or activated, takes a user to the Profiles screens shown in FIGS. 66. In this exemplary embodiment, the bottom portion of the screen displays icons for the various presets are shown. FIG. 65 depict a voice search sequence using screens according to the alternate exemplary embodiment, and, as noted, FIG. 66 depict profile creation and use using screens according to the alternate exemplary embodiment.

With reference to FIG. 65(a), a user taps the microphone icon to initiate a search. He then hears a chime, signaling that the system can accept his voice input. FIG. 65(b) depicts a blue circle filling a perimeter of the circle around the microphone, and indicates that the system is listening. When the system detects silence, the blue circle stops moving, and an end chime is sounded to the user. In this example the user had spoken “Coldplay.” The system, as shown in FIG. 65(c), searches for content responsive to the search term “Coldplay.” If, for example, that is *not* the term that the user wanted to search, the user may tap the microphone again, and the flow will return to FIG. 65(b). If the system accurately understood the search term, then flow continues to FIG. 65(d), where the search results are returned to the user for selection. The top row of the search results is an interview on SiriusXM Town Hall channel that is not available on the live broadcast, but is supplemental content available via IP channels. Hence, the descriptor “Interview” is shown in a green color. The remaining results are on the live broadcast (listening to which incurs no data fees) and refer to channels that play Coldplay's music.

As noted above, the user profiles available on this device are shown via names and icons, and each user profile is global, so its settings persist across persist across all Sirius XM enabled devices, for example.

FIGS. 67-68 depict screens associated with converting a customer at the end of their free trial to a paid subscription plan. These screens would be presented to a user at the end of a free trial, and thus are the “other bookend” to the tutorial/free trial sign up screens of FIGS. 1-5. FIGS. 67 and 68 offer a user a convenient way to select a subscription plan, enter user and payment data, and pay for it, as one would purchase goods or services online. The interactive screens use the connected IP communications channel to communicate with the Sirius XM servers.

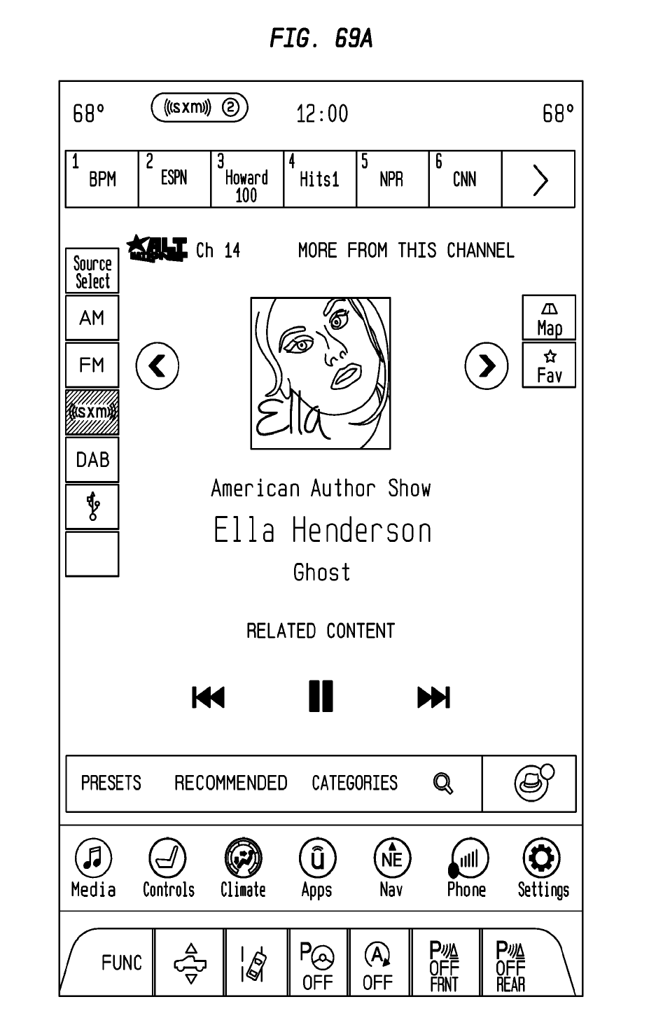

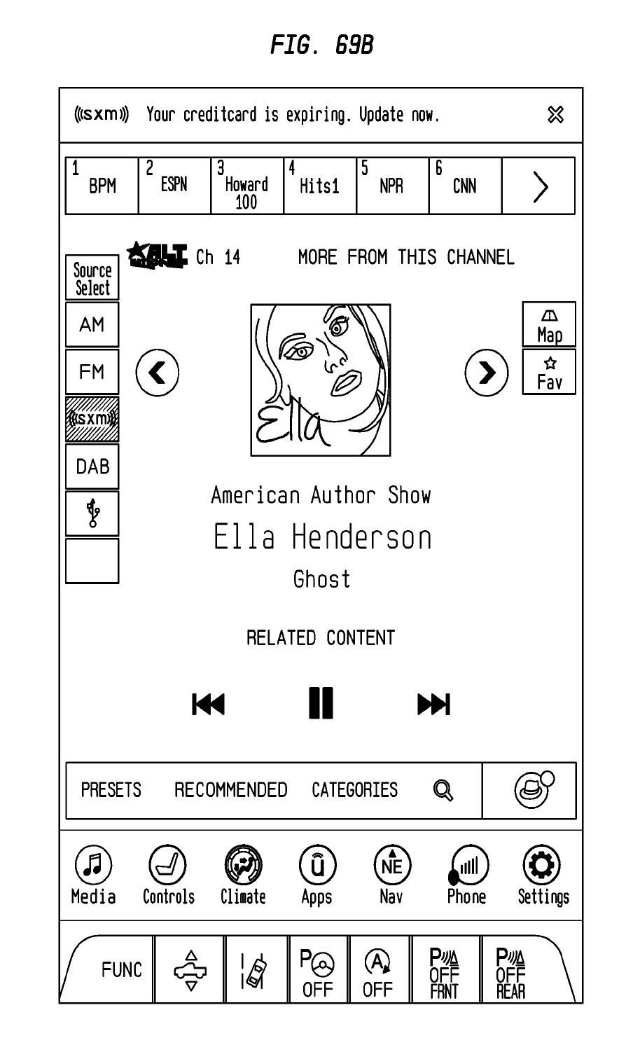

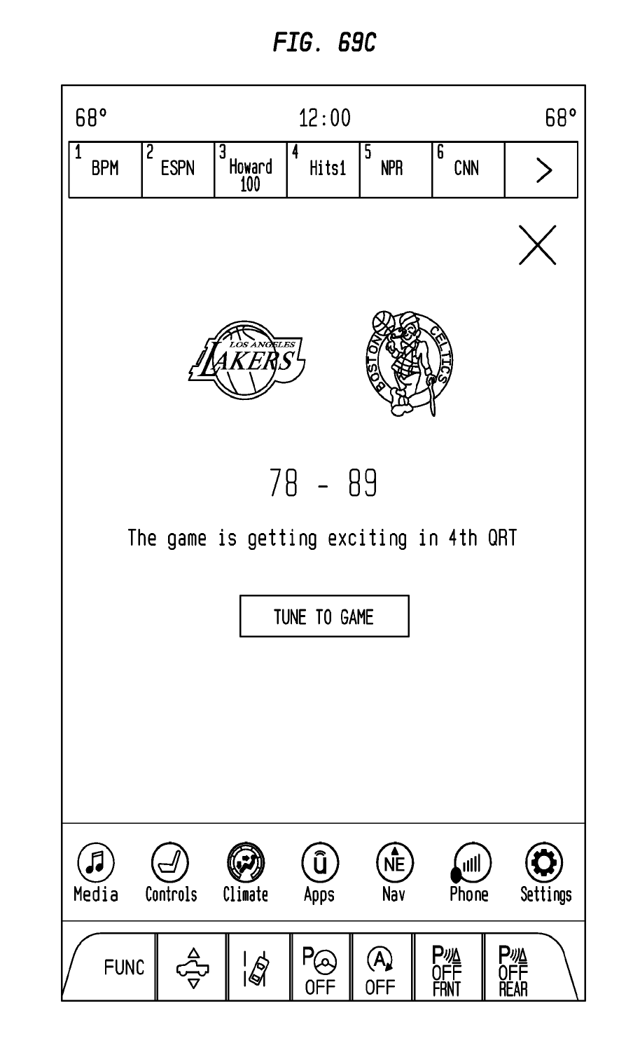

FIG. 69(a) is a player screen, here on Channel 14—Alt Nation. The “SXM 2” displayed at the top left indicates that the user has two system messages available for reading. FIG. 69(b) illustrates sending a user an in-band message, as seen at the top informational bar, which the user accesses by pressing the messages icon as show in FIG. 69(a). The messages are sent over IP, which is a user specific communications pipe, as opposed to the one to many broadcast communications channel. FIG. 69(c) shows a promo for a now playing basketball game, which the user may be interested in now that it is getting exciting. The live sports game prompt is akin to a recommendation, and is based upon one or more content recommendation algorithms that draw upon user data and listening habits, as described above. As also seen in FIGS. 69(a) and (b), there is a “Related Content” button centered under the program name.

Again, as indicated throughout the UI interactions described above, the information presentation to users is primarily iconic. The teams playing are depicted via their logos, the score is easily seen, and an easy to select “TUNE TO GAME” button is prominently positioned.

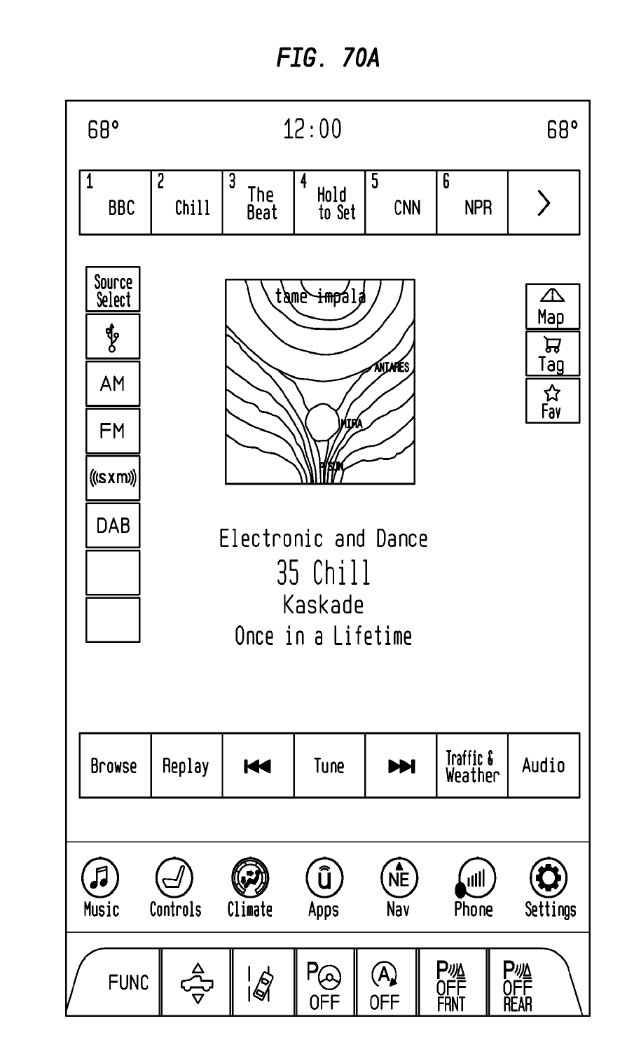

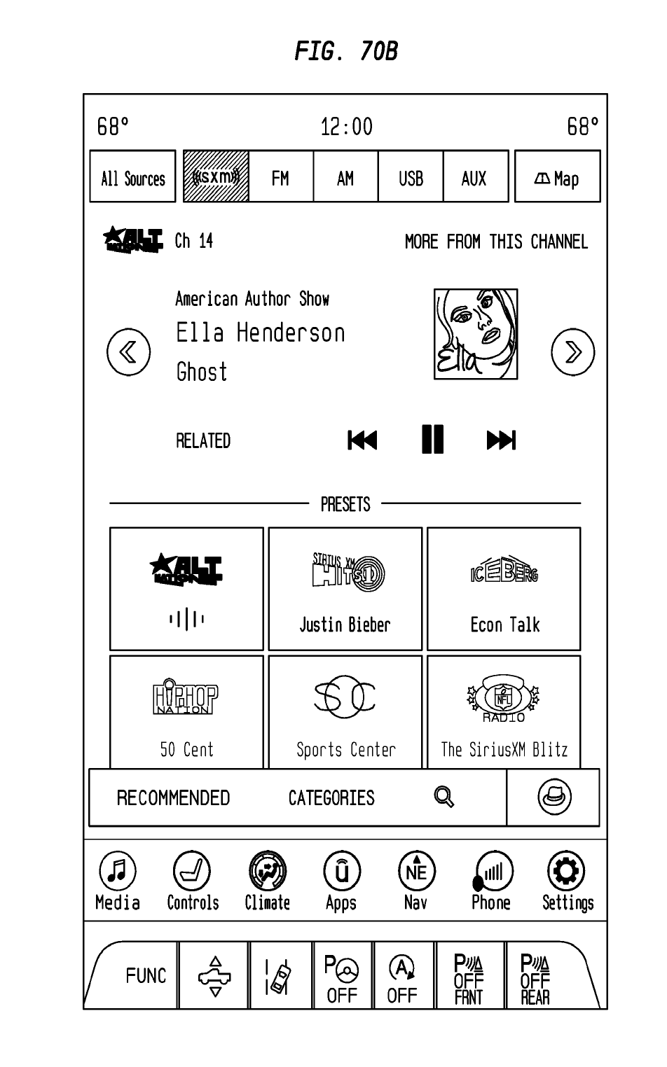

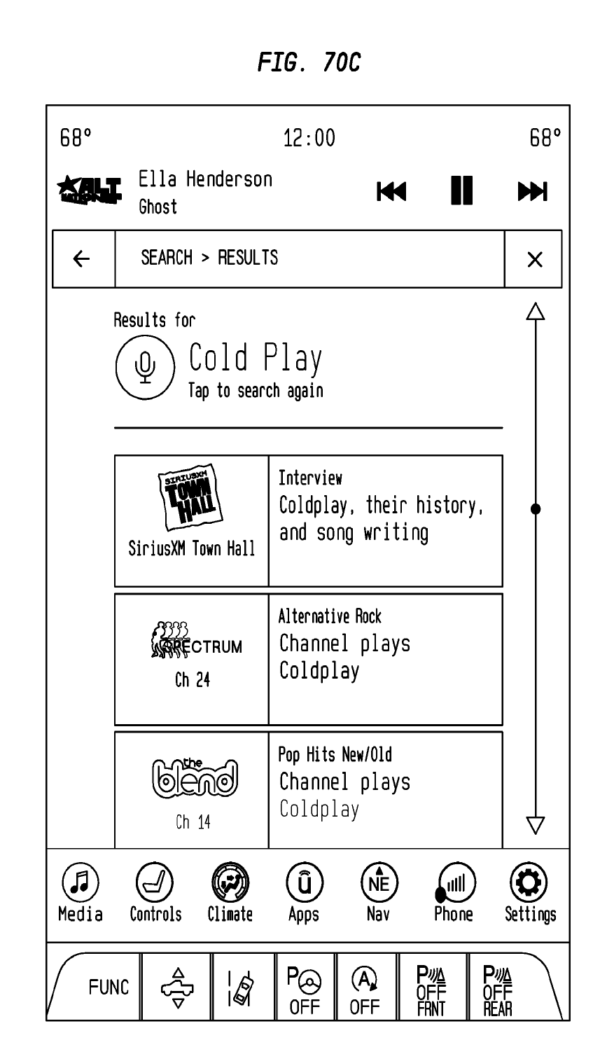

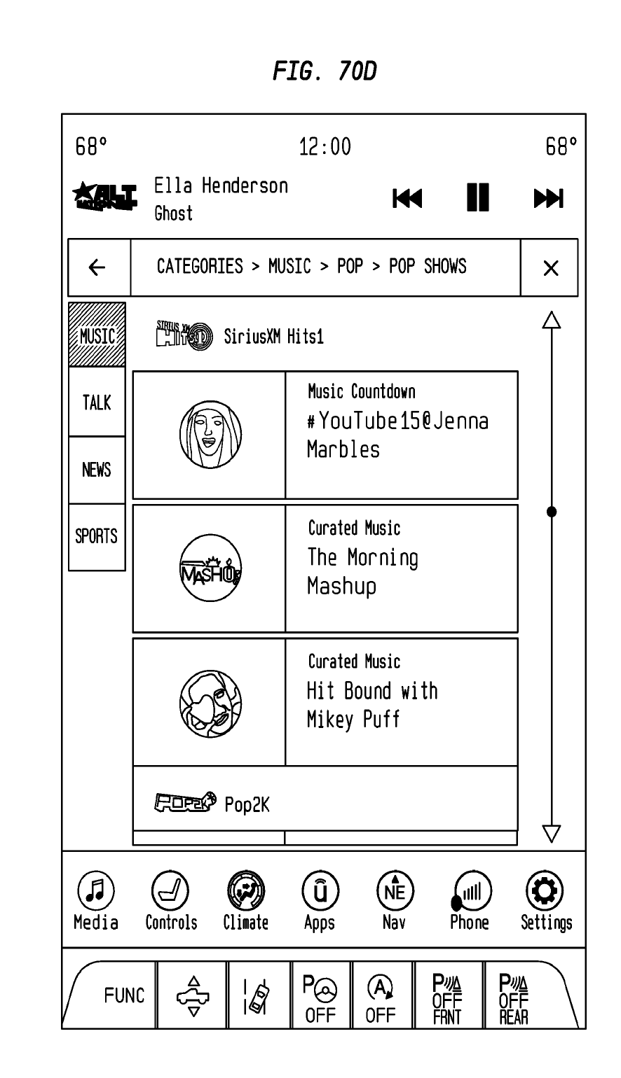

FIG. 70 depict various exemplary player, player and presets, search results, and shows in a sub-category screens according to the alternate exemplary embodiment of the present subject matter of FIGS. 61-70.

### Touch Screens and Equivalents

Given that not all cars now have, or even may have in the near future, interactive touch screens, in alternate exemplary embodiments of the present subject matter, a rotary dial or a haptic controller may be used, in whole or in part, to effect the various interactions described above as being accomplished via touch screens. FIG. 71 provides various examples of rotary dials and haptic controllers.

FIG. 72A is an exemplary player screen, as shown above, but here playing Channel 1—“Sirius XM Hits1”, according to an exemplary embodiment of the present subject matter. The channel is playing over the IP connection to the vehicle, as seen by the active “GO LIVE” button, which would return the user to the actual live broadcast channel. As noted above, the blue text showing “CUSTOM MIX” at the top center means that the user can tap that text, and customize the channel (which implies that the content is being streamed over IP).

FIG. 72B maps the various active buttons and icons shown in FIG. 72A to 16 selectable positions that may be accessed in order using a rotary dialer, according to an alternate exemplary embodiment of the present subject matter.

Additionally, other controllers commonly used on laptops and desktops may also be used, such as, for example, 5-way controllers and jog wheels. In addition a user may interact with an in-vehicle user-interface via voice commands as opposed to, or in addition to, touch screen tapping, gesturing and swiping, as described in the various interactions shown in FIGS. 1-70. Voice commands are next described.

### Voice Commands for Searching and Selection

As shown, for example, in FIG. 6, in exemplary embodiments of the present subject matter a user can use voice search to find enjoyable content. As noted, to do this a user simply taps the search icon and speaks the name of a channel, song, artist or category. Thus, in exemplary embodiments of the present subject matter, a voice recognition system may be integrated into the user-interface. Such a system can, for example, listen until a user is done speaking. The voice system can be adapted to the in-vehicle environment, and only suffer a negligible loss of performance—even at high speeds, where road, engine and wind noise tends to increase. For example, in an exemplary prototype developed by the inventors, an integrated voice recognition system operated successfully at speeds of 80 miles per hour. Such an exemplary system can, for example, be provided with specialized audio capture designed to sound a chime as soon as it senses the end of a spoken phrase. It is believed that when a user is driving at high speeds, and it is noisy, it is not useful to have a user speak long sentences. This is because first, when it is noisy, it is hard to tell when someone has finished speaking, and secondly, a driver should not be doing anything but simple actions when driving under conditions that require a high level of attention to the driving task itself. Driving when the roads are congested with traffic, or when visibility is limited due to weather, are examples of driving conditions that require a high level of attention. Thus, in exemplary embodiments of the present subject matter, a voice recognition system can have the intelligence to—based on driving conditions, namely vehicle speed, traffic conditions, and road noise—limit how long a person can talk when they use voice controls. Thus, in such exemplary embodiments, an intelligent adaptive voice search tool may be used. For example, under harsh driving conditions, the driver may be limited to saying channel names to change channels, and be disallowed from browsing through the use of voice search and subsequent visual attention to search results. In fact, some of the touch functionality may be limited in a similar fashion to avoid driver distraction.

In exemplary embodiments of the present subject matter, voice commands may be used to select any icon or screen, activate any active button or icon, and do all things described above in connection with navigating through the various screens and options of the UI.

The tap interface can include text where it is needed and deemed appropriate, and icons can be described verbally. Phrases such as “swipe to the left,” “show my presets,” “go to settings,” and “I want to hear that song again,” are examples of spoken requests that can be accommodated by the voice search function.

Further, as noted above, voice commands may be combined with tactile inputs, and/or haptic devices, to allow users to interact with the UI in a multi-modal manner, as they may at the moment feel most comfortable with. For example, in the swipe screen linear tuner shown in FIG. 11, it may be convenient to swipe left or right via voice commands, or even say “scroll left” or “scroll right” in response to which the carousel would scroll at a defined rate until either a channel number is spoken, or an icon is touched. So a driver may want to vocally initiate the linear tuner, but make a channel selection in a tactile manner. Similar combinations for interacting with other screens, buttons and icons are similarly contemplated. It is noted that United States Published Patent Application No. 2014/0267035, by Schalk et al., describes various multimodal input techniques for interacting with a user-interface; its disclosure is hereby incorporated herein by this reference in its entirety. Thus, in some embodiments, various combinations of a plurality of input techniques may be used, as a user may find convenient at any given time.

In exemplary embodiments of the present subject matter, the way search results are presented is unique. Iconic representation of content is used instead of conventional vertical text lists. Depending on the driver's spoken request, live channel options, as well as related on-demand channels or episodes, can be shown to the driver in an easy-to-see fashion, as shown, for example, in FIG. 65D. In response, the user may tap or speak the desired selection, and will then see the familiar player screen playing the chosen selection. For artists and song names, a similar style of presentation is used. FIGS. 65(a) through 65(d) depict the sequence of events in performing a search, and for a wholly spoken interaction, in FIG. 65(a) a user would say “SEARCH ON” or the like to initiate, as opposed to the indicated tapping.

### Custom Mix

In exemplary embodiments of the present subject matter, attributes of each song may be hand-coded on a channel-by-channel basis. Using that data, rule-sets may be designed for each slider to manage the results.

### Audio End-Pointing in the Car

Audio end-pointing can be defined as the determination of the beginning and end of a spoken utterance for the purpose of automatic speech recognition. Algorithms for performing audio end-pointing have been documented throughout signal processing literature. See for example, http://labrosa.ee.columbia.edu/˜dpwe/papers/ShenHL98-endpoint.pdf, or the first reference sited thereof.

As an exemplary embodiment of the audio end-pointing algorithm used in a prototype of the present subject matter, the algorithm developed and optimized is described next. FIG. 73 shows samples Sᵢ of an audio waveform S(t). For each sample Sᵢ, the sample amplitudes range between zero and 32,768 for 16-bit audio. The sample rate is 16 kHz which means that samples are spaced apart by 0.0625 milliseconds.

### Definitions

The following Definitions are useful for understanding audio end-pointing algorithms:

Audio Level (AL)—AL is defined as the average value of 640 successive sample amplitudes, which occur at, and before, a given frame time. AL is calculated every 40 milliseconds, which means that frames occur every 40 milliseconds. For example, we calculate 25 ALs during 1 second of speech.

Background Noise Level (BNL)—BNL is the minimum value of AL during the beginning of the audio recording. BNL is updated every frame for one second, starting at the beginning of the audio recording. A noise floor will be required (e.g., 50). When the AL drops below the noise floor, the BNL becomes the noise floor and remains the BNL estimate.

Silence Duration (SD)—SD is a duration measured in milliseconds. For example, an SD value of 400 corresponds to 10 frames. (e.g., SD=400)

Silence Sensitivity (SS)—SS is a scale factor which is used to detect silence. When AL falls below [BNL×SS] for SD seconds, the end of recording is declared. (e.g., SS=3.0)

Onset Sensitivity (OS)—OS is a scale factor which is used to detect word onset. Word onset occurs when AL is above [BNL×OS] for 2 successive frames. (e.g., OS=3.0)

Minimum Recording Duration (MRD) no speech detected—Stop recording if word onset isn't detected after MRD seconds. (e.g., MRD=2 seconds)

Maximum Recording Length (MRL)—Stop recording if silence isn't detected within MRL seconds from the start of the recording. The duration of an audio recording should not exceed MRL seconds. (e.g., MRL=5 seconds)

### Exemplary Audio End-Pointing Algorithm

In exemplary embodiments of the present subject matter, the following algorithm may be used for end-pointing:

calculate AL every frame;

use AL to estimate BNL for the 1st second of a recording;

starting at frame 6 (corresponding to approximately a quarter second after start of recording), begin trying to detect word onset and set a flag when detected;
// It is noted that we update our estimate of BNL as we start looking for word onset.

once word onset is found, start the silence detection process;
// It is noted that we continue to update BNL as we look for silence.

once silence has been detected, end the recording.

### Default Parameters

The following default parameters are optimized for vehicles, but also work for prototype's internal microphone.

Maximum Recording Length in ms

4000 ms

No Audio Detected Timeout in Ms

3000 ms

Silence Duration in ms

500 ms

Onset Sensitivity

3.0* above BNL

Silence Sensitivity

5.0* below BNL

BNL Floor Limit

100

These parameters are exposed at the application layer. In particular, MRL, SD, and BNL can be adjusted according to driving conditions in real time. In general, reducing MRL and SD will limit how long a driver's voice will be recorded. When BNL becomes high, MRL becomes a critical parameter for limiting the duration of a recording.

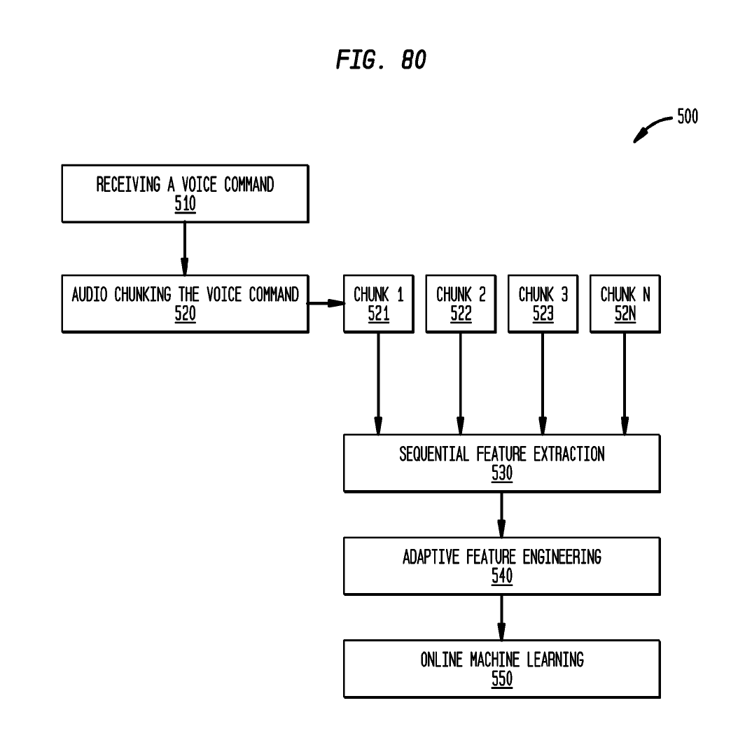

FIG. 80 illustrates an example of an embodiment of the present subject matter that employs a more sophisticated approach of audio end-pointing. A cloud-based recognizer (for example) can be configured to receive audio (at 510) as the user speaks and system response latency is minimized. For off-board speech recognition, chunked transfer encoding where audio is sent out in small chunks (e.g., 40 ms) as it is recorded on a device can be used. For example, as shown in FIG. 80 at 520, the voice command by the user can be divided (or “audio chunking”) into audio chunks 1-N (521, 522, . . . 52N). In this context, silence can be defined as audio that does not contain speech, that is, the user is silent and only background noise is present. The present subject matter can classify each chunk of audio as speech or background noise. In some embodiments, the present subject matter can employ a combination of adaptive feature engineering and machine learning to train a model that classifies audio chunks as speech or noise.

In some embodiments, the present subject matter can include one or more of sequential feature extraction 530, adaptive feature engineering 540, and/or online machine learning 550, which will be discussed in turn below.

Because the order of the audio sample can matter as much as their amplitude, the sequential feature extraction enables the present subject matter to leverage the ordinal/sequential nature of the audio chunk data. In some embodiments, the present subject matter can take one or more speech audio files that are represented as sequential sections (comprised of chunks) and classify them as being speech or background noise (silence) and index them accordingly (e.g., X_{class:seetion}). For example, X_{noise:1} can designate the first section of chunks of class noise. Each section (X_{class section}) can be split into chunks (e.g., C_{class:index:position}) For example, C_{speech2:6} can represent the 6^{th} chunk of the second speech section. Once each audio chunk is classified (labelled) and given its adequate class, the present subject matter can extract the audio samples from the chunk as features in their temporal order. For example, C_{speech:2:6:50} can represent the 50^{th} sample (feature) of the 6^{th} chunk in the second speech section. From these sequential data features, the classifier can learn the different ways in which the amplitude varies for each chunk class (speech or silence/background noise) from, for example, one millisecond to the next.

Adaptive feature engineering 540 includes one or more engineer DSP-specific (digital signal processing) features from which the classifier can learn various types of speakers (e.g., slow, fast, loud, etc.) associated with each audio chunk class (e.g., speech, noise or silence). Examples of such features include energy, zero-crossing rate, and pitch period. In some embodiments, the present subject matter can leverage features that describe the global characteristics of each chunk class for diverse types of speakers.

Online machine learning 550 can include utilizing the sequential and adaptive features to train a machine learning classifier that can dynamically adapt to one or more new vocal patterns. In some embodiments, the present subject matter employs machine learning to train the classifier to identify background noise given a sequence of chunks from a potentially infinite type of speakers in a potentially infinite type of scenarios (e.g., weather, background noise, etc.) so that the classifier can dynamically self-learn patterns from a finite set of data. In some embodiments, the present subject matter can train the classifier online (live) as it is making prediction on unseen data. For example, in some embodiment, the classifier can determine whether data is labeled (e.g., for training) or unlabeled (e.g., for predicting its class). When the data is labeled, the classifier will learn from the data and update itself. When the data is unlabeled, the classifier will determine a class for the data (speech or silence/noise).

### Non-Limiting Software and Hardware Examples

Various exemplary embodiments of the subject matter as described above can be implemented as one or more program products, software applications and the like, for use with a computer system, both as to transmission from preparation and as to receiver operations and processes. The terms program, software application, and the like, as used herein, are defined as a sequence of instructions designed for execution on a computer system or data processor. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The program(s) of the program product or software may define functions of the embodiments (including the methods described herein) and can be contained on a variety of computer readable media. Illustrative computer readable media include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such computer readable media, when carrying computer-readable instructions that direct the functions of the present subject matter, represent embodiments of the present subject matter.

In general, the routines executed to implement the embodiments of the present subject matter, whether implemented as part of an operating system or a specific application, component, program, module, object or sequence of instructions may be referred to herein as a “program.” A computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the subject matter. However, it should be appreciated that any particular program nomenclature that follows is used merely for convenience, and thus the subject matter should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the subject matter is not limited to the specific organization and allocation or program functionality described herein.

The present subject matter may be realized in hardware, software, or a combination of hardware and software. A system according to a preferred embodiment of the present subject matter can be realized in a centralized fashion in one computer system on the transmit side, and one receiver on the receive side, or in a distributed fashion where different elements are spread across several interconnected computer systems, including cloud connected computing systems and devices. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the subject matter have been disclosed, those having ordinary skill in the art will understand that changes can be made to the specific embodiments without departing from the spirit and scope of the subject matter. The scope of the subject matter is not to be restricted, therefore, to the specific embodiments. The above-presented description and figures are intended by way of example only and are not intended to limit the present subject matter in any way except as set forth in the following claims. For example, while this disclosure describes various efficient and easy to use user-interfaces, user-interface elements, and user interactions therewith, for an in-vehicle digital audio receiver unit, its techniques and systems are applicable to any type of user-interface, for various communications systems, media consumption systems, computer gaming systems, or the control and use of other applications, systems and devices where a user needs to quickly understand the features and options, and easily make selections, and navigate through the available screens. It is particularly noted that persons skilled in the art can readily combine the various technical aspects of the various elements of the various exemplary embodiments that have been described above in numerous other ways, all of which are considered to be within the scope of the subject matter.

1-42. (canceled)

42. A device comprising:
a display;
at least one processor; and
a non-transitory computer-readable medium including instructions which, when executed by the at least one processor, cause the at least one processor to perform a method comprising:
presenting a user-interface on the display, the user-interface including a plurality of user-interface elements, at least some of the user-interface elements being or including tiles, active buttons, icons or images representing a media content that can be streamed to the device via a one-way broadcast and a two-way communication channel; and
enabling selection of one or more of the user-interface elements by a user via at least one of an interactive touch screen, a rotary dial, a haptic controller, or voice commands.

43. The device according to claim 42, wherein at least some of the user-interface elements are presented as a 1D array of user-interface elements or a 2D array of user-interface elements.

44. The device according to claim 42, wherein upon selection by the user of a selected element from a first set of presented user-interface elements, the device is configured to remove from view at least some of the user-interface elements which do not form part of the selected element.

45. The device according to claim 42, wherein upon selection by a user of one from a first set of presented user-interface elements, the device is configured to automatically display a second set of user-interface elements to the user.

46. The device according to claim 42, wherein the selection of the one or more user-interface elements comprises detecting a particular stylus position from a plurality of detectable stylus positions of the device, each stylus position being associated with a constituent portion of the user-interface.

47. The device according to claim 42, wherein the selection of the one or more user-interface elements comprises detecting a particular cursor position from a plurality of detectable cursor positions of the device, each cursor position being associated with a constituent portion of the user-interface.

48. The device according to claim 42, wherein the enabled selection of one or more of the user-interface elements by a user includes a user speaking voice command, and wherein the device is configured to limit a length and/or complexity of the voice command based on a speed of the vehicle at the time the voice command is received by the device.

49. The device according to claim 42, further comprising a voice recognition system configured to limit a functionality of the voice recognition system based on a driving condition.

50. The device according to claim 42, further comprising a voice recognition system configured to determine a beginning and an end of a voice command.

51. The device according to claim 50, wherein determining of the beginning and the end of a voice command includes:
receiving a plurality of audio chunks of equal time frame;
calculating an audio level for each of the audio chunks; and
determining a background noise level based on the audio level for each of the audio chunks.

52. The device according to claim 42, further comprising a telematics sensor for generating telematics data; wherein the method further comprises monitoring the telematics data from the telematics sensor and limiting a functionality of at least one of the plurality of user-interface elements when a driving condition is detected.

53. The device according to claim 42, wherein the one-way broadcast is a Satellite Digital Audio Radio Service (SDARS) and the two-way communication channel is a cellular or internet protocol data connection.

54. A method, comprising:
presenting a user-interface on a display of a device, the user-interface including a plurality of user-interface elements, at least some of the user-interface elements being or including tiles, active buttons, icons or images representing a media content that can be streamed to the device via a one-way broadcast and a two-way communication channel; and
enabling selection of one or more of the user-interface elements by a user via at least one of an interactive touch screen, a rotary dial, a haptic controller, or voice commands.

55. The method according to claim 54, wherein at least some of the user-interface elements are presented as a 1D array of user-interface elements or a 2D array of user-interface elements.

56. The method according to claim 54, wherein upon selection by a user of one from a first set of presented user-interface elements, the apparatus is configured to remove from view at least some of the user-interface elements which do not form part of the selected element.

57. The method according to claim 54, wherein upon selection by a user of one from a first set of presented user-interface elements, the apparatus is configured to display a second set of user-interface elements to the user.

58. The method according to claim 54, wherein the selection of the one or more user-interface elements comprises detecting a particular stylus position from a plurality of detectable stylus positions of the device, each stylus position being associated with a constituent portion of the user-interface.

59. The method according to claim 54, further comprising detecting a particular position from a plurality of detectable cursor positions of the device, each cursor position being associated with a constituent portion of the user-interface.

60. The method according to claim 54, wherein the enabled selection of one or more of the user-interface elements by a user includes a user speaking voice command, and wherein the device is configured to limit a length and/or complexity of the voice command based on a speed of the vehicle at the time the voice command is received by the device.

61. The method according to claim 54, further comprising:
detecting a driving condition associated with the device; and
limiting a functionality of the user-interface based on the detected driving condition.

62. The method according to claim 54, further comprising determining a beginning and an end of the voice command.

63. The method according to claim 62, wherein the determining of the beginning and the end of the voice command includes:
receiving a plurality of audio chunks of the voice command;
calculating an audio level for each of the audio chunks; and
determining a background noise level based on the audio level for each of the audio chunks.

64. The method according to claim 54, further comprising:
receiving telematics data from a telematics sensor;
determining a driving condition based on the telematics data; and
limiting a functionality of at least one of the plurality of user-interface elements when the determined driving condition matches a pre-determined adverse driving condition.

65. The method according to claim 54, wherein the one-way broadcast is a Satellite Digital Audio Radio Service (SDARS) and the two-way communication channel is a cellular or internet protocol data connection.
